(19) United States
(12) Patent Application Publication
(10) Pub. No.: US 2009/0253585 A1
(43) Pub. Date: Oct. 8, 2009

(54) Identification of Genetic Polymorphic Variants Associated With Somatosensory Disorders and Methods of Using the Same

(76) Inventors: Luda Diatchenko, Chapel Hill, NC (US); William Maixner, Chapel Hill, NC (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/085,785

(22) PCT Filed: Nov. 29, 2006
(86) PCT No.: PCT/US2006/045757

§ 371 Date: Jun. 1, 2009

Related U.S. Application Data
(60) Provisional application No. 60/740,937, filed on Nov. 30, 2005.
(60) Provisional application No. 60/815,982, filed on Jun. 23, 2006.

(51) Int. Cl. C40B 30/04; C40B 40/06; G06F 19/00

(52) U.S. Cl. 506/9; 506/16; 702/19

(57) ABSTRACT

Methods of predicting effective pharmacological therapies for a subject afflicted with a somatosensory disorder by determining a genotype of the subject with or without determination of psychosocial and/or neurological assessments of the subject are provided. Methods of predicting susceptibility of a subject to develop somatosensory disorders by determining a genotype of the subject with or without determination of psychosocial and/or neurological assessments of the subject are further provided.

### RELATED APPLICATIONS

The presently disclosed subject matter claims the benefit of U.S. Provisional Patent Application Ser. No. 60/740,937, filed Nov. 30, 2005 and U.S. Provisional Patent Application Ser. No. 60/815,982 filed Jun. 23, 2006; the disclosures of each of which are incorporated herein by reference in their entireties.

### GOVERNMENT INTEREST

The presently disclosed subject matter was made with U.S. Government support under Grant Nos. DE16558 and NS045685 awarded by the National Institutes of Health. Thus, the U.S. Government has certain rights in the presently disclosed subject matter.

### TECHNICAL FIELD

The presently disclosed subject matter relates in some embodiments to predicting the susceptibility of a subject to develop somatosensory and related disorders based upon determined genotypes of the subject. The presently disclosed subject matter also relates to selecting and administering effective therapies for treatment of somatosensory and related disorders to a subject. Further, the presently disclosed subject matter provides for selecting the effective therapy for treating a somatosensory disorder based upon the determined genotype of the subject.

### BACKGROUND

An individual's sensitivity to pain is influenced by a variety of environmental and genetic factors (Mogil (1999)). Although the relative importance of genetic versus environmental factors in human pain sensitivity remains unclear, reported heritability for nociceptive and analgesic sensitivity in mice is estimated to range from 28% to 76% (Mogil (1999)). Even though animal studies have provided a list of candidate “pain genes,” only a few genes have been identified that are associated with the perception of pain in humans.

An understanding of the underlying neurobiological and psychosocial processes that contribute to enhanced pain sensitivity and the risk of developing somatosensory disorders is beginning to emerge (FIG. 1). The ability of central nociceptive pathways to show enhanced responses to peripheral input depends not only on the activity of peripheral primary afferents, but also on the activity of central pain regulatory systems. The interplay between peripheral afferent input and central nervous system regulatory systems modulates the activity of central neural networks and produces dynamic, time-dependent alterations in the excitability and response characteristics of spinal and supraspinal neural and glia cells that respond to noxious stimuli. Thus, aberrant neural processing of noxious stimuli and psychosocial dysfunction can result in enhanced pain sensitivity and increase the risk of developing somatosensory disorders that result from multiple etiologies and which are difficult to clinically categorize and treat effectively (FIG. 1).

The biological and psychosocial determinants of pain sensitivity and somatosensory disorders are influenced by both genetic factors, including heritable genetic variation, and environmental circumstances (e.g., exposure to injury, physical stress, psychological stress, and pathogens) that determine an individual's biological and psychosocial profiles or phenotypes. The coupling of genetic tests with neurological and psychosocial assessment procedures will permit the development of software routines and medical devices that are useful in diagnosing and treating disorders and conditions involving pain perception.

### SUMMARY

This Summary lists several embodiments of the presently disclosed subject matter, and in many cases lists variations and permutations of these embodiments. This Summary is merely exemplary of the numerous and varied embodiments Mention of one or more representative features of a given embodiment is likewise exemplary. Such an embodiment can typically exist with or without the feature(s) mentioned; likewise, those features can be applied to other embodiments of the presently disclosed subject matter, whether listed in this Summary or not. To avoid excessive repetition, this Summary does not list or suggest all possible combinations of such features.

In some embodiments of the presently disclosed subject matter, a method of predicting susceptibility of a subject to develop a somatosensory disorder is provided. In some embodiments, the method comprises determining a genotype of the subject with respect to one or more of genes selected from Table 1 and/or Table 4 and comparing the genotype of the subject with one or more of reference genotypes associated with susceptibility to develop the somatosensory disorder, whereby susceptibility of the subject to develop the somatosensory disorder is predicted. In some embodiments, predicting susceptibility of a subject to develop a somatosensory disorder comprises predicting a pain response and/or somatization in the subject.

In some embodiments of the presently disclosed subject matter, a method of selecting a therapy, predicting a response to a therapy, or both, for a subject having a somatosensory disorder is provided. In some embodiments, the method comprises determining a genotype of the subject with respect to one or more genes selected from Table 1 and/or Table 4 and selecting a therapy, predicting a response to a therapy, or both, based on the determined genotype of the subject. In some embodiments, the therapy is selected from the group consisting of a pharmacological therapy, a behavioral therapy, a psychotherapy, a surgical therapy, and combinations thereof. Further, in some embodiments, the subject is undergoing or recovering from a surgical therapy and the method comprises selecting a pain management therapy, predicting a response to a pain management therapy, or both based on the determined genotype of the subject.

In some embodiments of the presently disclosed subject matter, a method of classifying a somatosensory disorder afflicting a subject is provided. In some embodiments, the method comprises determining a genotype of the subject with respect to one or more genes selected from Table 1 and/or Table 4 and classifying the somatosensory disorder into a genetic subclass somatosensory disorder based on the determined genotype of the subject.

In some embodiments of the methods disclosed herein, determining the genotype of the subject comprises:
(i) identifying at least one haplotype from each of the one or more genes selected from Table 1 and/or Table 4;
(ii) identifying at least one polymorphism unique to at least one haplotype from each of the one or more genes selected from Table 1 and/or Table 4;
(iii) identifying at least one polymorphism exhibiting high linkage disequilibrium to at least one polymorphism unique to each of the one or more genes selected from Table 1 and/or Table 4;
(iv) identifying at least one polymorphism exhibiting high linkage disequilibrium to at least one of the one or more genes selected from Table 1 and/or Table 4; or
(v) combinations thereof.

In some embodiments of the methods disclosed herein, the at least one polymorphism unique to the at least one haplotype is a single nucleotide polymorphism from Table 5 and/or Table 6.

In some embodiments of the methods disclosed herein, the somatosensory disorder is selected from the group consisting of chronic pain conditions, fibromyalgia syndrome, tension headache, migraine headache, phantom limb sensations, irritable bowel syndrome, chronic lower back pain, chronic fatigue, multiple chemical sensitivities, temporomandibular joint disorder, post-traumatic stress disorder, chronic idiopathic pelvic pain, Gulf War Syndrome, vulvar vestibulitis, osteoarthritis, rheumatoid arthritis, angina pectoris, postoperative pain, and neuropathic pain.

In some embodiments of the methods disclosed herein, the methods comprise determining a psychosocial assessment, a neurological assessment, or both, of a subject; determining a genotype of the subject with respect to one or more genes selected from Table 4; and predicting susceptibility of the subject to develop a somatosensory disorder based on the determined psychosocial assessment, neurological assessment, or both, and the determined genotype of the subject.

In some embodiments, determining the psychosocial assessment of the subject comprises testing the subject with at least one psychosocial questionnaire comprising one or more questions that each assess anxiety, depression, somatization, stress, cognition, pain perception, or combinations thereof of the subject. In some embodiments, the at least one psychosocial questionnaire is selected from the group consisting of Eysenck Personality Questionnaire, Life Experiences Survey, Perceived Stress Scale, State-Trait Anxiety Inventory (STAI) Form Y-2, STAI Form Y-1, Pittsburgh Sleep Quality Index, Kohn Reactivity Scale, Pennebaker Inventory for Limbic Languidness, Short Form 12 Health Survey v2, SF-36, Pain Catastrophizing Scale, In vivo Coping Questionnaire, Coping Strategies Questionnaire-Rev, Lifetime Stressor List & Post-Traumatic Stress Disorder (PTSTD) Checklist for Civilians, Multidimensional Pain Inventory v3, Comprehensive Pain & Symptom Questionnaire, Symptom Checklist-90-R(SCL-90R), Brief Symptom Inventory (BSI), Beck Depression Inventory (BDI), Profile of Mood States Bi-polar, Pain Intensity Measures, and Pain Unpleasantness Measures.

In some embodiments, determining the neurological state of the subject comprises testing the subject with at least one neurological testing apparatus. In some embodiments, the neurological testing apparatus is selected from the group consisting of Thermal Pain Delivery and Measurement Devices, Mechanical Pain Delivery and Measurement Devices, Ischemic Pain Delivery and Measurement Devices, Chemical Pain Delivery and Measurement Devices, Electrical Pain Delivery and Measurement Devices, Vibrotactile Delivery and Measurement Devices, Blood Pressure Measuring Devices, Heart Rate Measuring Devices, Heart Rate Variability Measuring Devices, Baroreceptor Monitoring Devices, Cardiac Output Monitoring Devices, Blood Flow Monitoring Devices, and Skin Temperature Measuring Devices.

In some embodiments of the presently disclosed subject matter, a kit for determining a genotype of a subject that is associated with a somatosensory disorder is provided. In some embodiments, the kit comprises an array comprising a substrate and a plurality of polynucleotide probes arranged at specific locations on the substrate, wherein each probe has a binding affinity for a different polynucleotide sequence comprising a single nucleotide polymorphism selected from Table 5 and/or Table 6 and a set of instructions for using the array. In some embodiments, the substrate comprises a plurality of addresses, wherein each address is associated with at least one of the polynucleotide probes. In some embodiments, the set of instructions comprises instructions for interpreting results from the array.

In some embodiments of the presently disclosed subject matter, a system is provided. In some embodiments, the system comprises an array comprising a substrate and a plurality of polynucleotide probes arranged at specific locations on the substrate, wherein each probe has a binding affinity for a different polynucleotide sequence comprising a single nucleotide polymorphism selected from Table 5 and/or Table 6; and at least one neurological testing apparatus for determining a neurological assessment of the subject, at least one psychosocial questionnaire for determining a psychosocial assessment of the subject, or both the neurological testing apparatus and the psychosocial questionnaire. In some embodiments, the system comprises software for assessing results of the array, the neurological testing apparatus, and the psychosocial questionnaire. In some embodiments, the software provides diagnostic information, therapeutic information, or both related to a somatosensory disorder about the subject.

Accordingly, it is an object of the presently disclosed subject matter to provide identification of genetic polymorphic variants associated with somatosensory disorders and methods of using the same. This object is achieved in whole or in part by the presently disclosed subject matter

An object of the presently disclosed subject matter having been stated hereinabove, and which is achieved in whole or in part by the presently disclosed subject matter, other objects will become evident as the description proceeds when taken in connection with the accompanying drawings as best described hereinbelow.

### BRIEF DESCRIPTION OF THE DRAWINGS

FIG. 1 is a schematic diagram of a model of somatosensory disorder risk factors. The model displays likely neurological and psychosocial determinants that contribute to the risk of somatosensory disorder onset and persistence.

FIG. 2 is a schematic diagram showing mouse (top) and human (middle and bottom) OPRM1 gene structure. The human gene structure is presented in accordance with the NCBI database (middle) and reconstructed gene structure based on the present comparative genomes analysis (bottom). Exons and introns are shown by vertical and horizontal boxes, respectively. Grey boxes represent newly described exons.

FIG. 3 is a linkage disequilibrium (LD) table for pairwise LD and haplotype blocks in OPRM1. Pairwise LD values between single nucleotide polymorphism (SNP) markers were calculated using the HAPLOVIEW™ program (Whitehead Institute for Biomedical Research, Cambridge, Mass., U.S.A.). In the D′ Plot, each diagonal represents a different SNP, with each square representing a pairwise comparison (D′) between two SNPs. SNPs are arranged 5′ to 3′, and their relative location is indicated along the top. The black triangles indicate haplotype blocks, identified by high pairwise LD values among SNPs, with multiallelic D′>0.9. Monomorphic markers are not shown. The plots are color-coded as follows: dark gray, D′>0.8; medium gray, D′=0.7-0.8; light gray, D′=0.4-0.7; white, D′<0.4

### DETAILED DESCRIPTION

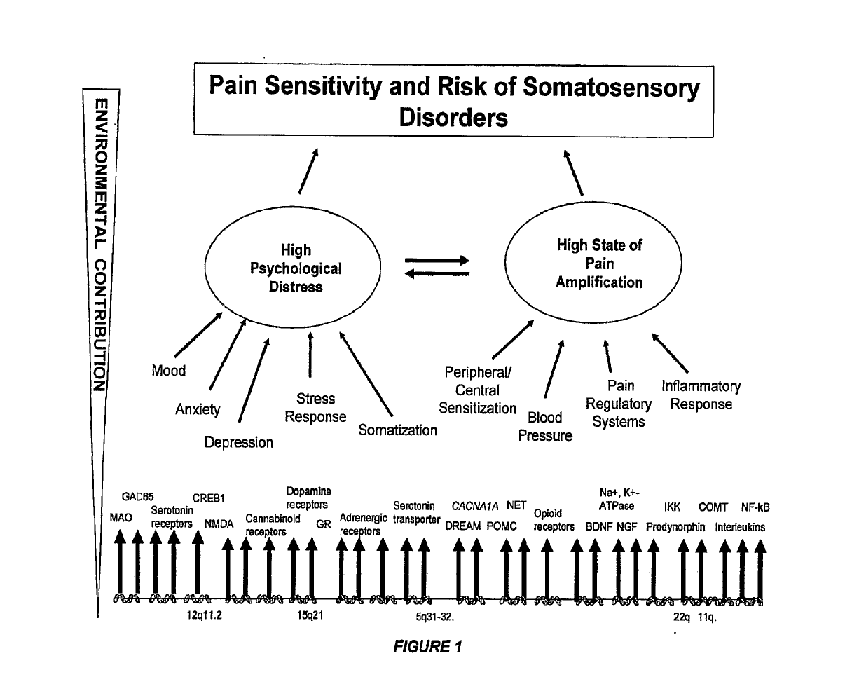

Somatosensory disorders can comprise several chronic clinical conditions that are characterized by the perception of persistent pain, unpleasantness or discomfort in various tissues and regions of the body. These conditions include, but are not limited to, chronic pain conditions, fibromyalgia syndrome, tension headache, migraine headache, phantom limb sensations, irritable bowel syndrome, chronic lower back pain, chronic fatigue, multiple chemical sensitivities, temporomandibular joint disorder, post-traumatic stress disorder, chronic idiopathic pelvic pain, Gulf War Syndrome, vulvar vestibulitis, osteoarthritis, rheumatoid arthritis, angina pectoris, postoperative pain (e.g., acute postoperative pain), and neuropathic pain. In general, these conditions are characterized by a state of pain amplification as well as psychosocial distress, which is characterized by high levels of somatization, depression, anxiety and perceived stress (FIG. 1). One example is temporomandibular joint disorder (TMJD), a prototypic somatosensory disorder, which is associated with a state of pain amplification as well as psychosocial distress, which is characterized by high levels of somatization, depression, anxiety and perceived stress (FIG. 1). TMJD alone impacts 5-15% of the population and has been estimated to incur approximately $1 billion in healthcare costs.

A common feature of somatosensory disorders is that a given somatosensory disorder is often associated with other co-morbid somatosensory conditions. It is generally accepted that impairments in CNS regulatory processes contribute to the pain amplification and psychosocial dysfunction associated with somatosensory disorders. However, details as to the specific molecular pathways resulting in the CNS regulatory process impairments and the exact role individual genetic variation play in the process are heretofore undetermined. Furthermore, a host of genetic and environmental factors impact pain sensitivity, psychosocial profiles and the risk of developing a somatosensory disorder. As shown in FIG. 1, a multitude of known environmental factors such as injury, stress, and infections can compound or interact to alter psychosocial function, pain sensitivity, and the risk of developing a somatosensory disorder. Thus, an individual with enhanced pain processing and/or psychosocial dysfunction (e.g., somatization), due to for example genetic variability affecting protein activity, as compared to a population norm, would be predicted to have a greater pain sensitivity and risk of developing a somatosensory disorder.

The presently disclosed subject matter provides new insights into the molecular genetic pathways involved in the development of somatosensory disorders and further reveals genotypes, which can include specific genetic polymorphisms present in subjects that, when coupled with environmental factors such as physical or emotional stress along with psychological perceptions of the stresses, can produce a clinical phenotype that is vulnerable to the development of a somatosensory disorder. The genotypes (which can include specific genetic polymorphisms) identified herein are useful alone or in combination with psychosocial and/or neurological assessments for predicting the susceptibility of a subject to develop a somatosensory disorder, or related condition, including for example increased pain sensitivity and predilection toward somatization.

The presently disclosed subject matter also provides methods for using the knowledge of the genotype (which can include the presence of specific polymorphisms) alone or in combination with psychosocial and/or neurological assessments of a particular subject suffering from a somatosensory or related disorder to subclassify the disorder, thereby allowing for development of optimal treatments for treating the disorder based on the determination that subjects exhibiting a particular genotype (which can include the presence of particular polymorphisms, as disclosed herein) respond well or poorly to particular pharmacologic, behavioral, and surgical treatments.

In particular, the presently disclosed subject matter provides insights into particular polymorphism patterns more prevalent in subjects suffering from somatosensory and related disorders. For example, the enzyme catechol-O-methyltransferase (COMT), which functions in part to metabolize catecholamines such as epinephrine and norepinephrine, the β2-adrenergic receptor (ADRB2) and the β3-adrenergic receptor (ADRB3), which are receptors for catecholamines, are components of a molecular pathway that plays a role in somatosensory disorders. Particular polymorphisms in one or more of these genes, as disclosed herein, are predictive of development of somatosensory disorders by subjects carrying one or more of the polymorphisms. Additional polymorphisms in other genes now shown to be associated with somatosensory disorders are disclosed herein for the first time as well.

Therefore, determining a subject's genotype for one or more genes associated with somatosensory disorders can be used to predict the susceptibility of the subject to develop a somatosensory or related disorder, as disclosed herein. Further, determining a subject's genotype can be used to develop and/or provide an effective therapy for the subject, as genotypes of genes associated with somatosensory disorders can result in gene products with different activities that make a subject more or less responsive to particular pharmacologic therapies. Further, a subject's determined genotype with respect to one or more genes associated with somatosensory disorders can be used to subclassify the particular somatosensory or related disorder and thereby direct treatment strategies. In addition, the coupling of genetic tests with neurological and psychosocial assessment procedures can permit the development of software routines and medical devices that are useful in diagnosing and treating disorders and conditions involving pain perception and can provide information regarding susceptibility of the subject to develop somatosensory disorders and related conditions.

### I. GENERAL CONSIDERATIONS FOR SOMATOSENSORY DISORDERS

Somatosensory disorders commonly aggregate as “comorbid” conditions that are characterized by a complaint of pain as well as a mosaic of abnormalities in motor function, autonomic balance, neuroendocrine function, and sleep (Zolnoun et a/2006; Aaron et a/2000; Kato et al. 2006; Vandvik et al. 2006). Although the mechanisms that underlie the majority of these conditions are poorly understood, somatosensory disorders have been associated with a state of pain amplification and psychological distress (McBeth et al. 2001; Bradley and McKendree-Smith 2002; Verne and Price 2002; Gracely et a/2004).

Importantly, there is substantial individual variability in the relative contribution of pain amplification and psychological phenotypes to somatosensory disorders. Pain amplification and psychological distress, which are mediated by an individual's genetic variability and exposure to environmental events, represent two primary pathways of vulnerability that underlie the development of highly prevalent somatosensory disorders (FIG. 1; Maixner et a/1995; Maixner 2004; Diatchenko et a/2005).

A handful of studies have sought to prospectively identify risk factors or risk determinants that are associated with or mediate the onset and maintenance of somatosensory disorders. A well-established predictor of onset is the presence of another chronic pain condition, characterized by a state of pain amplification (Von Korff et al. 1988). Additionally, widespread pain is a risk indicator for dysfunction associated with temporomandibular joint disorders (TMJD), which exemplify a class of painful somatosensory disorders, and for lack of response to treatment (Raphael and Marbach 2001). It has been demonstrated that individuals who are more sensitive to noxious stimuli are significantly more likely to develop painful TMJD than those who are less sensitive (risk ratio=2.7; Slade et al., unpublished observation). The outcomes of several cross-sectional studies also suggest that somatosensory disorders, including TMJD, are influenced by a state of pain amplification (Granges et al. 2003; Giesecke et al., 2004; Langemark et al., 1989, Verne et al., 2001; Sarlani and Greenspan 2003; Maixner 2004).

In general, a relatively high percentage of patients with somatosensory disorders show enhanced responses to noxious stimulation compared to controls (McBeth et al. 2001; Bradley and McKendree-Smith 2002; Verne and Price 2002; Gracely et al. 2004). Enhanced pain perception experienced by patients with somatosensory disorders might result from a dysregulation in peripheral afferent and central systems that produces dynamic, time dependent changes in the excitability and response characteristics of neuronal and glial cells. This dysregulation contributes to altered mood, motor, autonomic, and neuroendocrine responses as well as pain perception (FIG. 1; Maixner et al. 1995; Maixner 2004).

Heightened psychological distress is another domain or pathway of vulnerability that can lead to somatosensory disorders (FIG. 1). Patients with TMJD, and other somatosensory disorders, display a complex mosaic of depression, anxiety (Vassend et al. 1995), and perceived stress relative to pain-free controls (Beaton et al. 1991). Somatization, which is the tendency to report numerous physical symptoms in excess to that expected from physical exam (Escobar et al. 1987), is associated with more than a two fold increase in TMJD incidence, decreased improvement in TMJD facial pain after 5 years (Ohrbach and Dworkin 1998), and increased pain following treatment (McCreary et al. 1992). Somatization is also highly associated with widespread pain, the number of muscle sites painful to palpation (Wilson et al. 1994), and the progression from acute to chronic TMJD (Garofalo et al. 1998). In a prospective study on 244 initially TMJD free females, it was found that somatization, anxiety, depression and perceived stress represent significant risk factors for TMJD onset (Significant Risk Ratios ranging from 2.1 to 6.0) (Slade et al. 2006).

These results suggest that somatization, negative affect/mood, and environ mental stress independently or jointly contribute to the risk of onset and maintenance of somatosensory disorders.

In view of the disclosure hereinabove, it is proposed that there are two major domains that contribute to the vulnerability of developing common somatosensory disorders: enhanced pain sensitivity and psychological distress (FIG. 1). Each of these domains is influenced by specific genetic variants mediating the activity of physiological pathways that underlie pain amplification and psychological distress. Thus, individual polymorphic variations in genes coding for key regulators of these pathways, when coupled with environmental factors such as physical or emotional stress, injury, and infection, interact with each other to produce a phenotype that is vulnerable to somatosensory disorders.

Both clinical and experimental pain perception are influenced by genetic variants (Mogil 1999; Zubieta et al. 2003; Diatchenko et al. 2005). Although the relative importance of genetic versus environmental factors in human pain perception has not been completely determined, reported heritability for nociceptive and analgesic sensitivity in mice is estimated to range from 28% to 76% (Mogil 1999). Several recent studies have also established a genetic association with a variety of psychological traits and disorders that influence risk of developing somatosensory disorders. Twin studies show that 30%-50% of individual variability in the risk to develop an anxiety disorder is due to genetic factors (Gordon and Hen 2004). The heritability of unipolar depression is also remarkable, with estimates ranging from 40% to 70% (Lesch 2004). Moreover, normal variations in these psychological traits show substantial heritability (Exton et al. 2003; Bouchard, Jr. and McGue 2003; Eid, et al., 2003).

With advances in high throughput genotyping methods, the number of genes associated with pain sensitivity and complex psychological traits such as depression, anxiety, stress response and somatization has increased exponentially. A few examples of the genes associated with these traits include catechol-O-methyltransferase (COMT), adrenergic receptor β2 (ADRB2), serotonin transporter (5-HTT), cyclic AMP-response element binding protein 1, monoamine oxidase A, GABA-synthetic enzyme, D2 dopamine receptor, glucocorticoid receptor, interleukins 1 beta and alpha, Na+, K+-ATPase and voltage gated calcium channel gene.

It has been reported by the present co-inventors that the gene encoding COMT has been implicated in the onset of TMJD (PCT International Application No. PCT/US05/26201, incorporated herein by reference in its entirety). It was also shown that three common haplotypes of the human COMT gene are associated with pain sensitivity and the likelihood of developing TMJD. Haplotypes associated with heightened pain sensitivity produce lower COMT activity. Furthermore, inhibition of COMT activity results in heightened pain sensitivity and proinflammatory cytokine release in animal models via activation of β2/3-adrenergic receptors (PCT International Application No. PCT/US05/26201). Consistent with these observations, it has also been reported that three major haplotypes of the human ADRB2 are strongly associated with the risk of developing a somatosensory disorder, such as for example a TMJD (PCT International Application No. PCT/US05/26201; Diatchenko et al. 2006).

Because it is highly likely that somatosensory disorders share common underlying pathophysiological mechanisms, it is expected that the same functional genetic variants will often be associated with co-morbid somatosensory disorders and related signs and symptoms. For example, a common single nucleotide polymorphism (SNP) in codon 158 (val 158 met) of COMT gene is associated with pain ratings (Diatchenko et al. 2005), μ-opioid system responses (Rakvag, et al. 2005), TMJD risk (Diatchenko et al. 2005), and FMS development (Gursoy, et al. 2003) as well as addiction, cognition, and common affective disorders (Oroszi and Goldman 2005). Common polymorphisms in the promoter of the 5-HTT gene are associated with depression, stress-related suicidality (Caspi et al. 2003), anxiety (Gordon and Hen 2004), somatization, and TMJD risk (Herken et al. 2001).

On the other hand, a defining feature of complex common phenotypes is that no single genetic locus contains alleles that are necessary or sufficient to produce a complex disease or disorder. A substantial percentage of the variability observed with complex clinical phenotypes can be explained by genetic polymorphisms that are relatively common (i.e., greater than 10%) in the population, although the phenotypic penetrance of these common variants is frequently not very high (Risch 2000). Thus, the varied clinical phenotypes associated with somatosensory disorders are likely the result of interactions between many genetic variants of multiple genes. As a result, interactions among these distinct variants produce a wide range of clinical signs and symptoms so that not all patients show the same broad spectrum of abnormalities in pain amplification and psychological distress. Furthermore, environmental factors also play a crucial role in gene penetrance in multifactorial complex diseases. For example, functional polymorphism in the promoter region of the 5-HTT gene is associated with the influence of stressful life events on depression, providing evidence of a gene-by-environment interaction, in which an individual's response to environmental insult is moderated by his or her genetic makeup (Caspi et al. 2003).

Since each individual patient will experience unique environmental exposures and possess unique genetic antecedents to somatosensory disorder vulnerability, an efficient approach to identify genetic markers for somatosensory disorders and to identify therapeutic targets, is to analyze the interactive effects of polymorphic variants of multiple functionally related candidate genes. The complex interaction between these polymorphic variants will yield several unique subtypes of patients who are susceptible to a variety of somatosensory disorders and who will benefit from tailored treatments for their condition. Recognition of the fact that multiple genetic pathways and environmental factors interact to produce a diverse set of somatosensory disorders, with persistent pain as a primary symptom, requires a new paradigm to diagnose, classify, and treat somatosensory disorders patients. The presently disclosed subject matter addresses these needs.

### II. DEFINITIONS

While the following terms are believed to be well understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in this application, including the claims. Thus, for example, reference to “a cell” includes a plurality of such cells, and so forth.

Unless otherwise indicated, all numbers expressing quantities of ingredients, reaction conditions, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

“β2-adrenergic receptor” (ADRB2) and “β3-adrenergic receptor” (ADRB3) as used herein refer to cellular macromolecular complexes that when stimulated by catecholamines such as epinephrine (ADRB2) and norepinephrine (ADRB3) produce biological or physiological effects. The core component of both ADRB2 and ADRB3 is a seven transmembrane domain protein that comprise several functional sites. These proteins are comprised of a ligand-binding domain, as well as an effector domain that permits the receptor to associate with other cellular proteins, such as G proteins and β-arrestin. Together, these molecules interact as a receptor unit to produce a biological response. These receptors are widely distributed on multiple tissues throughout the body. ADRB2 can be found on neuronal and glial tissues in the central nervous system and on smooth muscle, bone, cartilage, connective tissue, the intestines, lungs, bronchial glands, liver. ADRB2 receptors are present on macrophages and glial cells and when stimulated produce proinflammatory and pro-pain producing cytokines such as IL1β, IL6, and TNFα. ADRB3 are present on smooth muscle, white and brown adipose tissue and in several regions of the central nervous system including the hypothalamus, cortex, and hippocampus, and along the gastrointestinal system. ADRB3 receptors are highly enriched on adipocytes and when stimulated produce proinflammatory and pro-pain producing cytokines such as IL1β, IL6, and TNFα.

“Catechol-O-methyltransferase” (COMT) as used herein refers to an enzyme that functions in part to metabolize catechols and catecholamines, such as epinephrine and norepinephrine by covalently attaching to the catecholamine one or more methyl moieties. The enzyme is widely distributed throughout the body, including the brain. The highest concentrations of COMT are found in the liver and kidney. Most of norepinephrine and epinephrine that is released from the adrenal medulla or by exocytosis from adrenergic fibers is methylated by COMT to metanephrine or normetanephrine, respectively.

“μ-opioid receptor” and “opioid receptor, μ1” (OPRM1) are used interchangeably herein and refer to a peptide that functions as a receptor of a class of opioids, such as for example morphine and codeine, and mediates effects of these opioids.

As used herein, the term “expression” generally refers to the cellular processes by which an RNA is produced by RNA polymerase (RNA expression) or a polypeptide is produced from RNA (protein expression).

The term “gene” is used broadly to refer to any segment of DNA associated with a biological function. Thus, genes include, but are not limited to, coding sequences and/or the regulatory sequences required for their expression. Genes can also include non-expressed DNA segments that, for example, form recognition sequences for a polypeptide. Genes can be obtained from a variety of sources, including cloning from a source of interest or synthesizing from known or predicted sequence information, and can include sequences designed to have desired parameters. For example, “ADRB2 gene” and “ADRB3 gene” are used to refer to gene loci related to the corresponding seven transmembrane domain proteins, which are the core component of the receptor complex.

As used herein, the term “DNA segment” means a DNA molecule that has been isolated free of total genomic DNA of a particular species. Included within the term “DNA segment” are DNA segments and smaller fragments of such segments, and also recombinant vectors, including, for example, plasmids, cosmids, phages, viruses, and the like.

As used herein, the term “genotype” refers to the genetic makeup of an organism. Expression of a genotype can give rise to an organism's phenotype, i.e. an organism's physical traits. The term “phenotype” refers to any observable property of an organism, produced by the interaction of the genotype of the organism and the environment. A phenotype can encompass variable expressivity and penetrance of the phenotype. Exemplary phenotypes include but are not limited to a visible phenotype, a physiological phenotype, a psychological phenotype, a susceptibility phenotype, a cellular phenotype, a molecular phenotype, and combinations thereof. Preferably, the phenotype is related to a pain response variability, including phenotypes related to somatosensory disorders and/or predictions of susceptibility to somatosensory disorders, or related pain sensitivity conditions. As such, a subject's genotype when compared to a reference genotype or the genotype of one or more other subjects can provide valuable information related to current or predictive phenotype.

“Determining the genotype” of a subject, as used herein, can refer to determining at least a portion of the genetic makeup of an organism and particularly can refer to determining a genetic variability in the subject that can be used as an indicator or predictor of phenotype. The genotype determined can be the entire genome of a subject, but far less sequence is usually required. The genotype determined can be as minimal as the determination of a single base pair, as in determining one or more polymorphisms in the subject. Further, determining a genotype can comprise determining one or more haplotypes. Still further, determining a genotype of a subject can comprise determining one or more polymorphisms exhibiting high linkage disequilibrium to at least one polymorphism or haplotype having genotypic value.

As used herein, the term “polymorphism” refers to the occurrence of two or more genetically determined alternative variant sequences (i.e., alleles) in a population. A polymorphic marker is the locus at which divergence occurs. Preferred markers have at least two alleles, each occurring at frequency of greater than 1%. A polymorphic locus may be as small as one base pair.

As used herein, “haplotype” refers to the collective characteristic or characteristics of a number of closely linked loci with a particular gene or group of genes, which can be inherited as a unit. For example, in some embodiments, a haplotype can comprise a group of closely related polymorphisms (e.g., single nucleotide polymorphisms (SNPs)). In some embodiments, the determined genotype of a subject can be particular haplotypes for but not limited to one or more genes associated with somatosensory disorders, such as one or more of the genes listed in Table 4.

As used herein, “linkage disequilibrium” refers to a derived statistical measure of the strength of the association or co-occurrence of two independent genetic markers. Various statistical methods can be used to summarize linkage disequilibrium (LD) between two markers but in practice only two, termed D′ and r2, are widely used.

In some embodiments, determining the genotype of a subject can comprise identifying at least one haplotype of a gene, such as for example one or more genes associated with somatosensory disorders, such as for example one or more of the genes listed in Table 4. In some embodiments, determining the genotype of a subject can comprise identifying at least one polymorphism unique to at least one haplotype of a gene, such as for example one or more polymorphisms listed in Tables 5 and 6 from genes associated with somatosensory disorders. In some embodiments, determining the genotype of a subject can comprise identifying at least one polymorphism exhibiting high linkage disequilibrium to at least one polymorphism unique to at least one haplotype of one or more genes associated with somatosensory disorders, such as for example one or more of the genes listed in Table 4. In some embodiments, determining the genotype of a subject can comprise identifying at least one polymorphism exhibiting high linkage disequilibrium to at least one haplotype of one or more genes associated with somatosensory disorders, such as for example one or more of the genes listed in Table 4.

As used herein, the term “modulate” means an increase, decrease, or other alteration of any, or all, chemical and biological activities or properties of a wild-type or mutant polypeptide, such as for example COMT, ADRB2, ABRB3, OPRM1, or other polypeptides expressed by the genes listed in Table 4, including combinations thereof. A peptide can be modulated at either the level of expression, e.g., modulation of gene expression (for example, anti-sense therapy, siRNA or other similar approach, gene therapy, including exposing the subject to a gene therapy vector encoding a gene of interest or encoding a nucleotide sequence that influences expression of a gene of interest), or at the level of protein activity, e.g., administering to a subject an agonist or antagonist of a receptor or enzyme polypeptide. The term “modulation” as used herein refers to both upregulation (i.e., activation or stimulation) and downregulation (i.e. inhibition or suppression) of a response.

As used herein, the term “mutation” carries its traditional connotation and means a change, inherited, naturally occurring or introduced, in a nucleic acid or polypeptide sequence, and is used in its sense as generally known to those of skill in the art.

As used herein, the term “polypeptide” means any polymer comprising any of the 20 protein amino acids, regardless of its size. Although “protein” is often used in reference to relatively large polypeptides, and “peptide” is often used in reference to small polypeptides, usage of these terms in the art overlaps and varies. The term “polypeptide” as used herein refers to peptides, polypeptides and proteins, unless otherwise noted. As used herein, the terms “protein”, “polypeptide” and “peptide” are used interchangeably herein when referring to a gene product.

“Somatization” as used herein refers to an individual's report of distress arising from the perception of bodily dysfunction. Complaints typically focus on cardiovascular, gastrointestinal, respiratory and other systems with strong autonomic mediation. Aches and pain, and discomfort are frequently present and localized in the gross musculatures of the body.

“Somatosensory disorder” as used herein refers to clinical conditions characterized by the perception of persistent pain, discomfort or unpleasantness in various regions of the body. These conditions are generally, but not always, associated with enhanced sensitivity to pain and/or somatization. On occasion, these conditions are observed without currently known measures of tissue pathology. Exemplary somatosensory disorders include, but are not limited to chronic pain conditions, idiopathic pain conditions, fibromyalgia syndrome, myofascial pain disorders, tension headache, migraine headache, phantom limb sensations, irritable bowel syndrome, chronic lower back pain, chronic fatigue syndrome, multiple chemical sensitivities, temporomandibular joint disorder, post-traumatic stress disorder, chronic idiopathic pelvic pain, Gulf War Syndrome, vulvar vestibulitis, osteoarthritis, rheumatoid arthritis, angina pectoris, postoperative pain (e.g., acute postoperative pain), and neuropathic pain. A general characteristic of a specific somatosensory disorder is that it is often associated with at least one additional or multiple co-morbid somatosensory disorders.

A “subject” as the term is used herein generally refers to an animal. In some embodiments, a preferred animal subject is a vertebrate subject. Further, in some embodiments, a preferred vertebrate is warm-blooded and a preferred warm-blooded vertebrate is a mammal. A preferred mammal is most preferably a human. However, as used herein, the term “subject” includes both human and animal subjects. Thus, veterinary therapeutic uses are provided in accordance with the presently disclosed subject matter.

As such, the presently disclosed subject matter provides for the analysis and treatment of mammals such as humans, as well as those mammals of importance due to being endangered, such as Siberian tigers; of economic importance, such as animals raised on farms for consumption by humans; and/or animals of social importance to humans, such as animals kept as pets or in zoos. Examples of such animals include but are not limited to: carnivores such as cats and dogs; swine, including pigs, hogs, and wild boars; ruminants and/or ungulates such as cattle, oxen, sheep, giraffes, deer, goats, bison, and camels; and horses. A “subject” as the term is used herein can further include birds, such as for example those kinds of birds that are endangered and/or kept in zoos, as well as fowl, and more particularly domesticated fowl, i.e., poultry, such as turkeys, chickens, ducks, geese, guinea fowl, and the like, as they are also of economical importance to humans. Thus, “subject” further includes livestock, including, but not limited to, domesticated swine, ruminants, ungulates, horses (including race horses), poultry, and the like.

“Treatment” as used herein refers to any treatment of an instantly disclosed disorder and includes: (i) preventing the disorder from occurring in a subject which may be predisposed to the disorder, but has not yet been diagnosed as having it; (ii) inhibiting the disorder, i.e., arresting its development; or (iii) relieving the disorder, i.e., causing regression of clinical symptoms of the disorder.

### III. METHODS OF PREDICTING ENHANCED PAIN SENSITIVITY AND RISK OF DEVELOPING SOMATOSENSORY DISORDERS

The onset of somatosensory disorders is associated with both physical (e.g., joint trauma or muscle trauma) and psychological (e.g., psychological or emotional stress) triggers that initiate pain amplification and psychological distress. However, each individual will develop these conditions with different probability. This probability is defined by a complex interaction between the individual's genetic background and the extent of exposure to a variety of environmental events. Elucidation of the neurological and psychological factors that contribute to pain amplification and psychological distress, as well as the underlying genetics, can contribute to the identification of the pathophysiological mechanisms that evoke painful sensations in patients with a variety of somatosensory disorders and even predict whether a subject is likely to develop a somatosensory disorder or predict how a subject will respond to a treatment strategy addressing pain management. Moreover, there is a considerable need to develop methodologies that permit the sub-classification of somatosensory disorders based on the specific network of genetic variations in each individual, which can permit better and more informed individually-based treatments.

As such, the presently disclosed subject matter provides for identification of psychological and physiological risk factors, and associated genotypes that influence pain amplification and psychological and/or neurological profiles in subjects, which are predictive of somatosensory disorders. Additionally, the biological pathways through which these genotypes causally influence somatosensory disorder risk can be characterized. A number of candidate genes associated with somatosensory disorders are disclosed herein (See e.g., Table 4). The identified genes can optionally be classified into four major clusters: genes that are able to influence 1) the activity of peripheral afferent pain fibers, 2) central nervous system pain processing systems, 3) the activity of peripheral cells (e.g., monocytes) that release proinflammatory mediators, and 4) the production of proinflammatory mediators from cells within the central nervous system (e.g., microglia and astrocytes).

As disclosed in Tables 5 and 6 for example, the presently disclosed subject matter provides polymorphisms in listed genes that represent areas of genetic vulnerability, which when coupled to environmental triggers can contribute to enhanced pain perception, psychological dysfunction, and risk of onset and persistence of somatosensory disorders. Because environmental factors strongly influence pain and psychological profiles, assessments of individuals' pain sensitivity, autonomic function, and psychological distress can also be obtained to delineate the degree to which specific genetic polymorphisms and environmental factors interact to produce the observed clinical signs and symptoms.

The presently disclosed subject matter provides for determining a genotype of a subject with respect to particular genes having a role in determining pain sensitivity in the subject. Thus, determining the genotype of the subject can elucidate pain processing and psychosocial phenotypes in the subject, which in turn can be used to predict a subject's pain sensitivity and risk for development of a somatosensory disorder (FIG. 1). The present subject matter discloses for the first time a compilation of genes associated with somatosensory disorders (Table 4), which encode for proteins that can each, and in combination with one another, play a role in pain perception or sensitivity. Thus, genotyping one or more of these genes, and in some embodiments with regard to polymorphisms disclosed in Tables 5 and 6, can provide valuable information related to pain sensitivity useful for predicting responses to pain, susceptibility to develop somatosensory disorders and even insights into selecting effective therapies to treat somatosensory disorders and managing pain therapies.

III.A. Methods of Predicting Susceptibility to Develop Somatosensory Disorders and Class

The presently disclosed subject matter provides in some embodiments methods of predicting susceptibility of a subject, i.e. the predisposition of or risk of the subject, to develop a somatosensory disorder. In some embodiments, the method comprises determining a genotype of the subject with respect to one or more genes associated with somatosensory disorders, such as for example one or more genes selected from Table 4; and comparing the genotype of the subject with one or more of reference genotypes associated with susceptibility to develop the somatosensory disorder, whereby susceptibility of the subject to develop the somatosensory disorder is predicted.

“Reference genotype” as used herein refers to a previously determined pattern of unique genetic variation associated with a particular phenotype, such as for example pain perception or sensitivity. The reference genotype can be as minimal as the determination of a single base pair, as in determining one or more polymorphisms in the subject. Further, the reference genotype can comprise one or more haplotypes. Still further, the reference genotype can comprise one or more polymorphisms exhibiting high linkage disequilibrium to at least one polymorphism or haplotype. In some particular embodiments, the reference genotype comprises one or more haplotypes of genes listed in Table 4 determined to be associated with pain sensitivity, including for example pain response prediction, susceptibility to a somatoform disorder, and/or somatization. In some embodiments, the haplotypes represent a particular collection of specific single nucleotide polymorphisms, such as for example one or more of the SNPs set forth in Tables 5 and 6. For example, Table 6 shows an exemplary list of SNPs from genes associated with somatosensory disorders. Each SNP was tested for correlation with a psychosocial or neurological characteristic associated with somatosensory disorders, such as pain sensitivity, somatization, depression, trait anxiety and blood pressure. The results of the correlation analysis are indicated in Table 6. Thus, a genotype from a subject matching a compared reference genotype, such as those set forth in Table 6 for example, could be correlated with an increased susceptibility to develop a somatosensory disorder. The reference genotypes therefore can be utilized for predicting susceptibility to somatosensory disorders and related conditions based on matching determined genotypes of a subject to the reference genotypes.

In some embodiments of the methods of predicting susceptibility of a subject to develop a somatosensory disorder disclosed herein, determining the genotype of the subject comprises:
(i) identifying at least one haplotype from each of the one or more genes selected from Table 4;
(ii) identifying at least one polymorphism unique to at least one haplotype from each of the one or more genes selected from Table 4;
(iii) identifying at least one polymorphism exhibiting high linkage disequilibrium to at least one polymorphism unique to each of the one or more genes selected from Table 4;
(iv) identifying at least one polymorphism exhibiting high linkage disequilibrium to at least one of the one or more genes selected from Table 4; or
(v) combinations thereof.

In some embodiments, the at least one polymorphism unique to the at least one haplotype is at least one single nucleotide polymorphism from Table 5 or Table 6. The determined genotype of the subject is then compared to one or more reference genotypes associated with susceptibility to develop a somatosensory disorder and if the determined genotype matches the reference genotype, the subject is predicted to be susceptible to a particular degree (as compared to a population norm) to develop a somatosensory disorder.

As indicated above, the determined genotype need not necessarily be determined based on a need to compare the determined genotype to the reference genotype in particular, but rather can be for example one or more polymorphisms exhibiting high linkage disequilibrium to a polymorphism or haplotype or combinations thereof, which can be equally predictive of susceptibility to develop a somatosensory disorder. One of ordinary skill would appreciate that any one or more polymorphisms exhibiting high linkage disequilibrium to a polymorphism or haplotype of the determined genotype with regard to genes associated with somatosensory disorders could likewise be effective as a substitute or additional component of or as a substitute for the determined genotype.

In some embodiments, predicting susceptibility of a subject to develop a somatosensory disorder comprises predicting a pain response in the subject. Further, in some embodiments, predicting susceptibility of a subject to develop a somatosensory disorder comprises predicting somatization in the subject.

In some embodiments, the presently disclosed subject matter provides methods of classifying a somatosensory disorder afflicting a subject. The methods comprise in some embodiments determining a genotype of the subject with respect to one or more genes selected from Table 4; and classifying the somatosensory disorder into a genetic subclass somatosensory disorder based on the determined genotype of the subject.

Classifying the somatosensory disorder into a genetic subclass somatosensory disorder can be utilized in some embodiments to select an effective therapy for use in treating the genetic subclass somatosensory disorder.

In some embodiments of the methods, determining the genotype of the subject to classify the genetic subclass of the somatosensory disorder comprises:
(i) identifying at least one haplotype from each of the one or more genes selected from Table 4;
(ii) identifying at least one polymorphism unique to at least one haplotype from each of the one or more genes selected from Table 4;
(iii) identifying at least one polymorphism exhibiting high linkage disequilibrium to at least one polymorphism unique to each of the one or more genes selected from Table 4;
(iv) identifying at least one polymorphism exhibiting high linkage disequilibrium to at least one of the one or more genes selected from Table 4; or
(v) combinations thereof.

In some embodiments, the at least one polymorphism unique to the at least one haplotype is a single nucleotide polymorphism from Table 5 or Table 6. The determined genotype of the subject is then compared to one or more reference genotypes associated with susceptibility to develop a somatosensory disorder and if the determined genotype matches the reference genotype, the somatosensory disorder of the subject is classified into a genetic subclass somatosensory disorder.

III.B. Methods of Selecting and Predicting a Response to a Therapy

The presently disclosed subject matter further provides that pain sensitivity-related haplotypes can be used to guide pharmacological treatment decisions regarding the treatment of acute (e.g., as a result of surgical procedures), persistent or chronic pain and inflammatory conditions, such as for example somatosensory disorders. As such, the presently disclosed subject matter provides in some embodiments methods for selecting a therapy and/or predicting a response to a therapy for a subject having a somatosensory disorder or determined to be susceptible to developing a somatosensory disorder, including for example postoperative pain and related pain sensitivity conditions.

As one example, opioid analgesics are the most widely used drugs to treat moderate to severe pain, yet in addition to profound analgesia, these agents also produce significant side effects consisting of miosis, pruritus, sedation, nausea and vomiting, cognitive impairment, constipation, rapid onset hypotension and on occasion life-threatening respiratory depression (Ready, 2000; Rowlingson & Murphy, 2000; Inturrisi, 2002; Goldstein, 2002). There is considerable inter-individual variability in the clinical response to opioid analgesics. For example, the minimal effective analgesic concentration (MEAC) of the fentanyl varies from 0.2 to 2.0 ng/ml among patients (Glass, 2000). Similarly, MEACs for other opioids, including morphine, pethidine, alfentanil and sufentanil, vary among patients by factors of 5 to 10 (Glass, 2000; Camu & Vanlersberghe, 2002). Furthermore, despite the fact that most clinically used opioids are selective for μ-opioid receptors (MOR), as defined by their selectivity in receptor binding assays, patients may respond far better to one μ-opioid than another, both with respect to analgesic responsiveness and side-effects (Galer et al., 1992). As such, there is a substantial need to develop new biological markers that will provide valid and reliable predictions of individual responses to opioid therapies. The presently disclosed subject matter provides disclosure of genetic markers for selecting and predicting responses to therapies, including opioid analgesic therapies.

In some embodiments, the method comprises determining a genotype of the subject with respect to one or more genes selected from Table 4 and selecting a therapy, predicting a response to a therapy, or both, based on the determined genotype of the subject. In some embodiments of the method, determining the genotype of the subject comprises:
(i) identifying at least one haplotype from each of the one or more genes selected from Table 4;
(ii) identifying at least one polymorphism unique to at least one haplotype from each of the one or more genes selected from Table 4;
(iii) identifying at least one polymorphism exhibiting high linkage disequilibrium to at least one polymorphism unique to each of the one or more genes selected from Table 4;
(iv) identifying at least one polymorphism exhibiting high linkage disequilibrium to at least one of the one or more genes selected from Table 4; or
(v) combinations thereof.

In some embodiments, the at least one polymorphism unique to the at least one haplotype is a single nucleotide polymorphism from Table 5 or Table 6.

In some embodiments, the therapy is selected from the group consisting of a pharmacological therapy, a behavioral therapy, a psychotherapy, a surgical therapy, and combinations thereof. In some embodiments, the subject is undergoing or recovering from a surgical therapy, such as for example a back surgery, medical implant procedures (e.g., CNS stimulators for pain relief, joint implant procedures, dental implant procedures (e.g., tooth implants), or cosmetic/plastic surgery, and the method comprises selecting a pain management therapy, predicting a response to a pain management therapy, or both based on the determined genotype of the subject. In some embodiments, the therapy is a behavioral therapy comprising treating the subject with biofeedback therapy and/or relaxation therapy.

III.C. Methods of Determining a Genotype in Combination with a Psychosocial and/or Neurological Assessment

A consistent predictor of developing a somatosensory disorder is the presence of another chronic pain condition at the baseline session (Von Korff et al., 1988). The subject matter disclosed herein indicates that factors that influence pain sensitivity (e.g., psychological factors and symptom perception) can contribute to the development of a variety of somatosensory disorders independent of anatomical sites. Pain sensitivity can also be a risk factor for somatosensory disorders. Furthermore, genetic polymorphisms that are associated with pain sensitivity can predict the risk of onset and persistence of somatosensory and related pain perception disorders.

A linkage of pain perception with somatosensory disorders can be utilized to predict susceptibility to develop somatosensory and related disorders. As such, the presently disclosed subject matter provides methods for predicting susceptibility of a subject to develop a somatosensory disorder, classifying a somatosensory disorder, and/or selecting a therapy and/or predicting a response to a therapy for treating pain disorders including somatosensory disorders by determining a genotype of a subject in combination with determining a psychosocial and/or neurological assessment associated with pain sensitivity of the subject.

In some embodiments, the methods comprise determining a psychosocial assessment, a neurological assessment, or both, of a subject; determining a genotype of the subject with respect to one or more genes selected from Table 4; and then predicting susceptibility of the subject to develop a somatosensory disorder, classifying a somatosensory disorder afflicting the subject, and/or selecting a therapy and/or predicting a response to a therapy based on the determined psychosocial assessment, neurological assessment, or both, and the determined genotype of the subject.

In some embodiments, determining the psychosocial assessment of the subject comprises testing the subject with at least one psychosocial questionnaire comprising one or more questions that each assess anxiety, depression, somatization, stress, cognition, pain perception, or combinations thereof of the subject. In some embodiments, the psychosocial questionnaire can be one or more questionnaires selected from the group consisting of Eysenck Personality Questionnaire, Life Experiences Survey, Perceived Stress Scale, State-Trait Anxiety Inventory (STAI) Form Y-2, STAI Form Y-1, Pittsburgh Sleep Quality Index, Kohn Reactivity Scale, Pennebaker Inventory for Limbic Languidness, Short Form 12 Health Survey v2, SF-36, Pain Catastrophizing Scale, In vivo Coping Questionnaire, Coping Strategies Questionnaire-Rev, Lifetime Stressor List & Post-Traumatic Stress Disorder (PTSTD) Checklist for Civilians, Multidimensional Pain Inventory v3, Comprehensive Pain & Symptom Questionnaire, Symptom Checklist-90-R (SCL-90R), Brief Symptom Inventory (BSI), Beck Depression Inventory (BDI), Profile of Mood States Bi-polar, Pain Intensity Measures, and Pain Unpleasantness Measures.

In some embodiments, determining the neurological state of the subject comprises testing the subject with at least one neurological testing apparatus. In some embodiments, the neurological testing apparatus can be one or more apparatus selected from the group consisting of Thermal Pain Delivery and Measurement Devices, Mechanical Pain Delivery and Measurement Devices, Ischemic Pain Delivery and Measurement Devices, Chemical Pain Delivery and Measurement Devices, Electrical Pain Delivery and Measurement Devices, Vibrotactile Delivery and Measurement Devices, Blood Pressure Measuring Devices, Heart Rate Measuring Devices, Heart Rate Variability Measuring Devices, Baroreceptor Monitoring Devices, Cardiac Output Monitoring Devices, Blood Flow Monitoring Devices, and Skin Temperature Measuring Devices.

In some embodiments, determining the genotype of the subject comprises:
(i) identifying at least one haplotype from each of the one or more genes selected from Table 4;
(ii) identifying at least one polymorphism unique to at least one haplotype from each of the one or more genes selected from Table 4;
(iii) identifying at least one polymorphism exhibiting high linkage disequilibrium to at least one polymorphism unique to each of the one or more genes selected from Table 4;
(iv) identifying at least one polymorphism exhibiting high linkage disequilibrium to at least one of the one or more genes selected from Table 4; or
(v) combinations thereof.

In some embodiments, the at least one polymorphism unique to the at least one haplotype is a single nucleotide polymorphism from Table 5 or Table 6.

### IV. SYSTEMS AND KITS FOR PREDICTING, DIAGNOSING AND TREATING SOMATOSENSORY DISORDERS

As disclosed herein, the presently disclosed subject matter provides novel genetic, physiological and psychological risk factors for predicting and diagnosing, and selecting therapies for somatosensory disorders. The disclosure set forth herein makes possible for the first time the development of medical devices that capitalize on the presently disclosed discoveries in the physiology, psychology and genetics of pain conditions. As such, the presently disclosed subject matter provides systems for pain diagnosis and therapies. In some embodiments, the systems are medical devices or suites that can comprise one or more of the following components: 1) a pain genetics platform (e.g., an array comprising polynucleotide probes); 2) hardware for psychophysical neurological testing of pain systems, sensory function, and autonomic nervous system activity; 3) at least one psychosocial questionnaire, which can in some embodiments be automated; and 4) diagnostic and treatment software algorithms.

The presently disclosed systems provide for the use of medical devices and software routines that permit: 1) more accurate diagnoses and subclassification of somatosensory disorders including persistent pain conditions; 2) the tailoring of pharmacotherapies and behavioral interventions for the treatment of somatosensory disorders and the management of acute pain; and 3) better predictions of treatment responses, which can improve clinical outcomes and reduce treatment cost. The systems enable healthcare providers to determine why pain occurs in a patient and how that patient should be treated to eliminate or manage acute and chronic pain. The presently disclosed systems provide unique benefit to the medical community by improving patient care and reducing healthcare costs. Further, the presently disclosed systems can provide benefits to the pharmaceutical industry as well as the systems can expedite development and validation of novel therapeutic agents for chronic pain.

In some embodiments of the presently disclosed subject matter, an array of polynucleotide probes is provided. A “polynucleotide probe” refers to a biopolymer comprising one or more nucleic acids, nucleotides, nucleosides and/or their analogs. The term also includes nucleotides having modified sugars as well as organic and inorganic leaving groups attached to the purine or pyrimidine rings. In some embodiments, the array can be provided alone, as part of a kit, or as part of the system disclosed hereinabove and further including at least one neurological testing apparatus and/or at least one psychosocial questionnaire. In some embodiments, the array comprises a substrate and a plurality of polynucleotide probes arranged at specific locations on the substrate, wherein each probe has a binding affinity for a different polynucleotide sequence comprising a polymorphism associated with one or more somatosensory disorders, such as for example one or more single nucleotide polymorphisms selected from Tables 5 and 6.

The term “binding affinity” as used herein refers to a measure of the capacity of a probe to hybridize to a target polynucleotide with specificity. Thus, the probe comprises a polynucleotide sequence that is complementary, or essentially complementary, to at least a portion of the target polynucleotide sequence. Nucleic acid sequences which are “complementary” are those which are base-pairing according to the standard Watson-Crick complementarity rules. As used herein, the term “complementary sequences” means nucleic acid sequences which are substantially complementary, as can be assessed by the same nucleotide comparison set forth above, or as defined as being capable of hybridizing to the nucleic acid segment in question under relatively stringent conditions such as those described herein. A particular example of a contemplated complementary nucleic acid segment is an antisense oligonucleotide. With regard to probes disclosed herein having binding affinity to SNPs, such as for example those set forth in Tables 5 and 6, the probe must necessarily be 100% complementary with the target polynucleotide sequence at the polymorphic base. However, the probe need not necessarily be completely complementary to the target polynucleotide along the entire length of the target polynucleotide so long as the probe can bind the target polynucleotide comprising the polymorphism with specificity.

Nucleic acid hybridization will be affected by such conditions as salt concentration, temperature, or organic solvents, in addition to the base composition, length of the complementary strands, and the number of nucleotide base mismatches between the hybridizing nucleic acids, as will be readily appreciated by those skilled in the art. Stringent temperature conditions will generally include temperatures in excess of 30° C., typically in excess of 37° C., and preferably in excess of 45° C. Stringent salt conditions will ordinarily be less than 1,000 mM, typically less than 500 mM, and preferably less than 200 mM. However, the combination of parameters is much more important than the measure of any single parameter. (See, e.g., Wetmur & Davidson, 1968). Determining appropriate hybridization conditions to identify and/or isolate sequences containing high levels of homology is well known in the art. (See e.g., Sambrook et al., 1989). For the purposes of specifying conditions of high stringency, preferred conditions are a salt concentration of about 200 mM and a temperature of about 45° C.

In some embodiments, the substrate comprises a plurality of addresses. Each address can be associated with at least one of the polynucleotide probes of the array. An array is “addressable” when it has multiple regions of different moieties (e.g., different polynucleotide sequences) such that a region (i.e., a “feature” or “spot” of the array) at a particular predetermined location (i.e., an “address”) on the array will detect a particular target or class of targets (although a feature may incidentally detect non-targets of that feature). Array features are typically, but need not be, separated by intervening spaces. In the case of an array, the “target” polynucleotide sequence comprising a polymorphism of interest can be referenced as a moiety in a mobile phase (typically fluid), to be detected by probes (“target probes”) which are bound to the substrate at the various regions. “Hybridizing” and “binding”, with respect to polynucleotides, are used interchangeably.

Biopolymer arrays (e.g., polynucleotide arrays) can be fabricated by depositing previously obtained biopolymers (such as from synthesis or natural sources) onto a substrate, or by in situ synthesis methods. Methods of depositing obtained biopolymers include, but are not limited to, loading then touching a pin or capillary to a surface, such as described in U.S. Pat. No. 5,807,522 or deposition by firing from a pulse jet such as an inkjet head, such as described in PCT publications WO 95/25116 and WO 98/41531, and elsewhere. The in situ fabrication methods include those described in U.S. Pat. No. 5,449,754 for synthesizing peptide arrays, and in U.S. Pat. No. 6,180,351 and WO 98/41531 and the references cited therein for polynucleotides, and may also use pulse jets for depositing reagents. Further details of fabricating biopolymer arrays by depositing either previously obtained biopolymers or by the in situ method are disclosed in U.S. Pat. Nos. 6,242,266, 6,232,072, 6,180,351, and 6,171,797. In fabricating arrays by depositing previously obtained biopolymers or by in situ methods, typically each region on the substrate surface on which an array will be or has been formed (“array regions”) is completely exposed to one or more reagents. For example, in either method the array regions will often be exposed to one or more reagents to form a suitable layer on the surface that binds to both the substrate and biopolymer or biomonomer. In in situ fabrication the array regions will also typically be exposed to the oxidizing, deblocking, and optional capping reagents. Similarly, particularly in fabrication by depositing previously obtained biopolymers, it can be desirable to expose the array regions to a suitable blocking reagent to block locations on the surface at which there are no features from non-specifically binding to target.

When part of a kit, the kit can comprise the array and a set of instructions for using the array. The instructions in some embodiments can comprise instructions for interpreting results from the array.

As noted herein, chronic and acute pain can result from the interaction between neurological and inflammatory processes that influence the processing of pain signals and central nervous system processes that influence psychological states such as anxiety, depression, perceived stress, and somatization. Multiple genetic factors influence the neurological, inflammatory, and psychological processes that influence pain perception and the responses to pharmacotherapeutics used to treat acute and chronic pain conditions. In some embodiments of the arrays disclosed herein for detecting polymorphisms associated with pain perception and somatosensory disorders, the arrays can comprise probes permitting the assessment of ˜3500 genetic polymorphisms (e.g., SNPs) associated with over 300 genes implicated in key pathways that regulate the perception of pain and responses to drugs used to treat pain. In some embodiments, the arrays permit the assessment of three types or “clusters” of genetic polymorphisms associated with different aspects of somatosensory disorders: Cluster 1 assesses genetic polymorphisms that influence the transmission of pain (e.g., opioid pathways, catecholamine pathways, cholinergic pathways, serotonin pathways, ion channel pathways, etc.); Cluster 2 assesses polymorphisms in genes that mediate inflammatory responses to tissue injury and physiological stress (e.g., prostaglandin pathways, cytokine pathways, glucocorticoid pathways, etc.); and Cluster 3 assesses polymorphisms in genes that influence mood and affect (e.g., catecholamine and serotonin transporters, dopamine pathways, etc.). Many of the genes analyzed in the three clusters also code for proteins that mediate or modify the therapeutic effects of pharmacological agents used to treat pain, inflammation, affect and mood (e.g., opioids, NSAIDs, channel blockers/modifiers, antidepressants, anticonvulsants).

In some embodiments, selecting polymorphisms within the locus of each gene can comprise selecting a set of SNPs that cover the allelic diversity, including potentially functional variations. An initial pool of SNPs can be selected, for example, using the HapMap (Nature (2005) 437: 1299-1320) and/or Tamal (Hemminger et al., 2006) databases, as disclosed in greater detail in the Examples. Selected SNPs can then be further narrowed based on the following criteria. First, selections can be restricted of the SNP requiring a minor allele frequency in population of >0.05 because relatively abundant SNPs rather than rare mutations are more likely to contribute to complex traits like pain responsiveness, complex pain disorders, and drug responsiveness (Risch, 2000). Second, SNPs can be selected that are predicted or known to impact gene function, such as for example SNPs in the coding region, exon-intron junctions, 5′ promoter regions, putative transcription factor binding sites (TFBS), and 3′ and 5′ untranslated regions (UTRs), as well as other highly evolutionary conserved genomic regions. Third, in the intronic regions, equally spaced SNPs can be selected at desired intervals, such as for example about 4 kb, to cover the haplotypic structure of the loci, with the exception of very large genes that exceed 200 kb. In addition, a panel of ancestry-informative markers (AIM) can be included to control for population stratification (Enoch et al., 2006).

In addition to an array for detecting polymorphisms associated with somatosensory disorders and pain perception, the presently disclosed system can comprise at least one neurological testing apparatus for determining a neurological assessment of the subject and/or at least one psychosocial questionnaire for determining a psychosocial assessment of the subject. In some embodiments, the system can further comprise software for assessing results of the array, the neurological testing apparatus, and/or the psychosocial questionnaire. In some embodiments, the software provides predictive information related to likely pain responses to surgical and non-surgical interventions, diagnostic information, therapeutic information, or both related to a somatosensory disorder about the subject.

One or more neurological testing apparatus known in the art for assessing psychophysical neurological aspects of a subject can be incorporated in the system, such as for example devices for assessing pain perception, sensory function, and devices for assessing autonomic function.

Exemplary neurological pain and sensory perception testing apparatus include, but are not limited to, Thermal Pain Delivery and Measurement Devices, Mechanical Pain Delivery and Measurement Devices (e.g., pressure pain devices), Ischemic Pain Delivery and Measurement Devices, Chemical Pain Delivery and Measurement Devices, and Electrical Pain Delivery and Measurement Devices, Vibrotactile Delivery and Measurement Devices. Exemplary neurological autonomic function testing apparatus include, but are not limited to Blood Pressure Measuring Devices, Heart Rate Measuring Devices, Heart Rate Variability Measuring Devices, Baroreceptor Monitoring Devices, Cardiac Output Monitoring Devices, Blood Flow Monitoring Devices, and Skin Temperature Measuring Devices.

In some embodiments, pressure pain assessments can be made using pressure pain delivery and measurement devices. For example, pressure pain thresholds can be assessed over one or more parts of a subject's body, such as for example, the right and left temporalis muscles, masseter muscles, trapezius muscles, temporomandibular joints, and ventral surfaces of the wrists using, for example, a hand-held pressure algometer (e.g., available from Pain Diagnosis and Treatment, Great Neck, N.Y., U.S.A.) using methods, for example, similar to those described previously (Jaeger & Reeves, 1986). Briefly, the algometer's tip can consist of a flat 10 mm diameter rubber pad. Pressure stimuli can be delivered at an approximate rate of 1 kg/sec. Participants can be instructed to signal either verbally or by a hand movement when the pressure sensation first becomes painful. When this occurs, the stimulus can be removed. The pressure pain threshold can be defined as the amount of pressure (kg) at which the subjects first perceive to be painful. The pressure application can be prevented from exceeding a predetermined safe amount, for example 6 kg for the wrists and 4 kg for other sites. Attained values can be entered into the calculation for the subject's pressure pain thresholds. One pre-trial assessment can be performed at each site followed by two additional assessments. The two values from the right and left sides can then be averaged to obtain one pressure pain threshold value per test site, yielding a total of four measures.

In some embodiments, thermal pain thresholds and tolerances can be assessed using thermal pain delivery and measurement devices (e.g., available from MEDOC Inc., Durham, N.C., U.S.A.). For example, a modified “Marstock” procedure (Fruhstorfer et al., 1976; Fagius & Wahren, 1981) can be used to measure thermal pain thresholds and tolerances with a 10 mm diameter computer-controlled contact thermal stimulator. Thermal stimuli can be applied, for example, to the skin overlying the right masseter muscle, the skin overlying the right hairy forearm, and/or the skin overlying the dorsal surface of the right foot. Thermal pain threshold can be defined as the temperature (° C.) at which the subjects perceive the thermal stimuli as painful, whereas thermal pain tolerance can be defined as the temperature (° C.) at which the subjects can no longer tolerate the thermal stimulus.

In some embodiments, two separate procedures can be used to assess thermal pain thresholds and a third procedure can be used to assess thermal pain tolerance, each at three anatomical sites. The first set of thermal stimuli can be delivered from a neutral adapting temperature of 32° C. at a rate of 5° C./sec, which has been proposed to produce a relatively selective activation of Aδ-fibers (Price, 1996; Yeomans et al., 1996). During this procedure, subjects can be instructed to depress a mouse key when they first perceive thermal pain. This causes the thermode to return to the baseline temperature and the reversal temperature can be defined as the Aδ mediated thermal pain threshold temperature. This procedure can be repeated six times and the values from these six trials averaged to obtain the temperature value of Aδ mediated thermal pain threshold. The same procedure can be repeated with a second set of thermal stimuli delivered at a rate of 0.5° C./sec. This procedure has been proposed to produce a relatively selective activation of C-fibers Price, 1996; Yeomans et al., 1996). Finally, C-fiber thermal pain tolerance can be determined by using a third set of thermal stimuli delivered at the rate of 0.5° C./sec. Subjects can be instructed to depress a mouse key when the probe temperature achieves a level that they can no longer tolerate. The probe temperature can be prevented from exceeding 53° C. to assure safety to the subject. When values approximating 53° C. are attained, the trial can be terminated and this value then entered into the calculation for the subject's tolerance value. The values obtained from six repeated thermal trials can be averaged to obtain a subject's C-fiber thermal pain tolerance value. This methodology yields nine measures: two threshold measures and one tolerance measure, each at three anatomical sites.

A procedure similar to that described previously (Price et al., 1977) can also be used to examine the temporal summation of C fiber mediated thermal pain. A total of fifteen 53° C. heat pulses can be applied to skin overlying the thenar region of the right hand. Each heat pulse can be, for example, 1.5 sec in duration and delivered at a rate of 10° C./sec from a 40° C. base temperature with an inter-trial interval of 1.5 sec. In effect, this produces a transient 53° C. heat pulse with a peak-to-peak inter-pulse interval of 3 seconds. Subjects can be instructed to verbally rate the intensity of each thermal pulse using a 0 to 100 numerical scale with ‘0’ representing ‘no sensation’, ‘20’ representing ‘just painful’, and ‘100’ representing ‘the most intense pain imaginable’. Subjects can be informed that the procedure will be terminated when they reported a value of ‘100’ or when 15 trials had elapsed. For subjects who terminate the procedure prior to the completion of 15 trials, a value of 100 can be assigned to the subsequent missing trials. Each subject's ability to summate C-fiber pain can be quantified by adding values of all 15 verbal responses. This value can be used as a single measurement of the temporal summation of C fiber mediated thermal pain.

In some embodiments, ischemic pain threshold and tolerance can be assessed using ischemic pain delivery and measurement devices. For example, a modified submaximal effort tourniquet procedure (Maixner et al., 1990) can be used to evoke ischemic pain. For this procedure, the subject's arm can be elevated and supported in a vertical position for 30 sec to promote venous drainage. Then, a blood pressure arm cuff positioned above the elbow can be inflated sufficiently to abolish arterial blood supply and to render the arm hypoxic (e.g., to 220 mmHg). A stopwatch can be started at the time of cuff inflation and the subject's arm then lowered to a horizontal position. Immediately afterward, the subject begins squeezing a handgrip dynamometer at 30% of maximum force of grip for a select number of repetitions, for example 20 repetitions. Prior to the procedure, the subject's maximum grip strength can be determined by having each subject squeeze the dynamometer with ‘as much force as possible’. The onset, duration, and magnitude of each handgrip squeeze can be signaled by computer-controlled signal lights to ensure standardized compression and relaxation periods. Ischemic pain threshold can be determined by recording the time (seconds) when subjects first report hand or forearm discomfort. Ischemic pain tolerance can be determined by recording the time (seconds) when subjects can no longer endure their ischemic arm pain. The tourniquet can remain in place for 25 minutes or until pain tolerance has been achieved, for example. This procedure yields two measures: ischemic pain threshold and ischemic pain tolerance.

In addition or alternatively to assessing pain perception using pain perception devices, autonomic function can be assessed to further the neurological testing. For example, resting systolic and diastolic blood pressures can be assessed with an automatic blood pressure monitor placed on the arm, as is generally known in the art. For example, five measures obtained at 2 minute intervals after a 15 minute rest period can be averaged to derive measures of resting systolic and diastolic arterial blood pressure. Commercially available equipment can be used to measure heart rate variability, baroreceptor receptor function, and skin temperature, for example.

Pain regulatory systems that are associated with resting levels of arterial blood pressure represent one of the biological systems responsible for pain amplification (Bragdon et al., 2002; Maixner et al., 1997). Many central nervous system pathways that regulate cardiovascular function are also involved in pain regulation (Randich & Maixner, 1984; Bruehl & Chung, 2004). In general, higher levels of resting arterial blood pressure are associated with diminished sensitivity to thermal, mechanical, and ischemic stimuli (Maixner et al., 1997; Randich & Maixner, 1984; Bruehl & Chung, 2004; Fillingim et al., 1998; Fillingim & Maixner, 1996; Pfleeger et al., 1997; Maixner, 1991). The mechanisms by which arterial blood pressure influences pain perception have not been fully elucidated, but it has been proposed that activation of blood pressure-dependent baroreceptor pathways modulates the central processing of nociceptive information by engaging central pain inhibitory networks (Maixner et al., 1995a; Maixner et al., 1995b; Randich & Maixner, 1984; Maixner, 1991). It has also been suggested that endogenous opioid and adrenergic systems contribute to the inverse relationship between blood pressure and pain sensitivity. This is supported by both animal and human studies which have shown: 1) several regions of the brain which support opioid-mediated and α₂-adrenergic receptor analgesia also contribute to the regulation of arterial blood pressure (Randich & Maixner, 1984; Bruehl & Chung, 2004) and 2) opioid receptor and α-adrenergic receptor blockade disrupts the relationship between blood pressure and pain sensitivity (Bruehl & Chung, 2004; McCubbin & Bruehl, 19941 Maixner et al., 1982; Zamir et al., 1980; Saavedra, 1981). However, patients with a variety of somatosensory disorders, including TMJD, do not show the expected relationship between blood pressure and pain sensitivity suggesting that the mechanism(s) that mediate this relationship are altered (Maixner et al., 1997; Bruehl & Chung, 2004). Data collected in investigations by the present co-inventors indicate that individuals with relatively high resting blood pressure are substantially less likely to develop TMJD compared to those who have lower resting blood pressures, which supports the view that low resting arterial blood pressure is associated with an enhanced state of pain perception/amplification and contributes to the development and maintenance of somatosensory disorders, including persistent TMJD. A recent large scale public health study has also provided evidence that higher levels of resting arterial blood pressure is associated with a reduced risk to develop a variety of chronic musculoskeletal pain conditions (Hagen et al., 2005). Thus individuals with relatively high blood pressures can exhibit a lower incidence and prevalence of somatosensory disorders. Furthermore, genetic polymorphisms that are associated with blood pressure and blood pressure regulation can predict the risk of onset and persistence of somatosensory disorders (Table 6). In addition to the above-noted biological influences, multiple psychological factors have been implicated as potential risk factors for the development of somatosensory disorders.

Thus, the presently disclosed system can comprise at least one psychosocial questionnaire for determining a psychosocial status of the subject. Exemplary psychosocial questionnaires that can be incorporated in the system include, but are not limited to Eysenck Personality Questionnaire, Life Experiences Survey, Perceived Stress Scale, State-Trait Anxiety Inventory (STAI) Form Y-2, STAI Form Y-1, Pittsburgh Sleep Quality Index, Kohn Reactivity Scale, Pennebaker Inventory for Limbic Languidness, Short Form 12 Health Survey v2, SF-36, Pain Catastrophizing Scale, In vivo Coping Questionnaire, Coping Strategies Questionnaire-Rev, Lifetime Stressor List & Post-Traumatic Stress Disorder (PTSTD) Checklist for Civilians, Multidimensional Pain Inventory v3, Comprehensive Pain & Symptom Questionnaire, Symptom Checklist-90-R(SCL-90R), Brief Symptom Inventory (BSI), Beck Depression Inventory (BDI), Profile of Mood States Bi-polar, Pain Intensity Measures, and Pain Unpleasantness Measures.

In some embodiments, for example, three psychological questionnaires that assess depression, anxiety and somatization, which represent three examples of major psychological domains that are consistently associated with somatosensory disorders, can be completed in whole or in part by a subject. For example, the following questionnaires can be used. The Brief Symptom Inventory (BSI) is a short form of the Symptom Checklist 90 Revised and consists of 53 items that assess a feeling or thought. It is scored on a 5 point scale from 0 (no such problem) to 4 (severe problem). It provides ratings of psychological distress in nine symptom areas: somatization, obsessive-compulsive, interpersonal sensitivity, depression, anxiety, hostility, phobic anxiety, paranoid ideation, and psychoticism (Derogatis. & Melisaratos, 1983). In some embodiments, summary scores can be computed for two of nine symptoms: somatization and depression. High scores indicate psychological distress.

The Pennebaker Inventory for Limbic Languidness (PILL) assesses the frequency of occurrence of 54 common physical symptoms and sensations and appears related to the construct of somatization or to the general tendency to perceive and endorse physical symptoms. A total score is computed by summing all items. It has been reported to have high internal consistency (alpha=0.88) and adequate test-retest reliability (0.70 over two months) (National Ambulatory Medical Care Survey, 1979). Recently it has been used as a measure of hypervigilance in fibromyalgia patients (McDermid et al. 1996). These patients demonstrated lower pressure pain thresholds and tolerances and higher scores on the PILL compared to arthritis patients and pain-free controls.

The State-Trait Anxiety Inventory (STAI) contains 20 statements evaluating levels of state and trait anxiety (Spielberger et al., 1983). The STAI is comprised of two forms, one measuring general propensity to experience anxiety (Trait Anxiety) and the other measures the subject's anxiety level at the time of questionnaire completion (State Anxiety). Summary scores for Trait Anxiety can be computed by summing all items for this form. Higher scores indicate greater anxiety level. Each of these instruments is widely used in clinical research and has good psychometric properties.

TABLE 1
EXEMPLARY GENES ASSOCIATED WITH SOMATOSENSORY DISORDERS

| Gene | Other | |
|---|---|---|
| Symbol | Symbols | Gene Name |
| HTR1A | | 5-hydroxytryptamine (serotonin) receptor 1A |
| HTR1B | | 5-hydroxytryptamine (serotonin) receptor 1B |
| HTR2A | | 5-hydroxytryptamine (serotonin) receptor 2A |
| HTR2C | | 5-hydroxytryptamine (serotonin) receptor 2C |
| HTR3A | | 5-hydroxytryptamine (serotonin) receptor 3A |
| HTR3B | | 5-hydroxytryptamine (serotonin) receptor 3B |
| ABCB1 | | ATP-binding cassette, sub-family B (MDR/TAP), member 1 |
| ACCN1 | ASIC1 | amiloride-sensitive cation channel 1, neuronal (degenerin) |
| ACCN2 | ASIC2 | amiloride-serisitive cation channel 2, neuronal |
| ACCN3 | ASIC3 | amiloride-sensitive cation channel 3 |
| ACCN4 | | amiloride-sensitive cation channel 4, pituitary |
| ACE | | angiotensin I converting enzyme (peptidyl-dipeptidase A) 1 |
| ACE2 | | angiotensin I converting enzyme (peptidyl-dipeptidase A) 2 |
| ADCY7 | | adenylate cyclase 7 |
| ADORA1 | | adenosine A1 receptor |
| ADORA2A | | adenosine A2a receptor |
| ADORA2B | | adenosine A2b receptor |
| ADORA3 | | adenosine A3 receptor |
| ADRA1A | | adrenergic, alpha-1A-, receptor |
| ADRA1B | | adrenergic, alpha-1B-, receptor |
| ADRA1D | | adrenergic, alpha-1D-, receptor |
| ADRA2A | | adrenergic, alpha-2A-, receptor |
| ADRA2B | | adrenergic, alpha-2B-, receptor |
| ADRA2C | | adrenergic, alpha-2C-, receptor |
| ADRBK2 | BARK2, GRK3 | adrenergic, beta, receptor kinase 2 |
| AGT | | angiotensinogen (serpin peptidase inhibitor, clade A, |
| | | member 8) |
| AGTR1 | | angiotensin II receptor, type 1 |
| AGTR2 | | angiotensin II receptor, type 2 |
| ANXA1 | | annexin A1 |
| ANXA2 | | annexin A2 |
| AP1G1 | | adaptor-related protein complex 1, gamma 1 subunit |
| ARL5B | | ADP-ribosylation factor-like 5B |
| ARRB1 | | arrestin, beta 1 |
| ARRB2 | | arrestin, beta 2 |
| ATF3 | | activating transcription factor 3 |
| ATP1A1 | | ATPase, Na+/K+ transporting, alpha 1 polypeptide |
| ATP1A2 | | ATPase, Na+/K+ transporting, alpha 2 (+) polypeptide |
| ATP1B3 | | ATPase, Na+/K+ transporting, beta 3 polypeptide |
| ATP2B1 | | ATPase, Ca++ transporting, plasma membrane 1 |
| ATP6A1 | | ATPase, H+ transporting, lysosomal, alpha polypeptide, |
| | | 70 kD, isoform 1 |
| ATP6V1B2 | | ATPase, H+ transporting, lysosomal, beta polypeptide, |
| | | 56/58 kD, isoform 2 |
| BDKRB1 | | bradykinin receptor B1 |
| BDKRB2 | | bradykinin receptor B2 |
| BDNF | | brain-derived neurotrophic factor |
| BTG2 | | BTG family, member 2, translocation gene 2, anti- |
| | | proliferative secrited protein |
| CACNA1A | | calcium channel, voltage-dependent, P/Q type, alpha 1A |
| | | subunit |
| CACNA2D1 | | calcium channel, voltage-dependent, alpha 2/delta subunit 1 |
| CACNA2D2 | | calcium channel, voltage-dependent, alpha 2/delta subunit 2 |
| CALCA | | Calcitonin/calcitonin-related polypeptide, alpha |
| CALCRL | | Calcitonin/calcitonin-related polypeptide receptor |
| CALM2 | | calmodulin 2 (phosphorylase kinase, delta) |
| CAMK4 | | calcium/calmodulin-dependent protein kinase IV |
| CAT | | catalase |
| CCK | | cholecystokinin |
| CCKAR | | cholecystokinin A receptor |
| CCKBR | | cholecystokinin B receptor |
| CCL2 | MCP-1 | chemokine (C-C motif) ligand 2 |
| CCL3 | MIP1alpha/(G0 | chemokine (C-C motif) ligand 3 |
| | S19-1) | |
| CCL4 | MIP-1beta | chemokine (C-C motif) ligand 4 |
| CCL5 | RANTES | chemokine (C-C motif) ligand 5 |
| CCR1 | MIP-1-alpha | chemokine (C-C motif) receptor 1 |
| | receptor, | |
| | RANTES | |
| | receptor | |
| CCR2 | MCP-1 | chemokine (C-C motif) receptor 2 |
| | receptor | |
| CCRL2 | | chemokine receptor-like 2 |
| CDK5 | | cyclin-dependent kinase 5, regulatory subunit 1 (p35) |
| CDKN1A | p21, Cip1 | cyclin-dependent kinase inhibitor 1A |
| CHRM1 | | cholinergic receptor, muscarinic 1 |
| CHRM2 | | cholinergic receptor, muscarinic 2 |
| CHRM3 | | cholinergic receptor, muscarinic 3 |
| CHRM4 | | cholinergic receptor, muscarinic 4 |
| CHRM5 | | cholinergic receptor, muscarinic 5 |
| CHRNA4 | | cholinergic receptor, nicotinic, alpha polypeptide 4 |
| CHRNA5 | | cholinergic receptor, nicotinic, alpha 5 |
| CHRNB2 | | cholinergic receptor, nicotinic, beta polypeptide 2 |
| | | (neuronal) |
| CIAS1 | | cold autoinflammatory syndrome 1 |
| CNR1 | | cannabinoid receptor 1 (brain) |
| CNR2 | | cannabinoid receptor 2 (peripheral) |
| CREB1 | | cAMP responsive element binding protein 1 |
| CRH | | corticotropin releasing hormone |
| CRHBP | | corticotropin releasing hormone binding protein |
| CRHR1 | | corticotropin releasing hormone receptor 1 |
| CRHR2 | | corticotropin releasing hormone receptor 2 |
| CRYAA | | crystallin, alpha A |
| CSEN | DREAM | calsenilin, presenilin binding protein, EF-hand transcription |
| | | factor |
| CSNK1A1 | | casein kinase 1, alpha 1 |
| CSNK1E | | casein kinase 1, epsilon |
| CX3CL1 | Fractalkine | chemokine (C—X3—C motif) ligand 1 |
| CX3CR1 | Fractalkine | chemokine (C—X3—C motif) receptor 1 |
| | Receptor | |
| CXCR4 | | chemokine (C—X—C motif), receptor 4 (fusin) |
| CYBB | GP91PHOX, | cytochrome b-245, beta polypeptide (chronic |
| | NOX2 | granulomatous disease) |
| DARPP32 | | protein phosphatase 1, regulatory (inhibitor) subunit 1B |
| | | (dopamine and cAMP regulated phosphoprotein, DARPP- |
| | | 32) |
| DBH | | dopamine beta-hydroxylase (dopamine beta- |
| | | monooxygenase) |
| DBI | | diazepam binding inhibitor (GABA receptor modulator, |
| | | acyl-Coenzyme A binding protein) |
| DDC | | dopa decarboxylase (aromatic L-amino acid |
| | | decarboxylase) |
| DDX24 | | DEAD/H box polypeptide 24, ATP-dependent RNA |
| | | helicase |
| DLG4 | PSD-95 | discs, large homolog 4 (Drosophila) |
| DRD1 | | dopamine receptor D1 |
| DRD2 | | dopamine receptor D2 |
| DRD3 | | dopamine receptor D3 |
| DRD4 | | dopamine receptor D4 |
| DRD5 | | dopamine receptor D5 |
| EFNB1 | | ephrin-B1 |
| EFNB2 | | ephrin-B2 |
| EGFR | ERBB1 | epidermal growth factor receptor (erythroblastic leukemia |
| | | viral (v-erb-b) oncogene homolog, avian |
| EGR3 | | early growth response 3 |
| ELOVL3 | fatty acid | elongation of very long chain fatty acids (FEN1/Elo2, |
| | elongase | SUR4/Elo3, yeast)-like 3 |
| EPHB1 | | ephrin EPH receptor B1 |
| EPHB2 | | ephrin EPH receptor B2 |
| EPHB3 | | ephrin EPH receptor B3 |
| EPHB4 | | ephrin EPH receptor B4 |
| EPHB5 | | ephrin EPH receptor B5 |
| EPHB6 | | ephrin EPH receptor B6 |
| EPO | | erythropoietin |
| EPOR | | erythropoietin receptor |
| ERBB2 | NEU; NGL; | v-erb-b2 erythroblastic leukemia viral oncogene homolog |
| | HER2; TKR1; | 2, neuro/glioblastoma derived oncogene homolog (avian) |
| | HER-2; c-erb | |
| | B2; HER-2/neu | |
| ERBB4 | | v-erb-a erythroblastic leukemia viral oncogene homolog 4 |
| | | (avian) |
| EREG | | epiregulin |
| ESR1 | | estrogen receptor 1 (alpha) |
| ESR2 | | estrogen receptor 2 (beta) |
| FAAH | | fatty acid amide hydrolase |
| FACL2 | | fatty-acid-Coenzyme A ligase, long-chain 2 |
| FEV | | FEV (ETS oncogene family) |
| FGF2 | | fibroblast growth factor 2 (basic) |
| FPRL1 | lipoxin A4 | FPRL1 formyl peptide receptor-like 1 |
| | receptor | |
| GABARAPL1 | | GABA(A) receptor-associated protein like 1/early |
| | | estrogen-regulated protein (GEC1) |
| GABBR1 | | gamma-aminobutyric acid (GABA) B receptor, 1 |
| GABBR2 | | gamma-aminobutyric acid (GABA) B receptor, 2 |
| GABRA2 | | gamma-aminobutyric acid (GABA) A receptor, alpha 2 |
| GABRA4 | | gamma-aminobutyric acid (GABA) A receptor, alpha 4 |
| GABRA6 | | gamma-aminobutyric acid (GABA) A receptor, alpha 6 |
| GABRB1 | | gamma-aminobutyric acid (GABA) A receptor, beta 1 |
| GABRB2 | | gamma-aminobutyric acid (GABA) A receptor, beta 2 |
| GABRB3 | | gamma-aminobutyric acid (GABA) A receptor, beta 3 |
| GABRD | | gamma-aminobutyric acid (GABA) A receptor, delta |
| GABRG2 | | gamma-aminobutyric acid (GABA) A receptor, gamma 2 |
| GABRG3 | | gamma-aminobutyric acid (GABA) A receptor, gamma 3 |
| GAD1 | | glutamate decarboxylase 1 (brain, 67 kDa) |
| GAD2 | | glutamate decarboxylase 2 (pancreatic islets and brain, |
| | | 65 kDa) |
| GAL | | galanin |
| GALR1 | | galanin receptor 1 |
| GALR2 | | galanin receptor 2 |
| GALR3 | | galanin receptor 3 |
| GBP1 | | guanylate binding protein 1, interferon-inducible, 67 kD |
| GBP2 | | guanylate binding protein 2, interferon-inducible |
| GCH1 | GTPCH1 | GTP cyclohydrolase 1 (dopa-responsive dystonia) |
| GDNF | | glial cell derived neurotrophic factor |
| GLRA1 | | glycine receptor, alpha 1 (startle disease/hyperekplexia, |
| | | stiff man syndrome) |
| GLRA2 | | glycine receptor, alpha 2 |
| GLRB | | glycine receptor, beta |
| GNB2L1 | the receptor for | guanine nucleotide binding protein (G protein), beta |
| | activated C | polypeptide 2-like 1 |
| | kinase | |
| | 1(RACK1) | |
| GNG5 | | guanine nucleotide binding protein (G protein), gamma 5 |
| GPX4 | | glutathione peroxidase 4 (phospholipid hydroperoxidase) |
| GRIA1 | AMPA | glutamate receptor, ionotropic, AMPA 1 |
| | receptor 1 | |
| GRIA2 | AMPA | glutamate receptor, ionotropic, AMPA 2 |
| | receptor 2 | |
| GRIA3 | AMPA | glutamate receptor, ionotropic, AMPA 3 |
| | receptor 3 | |
| GRIA4 | AMPA | glutamate receptor, ionotropic, AMPA 4 |
| | receptor 4 | |
| GRIK1 | | glutamate receptor, ionotropic, kainate 1 |
| GRIN1 | NMDA receptor 1 | glutamate receptor, ionotropic, N-methyl D-aspartate 1 |
| GRIN2A | | glutamate receptor, ionotropic, N-methyl D-aspartate 2A |
| GRIN2B | | glutamate receptor, ionotropic, N-methyl D-aspartate 2B |
| GRM1 | | glutamate receptor, metabotropic 1 |
| GRK 4 | | G protein-coupled receptor kinase 4 |
| GRK 5 | | G protein-coupled receptor kinase 5 |
| GRK 6 | | G protein-coupled receptor kinase 6 |
| GRK 7 | | G protein-coupled receptor kinase 7 |
| GSTM1 | | glutathione S-transferase M1 |
| GSTT1 | | glutathione S-transferase theta 1 |
| HIF1A | | HIF1A, alpha subunit |
| HN1 | | Humanin (HN1), mitochondial |
| hnRNP G | Glycoprotein | RNA binding motif protein (RBMX, hnRNP-G), |
| | P43 | Heterogeneous nuclear ribonucleoprotein G |
| HNRPD | | heterogeneous nuclear ribonucleoprotein D (AU-rich |
| | | element RNA binding protein 1, 37 kD) |
| HNRPU | | heterogeneous nuclear ribonucleoprotein U (scaffold |
| | | attachment factor A |
| HSPA8 | | heat shock 70 kD protein 8 (HSPA8) |
| HSPA9B | | heat shock 70 kD protein 9B (mortalin-2) (HSPA9B) |
| HSPCA | | heat shock 90 kD protein 1, alpha) |
| HSPCB | | heat shock 90 kD protein 1, beta |
| HTR2B | | 5-hydroxytryptamine (serotonin) receptor 2B |
| IFI30 | | interferon, gamma-inducible protein 30 |
| IFNG | | interferon, gamma |
| IFRD1 | | interferon-related developmental regulator 1 |
| IGF1 | | insulin-like growth factor 1 (somatomedin C) |
| IKBKB | IKK-beta | inhibitor of kappa light polypeptide gene enhancer in B- |
| | | cells, kinase beta |
| IL10 | | interleukine 10 |
| IL13 | | interleukine 13 |
| IL-1alpha | | interleukine 1 alpha |
| IL-1beta | | interleukine 1 beta |
| IL1RN | | interleukin 1 receptor antagonist |
| IL1RN | | interleukin 1 receptor antogonist |
| IL-2 | | interleukine 2 |
| IL-4 | | interleukine 4 |
| IL-6 | | interleukine 6 |
| IL8 | | interleukine 8 |
| INADL | channel- | InaD-like (Drosophila) |
| | interacting PDZ | |
| | domain protein | |
| INSIG1 | | insulin induced protein 1 |
| IRAP | | secreted interleukin 1 receptor antagonist |
| ITGAM | OX42 | integrin, alpha M (complement component receptor 3, |
| | | alpha; also known as CD11b (p170), macrophage antigen |
| | | alpha polypeptide) |
| KCNA2 | Kv1.2 | potassium voltage-gated channel, shaker-related |
| | | subfamily, member 2 |
| KCNJ11 | Kir6.2 | potassium inwardly-rectifying channel, subfamily J, |
| | | member 11 |
| KCNJ3 | Kir3.1 | potassium inwardly-rectifying channel, subfamily J, |
| | | member 3 |
| KCNJ5 | Kir3.4 | potassium inwardly-rectifying channel, subfamily J, |
| | | member 5 |
| KCNJ6 | Kir3.2 | potassium inwardly-rectifying channel, subfamily J, |
| | | member 6 |
| KCNJ8 | Kir6.1 | potassium inwardly-rectifying channel, subfamily J, |
| | | member 8 |
| KCNJ9 | Kir3.3 | potassium inwardly-rectifying channel, subfamily J, |
| | | member 9 |
| KCNK2 | TREK-1 | potassium channel, subfamily K, member 2 |
| KCTD17 | | potassium channel tetramerisation domain containing 17 |
| KPNB1 | | karyopherin (importin) beta 1 |
| LIPL3 | | lipase-like, ab-hydrolase domain containing 3 |
| MAO-A | | monoamine oxidase A |
| MAO-B | | monoamine oxidase B |
| MAP2K1IP1 | | mitogen-activated protein kinase kinase 1 interacting |
| | | protein 1 (MAP2K1IP1) |
| MAP3K1 | | MAP kinase kinase kinase 1 (Mekk1) |
| MAPK1 | ERK2 | mitogen-activated protein kinase 1 |
| MAPK11 | p38beta | p38beta |
| MAPK13 | p38delta | p38delta |
| MAPK14 | p38alpha | p38 alpha |
| MAPK3 | ERK1 | mitogen-activated protein kinase 3 |
| MC1R | | melanocortin 1 receptor (alpha melanocyte stimulating |
| | | hormone receptor) |
| MC4R | | melanocortin 4 receptor (alpha melanocyte stimulating |
| | | hormone receptor) |
| MFN1 | | mitofusin 1 |
| MFN2 | | Mitofusin 2 |
| MPDZ | | multiple PDZ domain protein |
| MPO | | myeloperoxidase |
| MSN | | moesin |
| MTMR6 | | myotubularin related protein 6 |
| NAB1 | | NGFI-A binding protein 1 (EGR1 binding protein) |
| NFKBIA | alphalkBa | nuclear factor of kappa light polypeptide gene enhancer in |
| | | B-cells inhibitor |
| NFKBIZ | zetalkappaB- | nuclear factor of kappa light polypeptide gene enhancer in |
| | zeta | B-cells inhibitor |
| NGF | | nerve growth factor, beta polypeptide |
| NOS1 | | nitric oxide synthase 1 (neuronal) |
| NOS2A | | nitric oxide synthase 2A (inducible, hepatocytes) |
| NOS3 | | nitric oxide synthase 3 (endothelial cell) |
| NPY | | neuropeptide Y |
| NPY1R | | neuropeptide Y receptor Y1 |
| NPY2R | | neuropeptide Y receptor Y2 |
| NPY5R | | neuropeptide Y receptor Y5 |
| NQO1 | | NAD(P)H dehydrogenase, quinone 1 |
| NR3C1 | glucocorticoid | nuclear receptor subfamily 3, group C, member 1 |
| | receptor | |
| NR4A1 | | TR3 orphan receptor NR4A1 |
| NR4A2 | | NGFI-B/nur77 beta homolog |
| NR4A3 | | mitogen induced nuclear orphan receptor (MINOR) |
| NRG1 | ErbB | neuregulin 1 |
| NTRK1 | TrkA | neurotrophic tyrosine kinase, receptor, type 1 |
| NTRK2 | TrkB | neurotrophic tyrosine kinase, receptor, type 2 |
| NTSR1 | | neurotensin receptor 1 |
| NTSR2 | | neurotensin receptor 2 |
| OBLR | | opiate receptor-like 1 |
| OLR1 | | oxidised low density lipoprotein receptor 1 |
| OPRD1 | | opioid receptor, delta 1 |
| OPRK1 | | opioid receptor, kappa 1 |
| OPRM1 | | opioid receptor, mu 1 |
| OXT | | oxytocin, prepro-(neurophysin I) |
| P2RX2 | | purinergic receptor P2X, ligand-gated ion channel, 2 |
| P2RX3 | | purinergic receptor P2X, ligand-gated ion channel, 3 |
| P2RX4 | | purinergic receptor P2X, ligand-gated ion channel, 4 |
| P2RX7 | | purinergic receptor P2X, ligand-gated ion channel, 7 |
| P2RY1 | | purinergic receptor P2Y, G-protein coupled, 1 |
| P2RY12 | | purinergic receptor P2Y, G-protein coupled, 12 |
| P2RY13 | | purinergic receptor P2Y, G-protein coupled, 13 |
| P2RY2 | | purinergic receptor P2Y, G-protein coupled, 2 |
| P2RY4 | | purinergic receptor P2Y, G-protein coupled, 4 |
| P2RY6 | | purinergic receptor P2Y, G-protein coupled, 6 |
| PACSIN1 | | Protein kinase C and casein kinase substrate in neurons 1 |
| PBEF | | pre-B-cell colony-enhancing factor |
| PDGFA | | platelet-derived growth factor alpha polypeptide |
| PDGFB | | platelet-derived growth factor beta polypeptide (simian |
| | | sarcoma viral (v-sis) oncogene homolog) |
| PENK | | proenkephalin |
| PLA2G4A | cPLA2-alpha | phospholipase A2, group IVA (cytosolic, calcium- |
| | | dependent) |
| PLA2G4B | cPLA2-beta | phospholipase A2, group IVB (cytosolic) |
| PLAUR | | plasminogen activator, urokinase receptor |
| PNMT | | phenylethanolamine N-methyltransferase |
| PNOC | orphanin FQ | prepronociceptin |
| PNYD | | prodynorphin |
| POMC | | proopiomelanocortin (adrenocorticotropin/beta-lipotropin/ |
| | | alpha-melanocyte stimulating hormone/beta-melanocyte |
| | | stimulating hormone/beta-endorphin) |
| PPP3CA | | protein phosphatase 3 (formerly 2B), catalytic subunit, |
| | | alpha isoform (calcineurin A alpha) |
| PPP3CB | | protein phosphatase 3 (formerly 2B), catalytic subunit, |
| | | beta isoform (calcineurin A beta) |
| PPP3R1 | | protein phosphatase 3 (formerly 2B), regulatory subunit B, |
| | | 19 kDa, alpha isoform (calcineurin B, type I) |
| PPP3R2 | | protein phosphatase 3 (formerly 2B), regulatory subunit B, |
| | | 19 kDa, beta isoform (calcineurin B, type II) |
| PRKACA | PKA | protein kinase, cAMP-dependent, catalytic, alpha |
| PRKACB | PKA | protein kinase, cAMP-dependent, catalytic, beta |
| PRKCABP | | protein kinase C, alpha binding protein |
| PRKCE | | protein kinase C, epsilon |
| PRKD3 | protein kinase | protein kinase C, D3 |
| | C, nu | |
| PTGER1 | | prostaglandin E receptor 1 (subtype EP1) |
| PTGER2 | | prostaglandin E receptor 2 (subtype EP2) |
| PTGER3 | | prostaglandin E receptor 3 (subtype EP3) |
| PTGER4 | | prostaglandin E receptor 4 (subtype EP4) |
| PTGS1 | COX1-COX3 | prostaglandin-endoperoxide synthase 1 (prostaglandin |
| | | G/H synthase and cyclooxygenase) |
| PTGS2 | COX2 | prostaglandin-endoperoxide synthase 2 (prostaglandin |
| | | G/H synthase and cyclooxygenase) |
| RAB20 | | RAB20, member RAS oncogene family |
| Rab5 | | Rab5 GDP/GTP exchange factor homologue |
| RAB8B | | RAB8B, member RAS oncogene family |
| RBMX | hnRNP-G | |
| RGS2 | | regulator of G-protein signalling 2 |
| RGS4 | | regulator of G-protein signalling 4 |
| S100A12 | | S100 calcium binding protein A12 (calgranulin C) |
| S100A3 | | S100 calcium binding protein A3 |
| S100B | | S100 calcium binding protein, beta (neural) |
| SAMSN1 | | SAM domain, SH3 domain and nuclear localisation |
| | | signals, 1 |
| SAT | | spermidine/spermine N1-acetyltransferase (SAT) |
| SC5DL | Δ-5 | sterol-C5-desaturase (ERG3 delta-5-desaturase homolog, |
| | desaturase | fungal)-like |
| SCD | Δ-9 | stearoyl-CoA desaturase (delta-9-desaturase) |
| | desaturase | |
| SCN10A | | sodium channel, voltage-gated, type X, alpha |
| SCN11A | | sodium channel, voltage-gated, type XI, alpha |
| SCN1A | | sodium channel, voltage-gated, type I, alpha |
| SCN2A1 | | sodium channel, voltage-gated, type II, alpha 1 |
| SCN3A | | sodium channel, voltage-gated, type III, alpha |
| SCN5A | | sodium channel, voltage-gated, type V, alpha (long QT |
| | | syndrome 3) |
| SCN8A | | sodium channel, voltage gated, type VIII, alpha |
| SCN9A | | sodium channel, voltage-gated, type IX, alpha |
| SET | | SET translocation (myeloid leukemia-associated) |
| SGK | | serum/glucocorticoid regulated kinase |
| SGKL | | serum/glucocorticoid regulated kinase-like |
| SLC18A2 | | solute carrier family 18 (vesicular monoamine), member 2 |
| SLC29A1 | | solute carrier family 29 (nucleoside transporters), member 1 |
| SLC32A1 | | vesicular inhibitory amino acid transporter (solute carrier |
| | | family 32 (GABA vesicular transporter) |
| SLC6A11 | | solute carrier family 6 (neurotransmitter transporter, |
| | | GABA), member 11 |
| SLC6A13 | | solute carrier family 6 (neurotransmitter transporter, |
| | | GABA), member 13 |
| SLC6A2 | | solute carrier family 6 (neurotransmitter transporter, |
| | | noradrenalin), member 2 |
| SLC6A3 | | solute carrier family 6 (neurotransmitter transporter, |
| | | dopamine), member 3 |
| SLC6A4 | | solute carrier family 6 (neurotransmitter transporter, |
| | | serotonin), member 4 |
| SMN1 | | survival of motor neuron 1, telomeric |
| SOD2 | | superoxide dismutase 2, mitochondrial |
| TAC1 | | tachykinin, precursor 1 (substance K, substance P, |
| | | neurokinin 1, neurokinin 2, neuromedin L, neurokinin |
| | | alpha, neuropeptide K, neuropeptide gamma) |
| TACR1 | NK-1 receptor | tachykinin receptor 1 (substance P receptor; neurokinin-1 |
| | | receptor) |
| TCIRG1 | | ATPase, H+ transporting, lysosomal V0 protein a isoform |
| | | 3, T-cell, immune regulator 1 |
| TGFBI | | transforming growth factor, beta-induced, 68 kD |
| TH | | tyrosine hydroxylase |
| THBD | | thrombomodulin |
| THBS1 | | thrombospondin |
| TIEG | | TGFB inducible early growth response |
| TIMP1 | | tissue inhibitor of metalloproteinase 1 |
| TLR4 | | toll-like receptor 4 |
| TMSB10 | | thymosin, beta 10 |
| TMSB4X | | thymosin, beta 4, X chromosome |
| TNF | | tumor necrosis factor (TNF superfamily, member 2) |
| TNFAIP3 | A20 | tumor necrosis factor, alpha-induced protein 3 |
| TPH2 | | tryptophan hydroxylase 2 (is the rate-limiting enzyme in |
| | | the synthesis of serotonin) |
| TRPM8 | | transient receptor potential cation channel, subfamily M, |
| | | member 8 |
| TRPV1 | | transient receptor potential cation channel, subfamily V, |
| | | member 1 |
| TRPV2 | | transient receptor potential cation channel, subfamily V, |
| | | member 2 |
| TRPV3 | | transient receptor potential cation channel, subfamily V, |
| | | member 3 |
| UBE2G2 | | ubiquitin-conjugating enzyme E2G 2 (UBC7 homolog, |
| | | yeast) (UBE2G2) |
| VEGF | | vascular endothelial growth factor |
| VIL2 | ezrin | villin 2 |
| VPS4A | | vacuolar protein sorting 4A (yeast) |
| VPS4B | | vacuolar protein sorting 4B (yeast) |
| XDH | | xanthine dehydrogenase |
| YWHAZ | | tyrosine 3-monooxygenase/tryptophan 5-monooxygenase |
| | | activation protein, zeta polypeptide |
| ZA20D2 | ZNF216 | zinc finger, A20 domain containing 2 |
| ZA20D3 | protein | zinc finger, A20 domain containing 3 |
| | associated with | |
| | PRK1(AWP1) | |
| ZNF265 | | zinc finger protein 265 |

TABLE 2
EXEMPLARY SNPs FROM GENES ASSOCIATED WITH
SOMATOSENSORY DISORDERS

| | |
|---|---|
| HTR1A | rs1800045, rs6294, rs878567 |
| HTR1B | rs11568817, rs130058, rs6298, rs6297 |
| HTR2A | rs1058576, rs1923882, rs2296972, rs2770296, rs4142900, rs4941573, |
| | rs6314, rs6561333, rs9316233, rs17068986, rs927544, rs6310, rs6312, |
| | rs977003, rs1805055 |
| HTR2B | rs7604219, rs17619588, rs10194776, rs1549339, rs17586428, rs3806545, |
| | rs6437000, rs4973377 |
| HTR2C | rs3813928, rs3813929, rs2497551, rs2228669, rs6318, rs11798698, |
| | rs12838742, rs2497510, rs2497515, rs2497529, rs475717, rs498177, |
| | rs508865, rs5987817, rs6643915, rs4911878, rs1801412 |
| HTR3A | rs897692, rs1176752, rs1150226, rs2276302, rs3737457, rs1176713, |
| | rs1150219 |
| HTR3B | rs3758987, rs10502180, rs12421126, rs7103572, rs1176744, rs2276305, |
| | rs17116138, rs1176739, rs1176761, rs4936285, rs3782025 |
| ABCB1 | rs17064, rs2235051, rs1045642, rs1882477, rs2032582, rs2229109, |
| | rs9282564, rs3213619, rs2188524, rs4148727, rs10261685 |
| ACCN1 | rs28903, rs28935, rs16567, rs1988598, rs7503296, rs4795742, rs4289044, |
| | rs16968020, rs11657055, rs4133924, rs7214319, rs319773, rs8069909, |
| | rs394886, rs368365, rs4795754, rs1002317, rs1497366, rs731601, |
| | rs7214382, rs2228990, rs2228989, rs2097761, rs28932, |
| | rs11080233 |
| ACCN2 | rs590460, rs653576, rs10875995, rs706793, rs2307082 |
| ACCN3 | rs2303928, rs11977275, rs2288646 |
| ACCN4 | rs907676, rs3731909, rs746233, rs1467116, rs2276642, rs2276643, |
| | rs1043833 |
| ACE | rs4292, rs17236660, rs4303, rs4309, rs12709426, rs4318, rs4343, rs4362, |
| | rs4364, rs4461142, rs4459610, rs8066276, rs12451328, rs4968591, rs4365, |
| | rs3730025, rs4302, rs12720746, rs4316, rs4331 |
| ACE2 | rs4830542, rs4646179, rs1514280, rs4646146, rs971249, rs4646115, |
| | rs4646112, rs4646116 |
| ADCY7 | rs9926131, rs1064448, rs1872688, rs1872691, rs2302679, rs2302717, |
| | rs3760013, rs3815562, rs4611457, rs4785210, rs4785400, rs729229, |
| | rs9936021, rs9939322 |
| ADORA1 | rs2364571, rs6702345, rs1494490, rs11582098, rs722915, rs1874142, |
| | rs10920570, rs3766566, rs3766563, rs3766560, rs3766557, rs10920576, |
| | rs3753472, rs10920568, rs12744240 |
| ADORA2A | rs3761423, rs2236624, rs2267076, rs2779193, rs2228101, rs2535609, |
| | rs2324082 |
| ADORA3 | rs2275797, rs2229155, rs10776727, rs923, rs7737, rs9025, rs1415793, |
| | rs10776733, rs4839145, rs12142663, rs6686510, rs1337912 |
| ADRA1A | rs10089254, rs1079078, rs11991324, rs13261054, rs13270252, rs13281802, |
| | rs1353446, rs1383914, rs1496126, rs17426222, rs1874425, rs2036107, |
| | rs2229124, rs2229125, rs2291776, rs4732880, rs498246, rs511662, |
| | rs523851, rs536220, rs556793, rs6989854, rs7835853, rs7842829 |
| ADRA1B | rs10070745, rs10214093, rs10214211, rs11739589, rs13171967, rs2229181, |
| | rs3729604, rs4921241, rs6884129, rs6892282, rs752266, rs756275, |
| | rs7728708, rs7734327 |
| ADRA1D | rs1556832, rs3787441, rs3803964, rs3810568, rs6052456, rs709024, |
| | rs734290, rs835873, rs835880, rs835882, rs946188 |
| ADRA2A | rs1800763, rs1800544, rs1800035, rs1800036, rs1800038, rs553668, |
| | rs3750625, rs521674 |
| ADRA2B | rs9333567, rs2229169, rs4066772, rs2252697, rs4426564 |
| ADRA2C | rs7692883, rs9790376, rs13112010, rs7696139, rs7434444, rs7678463 |
| ADRBK2 | rs5761122, rs6004701, rs2283811, rs5752108, rs1008673, rs909695, |
| | rs9941944, rs11913984, rs7292634, rs718163, rs1344079, rs5761159, |
| | rs9608416, rs12627968, rs9624896 |
| AGT1 | rs7079, rs7080, rs11568041, rs699, rs4762, rs11568052, rs11568029, |
| | rs2148582, rs5049, rs5046, rs2478522, rs5052 |
| AGTR1 | rs1492078, rs10935724, rs3772616, rs3772608, rs5182, rs5183, rs2638360, |
| | rs380400, rs2675511, rs10513337, rs12721225 |
| AGTR2 | rs12710567, rs1403543, rs3736556, rs5193, rs5194, rs17237820 |
| AKR1B10 | rs10263433, rs2037004, rs1722883, rs706160, rs4732036, rs4728329, |
| | rs706150, rs6467538, rs12668047 |
| ANXA1 | rs2795108, rs2795114, rs1342018, rs4301502, rs10869229, rs1050305 |
| | rs3739959 |
| ANXA2 | rs7170421, rs7163836, rs1551347, rs3759911, rs3743268, rs2100432, |
| | rs1454102 |
| AP1G1 | rs904763, rs12598902 |
| APP | rs1059461, rs2829966, rs2829979, rs214482, rs440666, rs1701004, |
| | rs3787639, rs2830012, rs2070655, rs2830041, rs2234988, rs2830071, |
| | rs2830097, rs466448 |
| ARL5B | rs2130531, rs10741127, rs6482597, rs1055114 |
| ARRB1 | rs528833, rs1676890, rs667791, rs490528, rs506233, rs472112, rs7127461, |
| | rs616714, rs569796, rs12274033 |
| ARRB2 | rs9905578, rs3786047, rs7208257, rs4522461, rs1045280 |
| ATF1 | rs11169552, rs3742065, rs10783389, rs1129406, rs2230674, rs829125 |
| ATF3 | rs1195474, rs3806460, rs1976657, rs3125296, rs10735510, rs8192658, |
| | rs1126526, rs11119989 |
| ATP1A1 | rs12079419, rs1407717, rs850602, rs12079419, rs12085796, rs7547948, |
| | rs850610 |
| ATP1A2 | rs3761685, rs1016732, rs2854248, rs6686067, rs10494336, rs1046995 |
| ATP1B3 | rs10935442, rs16846285, rs2060014, rs1897139, rs1072982,, s6440047, |
| | rs6440049, rs6782694, rs3804772, rs13327276 |
| ATP2B1 | rs10506974, rs2854371, rs3741895, rs17381194, rs11105345, rs2681491, |
| | rs1050395, rs11105356, rs11105358, rs10858915 |
| ATP6V1A | rs1048892, rs9811353, rs1043132, rs12736 |
| ATP6V1B2 | rs2410633, rs1042426 |
| BDKRB1 | rs2069613, rs4905475, rs10143977, rs2071084, rs11625494 |
| BDKRB2 | rs1799722, rs5223, rs8016905, rs4900312, rs945039, rs11847625, |
| | rs4905470, rs4905474, rs2069575, rs1046248, rs2069582, rs885820, rs5224, |
| | rs2227279, rs3809418 |
| BDNF | rs908867, rs12273363, rs11030121, rs2049046, rs7103411, rs1048220, |
| | rs1048221, rs1048218, rs6265, rs7124442, rs4923463, rs1401635 |
| BTG2 | rs17534202, rs4971234, rs6682806, rs12085417 |
| CACNA1A | rs2419233, rs1865033, rs3816027, rs10421681, rs4926240, rs8103699, |
| | rs2074879, rs7251403, rs16030, rs10423506, rs16018, rs2419248, |
| | rs4926278, rs4461194, rs8109003, rs4926285, rs4926286, rs1862262, |
| | rs1422256, rs1978431, rs16029, rs16027, rs16025, rs16022, rs16016, |
| | rs16012, rs16009, rs2248069, rs16006, rs17639705 |
| CACNA2D1 | rs1229502, rs3735517, rs37067, rs1229506, rs37089, rs7797314, rs1011696, |
| | rs7341478, rs10486945, rs3823920, rs3801742, rs3801734, rs10486948, |
| | rs2057894, rs2367912, rs11978472, rs38557, rs3757631, rs929416, rs42051, |
| | rs7794797, rs724118, rs2237526, rs2237528, rs2007111, rs6975647, |
| | rs6967334, rs10486960, rs17155680, rs10226282 |
| CACNA2D2 | rs2071801, rs2239801, rs2071803, rs2269568, rs2236953, rs762897, |
| | rs2282752, rs2282754, rs2236956, rs2282755, rs2236964, rs743755, |
| | rs2236969, rs2236977, rs2236989, rs736471, rs1467913, rs6807916, |
| | rs9814874, rs752183, rs3806706 |
| CALCA | rs2956, rs5241, rs5239, rs155300 |
| CALCRL | rs10179705, rs10203398, rs3771083, rs3771095, rs696092, rs858745, |
| | rs17464221, rs860859 |
| CALM2 | rs17036320, rs1027478, rs815802, rs815815, rs1723482, rs169386 |
| CAMK2A | rs2240793, rs957709, rs2217641, rs2241694, rs2241695, rs919741, |
| | rs3776825, rs3756577, rs10463293, rs13357922, rs10515639, rs919740, |
| | rs873593, rs3806947 |
| CAMK2B | rs7810158, rs2075076, rs11542228, rs17172630, rs4526269, rs12702072, |
| | rs4642534, rs4724298, rs10224124, rs4724299, rs12702079, rs4410809, |
| | rs6962696 |
| CAMK4 | rs919334, rs2290679, rs7704970, rs6875225, rs2434722, rs7707264, |
| | rs2288397, rs216535, rs10500205, rs306083, rs435021, rs306076, |
| | rs1644501, rs1644498, rs376880, rs960452, rs3756612, rs467422, rs306098, |
| | rs306090, rs3797746, rs10491334, rs3797739, rs25923, rs251007, rs25925, |
| | rs31309, rs1469442, rs402420, rs306124, rs2300782 |
| CAT | rs12807961, rs1049982, rs564250, rs494024, rs480575, rs2300181, |
| | rs17881192, rs554576, rs511895, rs7104301 |
| CCK | rs935112, rs10460960, rs11571842, rs754635, rs10865918, rs8192473, |
| | rs20291 |
| CCKAR | rs1800856, rs3822222, rs2000978, rs2725301, rs10016465, rs7665027 |
| CCKBR | rs4349588, rs906895, rs3793993, rs2947027, rs1805002, rs1042 |
| CCL2 | rs11575011, rs4586, rs1080327, rs13900 |
| CCL3 | rs8075808, rs1130371, rs1634499, rs1049131, rs1049121, rs1049114 |
| CCL4 | rs1719140, rs1049750, rs1049807, rs9635771, rs1130750 |
| CCL5 | rs3817655, rs2280788, rs2107538, rs4796123 |
| CCR1 | rs3181080, rs1491961, rs3136667, rs31769 |
| CCR2 | rs3918372, rs1799864, rs1799865, rs3918367, rs743660 |
| CCRL2 | rs11574433, rs11574440, rs11574442, rs11574443, rs6441977, rs3204850, |
| | rs1140865 |
| CDK5 | rs756785, rs735555, rs8192474 |
| CDKN1A | rs2395655, rs3176319, rs4986866, rs4986868, rs1801270, rs4986867, |
| | rs3176358 |
| CHRM1 | rs12295208, rs542269 |
| CHRM2 | rs2067477, rs6957496, rs1424569, rs4475425, rs2278071, rs7800170, |
| | rs1824024, rs324586, rs324587, rs2350786, rs324637, rs324651, rs8191992, |
| | rs11773032 |
| CHRM3 | rs7529470, rs6657343, rs685960, rs621060, rs650751 |
| CHRM4 | rs2067482, rs2229163, rs16938505 |
| CHRM5 | rs661968, rs9806373, rs8030094, rs513706, rs499167, rs2279423 |
| CHRNA4 | rs3787138, rs6011776, rs755204, rs755203, rs1044397, rs1044396, |
| | rs1044393 |
| CHRNA5 | rs684513, rs667282, rs17486278, rs680244, rs692780, rs16969968, |
| | rs615470, rs660652 |
| CHRNB2 | rs4845651, rs4845652, rs3008433, rs2072659, rs3926124 |
| CHUK | rs11597086, rs3818411, rs7903344, rs12251292, rs12762869 |
| CIAS1 | rs3738448, rs10754555, rs3806268, rs12564791, rs1539019, rs7525979, |
| | rs4925543, rs10157379, rs10754558, rs10802501 |
| CNR1 | rs1049353, rs806375, rs806378, rs806381, rs6454674, rs6454676, |
| | rs9344757, rs12720071, rs806368 |
| CNR2 | rs2229580, rs2229579, rs2502993, rs9424339, rs2502967, rs2501397 |
| CPN1 | rs11599750, rs11594585, rs2862925, rs3750717, rs3829161, rs12775433, |
| | rs10883439, rs7921462 |
| CREB1 | rs2253206, rs2551640, rs2709359, rs2059336, rs10932201, rs2551922, |
| | rs2551928, rs6785 |
| CRH | rs28364017, rs3176921, rs6472257 |
| CRHBP | rs3792738, rs32897, rs6453267, rs7718461, rs1053989, rs1875999 |
| CRHR1 | rs12942300, rs7209436, rs4792887, rs17689378, rs12936511, rs242924, |
| | rs16940655, rs81189, rs16940665, rs16940674, rs16940681 |
| CRHR2 | rs2240403, rs973002, rs2190242, rs2251002, rs2284217, rs2267717, |
| | rs2284220, rs255097, rs255125 |
| CRYAA | rs3761381, rs872331, rs3788061 |
| CSEN | rs1559483, rs3772038, rs2113418, rs3772031, rs869185, rs6730587 |
| CSNK1A1 | rs10057083, rs10036211, rs3733847, rs1947582, rs10058728, |
| | rs12163992, rs12108750, rs7719315, rs6883553, rs2279019, rs10075658, |
| | rs13184089 |
| CSNK1E | rs135750, rs1534891, rs6001090, rs6001093, rs135757, rs1997644, |
| | rs7289981, rs5995570, rs7289395, rs13054361 |
| CX3CL1 | rs223815, rs668100, rs170364, rs4151117, rs8323, rs3732378, rs3732379, |
| | rs9862876, rs2669844, rs2853707 |
| CXCR4 | rs2228014, rs17848057, rs17848385, rs99734 |
| CYBB | rs6610650, rs17146226, rs5917471, rs5964125, rs12848910 |
| CYP2C9 | rs9332103, rs1799853, rs7900194, rs4086116, rs2256871, rs2475376, |
| | rs4917639, rs1934963, rs1057910, rs9332242 |
| CYP2D6 | rs1058172, rs3915951, rs1058170, rs17002853, rs11568728, rs1058164, |
| | rs769258, rs28360521, rs17002852, rs742086 |
| CYP2E1 | rs3813865, rs3813867, rs915906, rs6413419, rs743535, rs2515642, |
| | rs2515641, rs9622778, rs3890379, rs11445593, rs2515641 |
| CYPSA4 | rs2687103, rs1851426, rs2740574, rs2738258, rs2687117, rs2242480, |
| | rs17161886 |
| DARPP32 | rs9532, rs734645, rs16965199, rs1495099, rs879606 |
| DBH | rs1076152, rs2797849, rs3025388, rs1108581, rs5320, rs4531, rs2519154, |
| | rs77905, rs2097629, rs2073833, rs1611131, rs129882, rs13306304 |
| DBI | rs3795890, rs3091405, rs3091406, rs8192503, rs8192506, rs2289948, |
| | rs12613135, rs2084202, rs8192503, rs8192506, rs1050698, rs2289948 |
| DDC | rs4947510, rs11575542, rs730092, rs4490786, rs1349492, rs2122822, |
| | rs880028, rs6263, rs6262, rs10244632, rs2329341, rs3829897, rs3837091, |
| | rs12666409 |
| DDX24 | rs4905149, rs1056810, rs3748328, rs3790043, rs8006174 |
| DLG4 (PSD-95) | rs2017365, rs390200, rs17203281, rs2242449 |
| DPP4 | rs2909443, rs12617336, rs2268894, rs1014444, rs2302872, rs2300755, |
| | rs2111850, rs3788979, rs6741949, rs6733162, rs12469968, rs17574, |
| | rs2075302 |
| DRD1 | rs4867798, rs686, rs5326, rs2168631, rs155417 |
| DRD2 | rs6279, rs9282673, rs1801028, rs6277, rs1800499, rs6275, rs4986918, |
| | rs2075652, rs1076563, rs1079596, rs7103679, rs4586205, rs4648318, |
| | rs4274224, rs4581480, rs1799978 |
| DRD3 | rs3732790, rs9824856, rs2134655, rs9288993, rs963468, rs3773678, |
| | rs2630349, rs167770, rs324029, rs10934256, rs3732783, rs6280, rs324026, |
| | rs9825563 |
| DRD4 | rs916457, rs3758653, rs4646983, rs762502, rs11246226 |
| DRD5 | rs10033951, rs2227840, rs2227839, rs2227841, rs2227845, rs2227843, |
| | rs2227852, rs16888561, rs1800762, rs1967550 |
| EFNB1 | rs1155215, rs421069, rs877817, rs7885471, rs688969 |
| EFNB2 | rs7322914, rs9520087, rs4399422, rs9301140, rs7983579, rs8001826, |
| | rs2391333, rs2893262, rs8000078, rs3809348, rs9301143 |
| EGFR | rs12674036, rs759171, rs4947963, rs763317, rs12668421, rs1558542, |
| | rs17172432, rs10244108, rs759170, rs3735061, rs2330951, rs6593206, |
| | rs10488141, rs2072454, rs2075112, rs11543848, rs12538371, rs2241054, |
| | rs845552, rs10251977, rs2075102, rs17518376, rs2740762, rs1140475, |
| | rs2293347, rs17172455, rs884225 |
| EGR3 | rs1996147, rs3750192, rs1533307, rs1008949 |
| ELOVL3 | rs7083450, rs1410416, rs2281983 |
| EPHB1 | rs17763226, rs7644369, rs3732566, rs3182239, rs6786165 |
| EPHB2 | rs294218, rs294231, rs2869513, rs12732926, rs1318720, rs876685, |
| | rs893964, rs4654814, rs7516175, rs2817907, rs2817900, rs16827538, |
| | rs7530478, rs2869511, rs751022, rs10917314, rs4654821, rs10917318, |
| | rs4655130, rs4654824, rs6426770, rs2138542, rs10158095, rs116119, |
| | rs2675494, rs309499, rs309492 |
| EPHB3 | rs7653075, rs12489076, rs4132006, rs9862375, rs7652033, rs7652280 |
| EPHB4 | rs314346, rs2230585, rs144173, rs314313, rs2247445 |
| EPHB6 | rs8177146, rs6464535, rs4987685, rs7789303, rs8177100, rs1009848, |
| | rs8177141 |
| EPO | rs1617640, rs551238 |
| EPOR | rs318717, rs318720, rs431144 |
| ERBB2 | rs2517956, rs4252599, rs1565923, rs1810132, rs4252634, rs1801200, |
| | rs1058808, rs9896218 |
| ERBB4 | rs3748960, rs3748962, rs3791699, rs10497944, rs17804031, rs4131610, |
| | rs10192302, rs7602850, rs6435660, rs13035133, rs13390226, rs12464239, |
| | rs17416172, rs12995889, rs10207020, rs10173511, rs9288452, rs1394785, |
| | rs972488, rs7556832, rs1384292 |
| EREG | rs1563826, rs6837909, rs2367707, rs7687621, rs1542466 |
| ESR1 | rs488133, rs9340771, rs2077647, rs746432, rs17847065, rs9340784, |
| | rs6926750, rs9340802, rs9340820, rs1514348, rs1709183, rs9340835, |
| | rs7761846, rs4869748, rs6557171, rs12154178, rs6912184, rs1801132, |
| | rs3020377, rs7383754, rs726281, rs3020407, rs9340954, rs2207231, |
| | rs3020422, rs9371573, rs3020368, rs2207396, rs3798575, rs3020382, |
| | rs9341069, rs2228480, rs3798577 |
| ESR2 | rs1256061, rs944461, rs8017441, rs1256054, rs1256049, rs1256044, |
| | rs7154455, rs1256030, rs3783736, rs17179740, rs1271572, rs8004842, |
| | rs10483774, rs3020450, rs10137185, rs17101774, rs17226081, rs1256120, |
| | rs12435395 |
| ETV1 | rs41505, rs17739403, rs5882426, rs10215655, rs3801101, rs9639168, |
| | rs6969848, rs2237292, rs3823702, rs9785000 |
| FAAH | rs913168, rs932816, rs6703669, rs3766246, rs324420, rs324419, rs2295633, |
| | rs12029329 |
| FACL2 (ACSL1) | rs1056896, rs8086, rs2292898, rs3792311, rs1803898, rs7681334, |
| | rs3806795, rs13112568, rs9997745, rs12503643, rs10027540 |
| FGF2 | rs308395, rs1449683, rs11938826, rs308442, rs308379, rs6534365, |
| | rs308388, rs1476214, rs3804158 |
| FMR1 | rs1805420, rs4949, rs25727, rs25707, rs25714, rs25702, rs25704, |
| | rs6626284, rs28900 |
| FOS | rs2239615, rs7101, rs1046117 |
| FPRL1 | rs11666254, rs4801893, rs10853843, rs17834679, rs17695052 |
| GABARAPL1 | rs4322502, rs4326886, rs11539, rs7248 |
| GABBR1 | rs2267633, rs740884, rs29230, rs2076489, rs29253, rs29225, rs29243 |
| GABBR2 | rs1044637, rs2304391, rs10985765, rs2304389, rs3780446, rs3780445, |
| | rs3205936, rs7020345, rs10986125, rs2808536, rs3750344, rs2779535, |
| | rs2779536, rs7869482, rs3808896, rs529269 |
| GABRA2 | rs573400, rs10938435, rs519270, rs2083422, rs279843, rs279844, rs279827, |
| | rs1442060, rs1442062, rs3756007, rs2119767, rs894269 |
| GABRA4 | rs7678338, rs17599158, rs1160093, rs7689605, rs9291300, rs3792208, |
| | rs10517171, rs16859826, rs2229940, rs3762611 |
| GABRA6 | rs1992646, rs3811995, rs3811992, rs6883829, rs3219151 |
| GABRB1 | rs2236781, rs1866989, rs7666487, rs7677890, rs13107066, rs13107066, |
| | rs6284, rs6289, rs6290, rs16860198, rs4591574, rs10028945, rs3733469 |
| GABRB2 | rs592403, rs2229944, rs10515826, rs2194159, rs7724086, rs1363697, |
| | rs10051667, rs4304105, rs2962406, rs10069900, rs6882041, rs3816596 |
| GABRB3 | rs2017247, rs2912582, rs2077920, rs3928441, rs2033420, rs8036052, |
| | rs2873027, rs7173713, rs2194958, rs10873637, rs981778, rs6576603, |
| | rs4453447, rs8179184, rs4906902, rs12910925, rs17647384 |
| GABRD | rs13303344, rs2376805, rs2229110, rs16824627 |
| GABRG2 | rs209345, rs3219203, rs209350, rs11135176, rs211037, rs211029, rs387661, |
| | rs7728001, rs2205364, rs10491329, rs211014, rs418210 |
| GABRG3 | rs12442092, rs7403021, rs2376481, rs7177870, rs997140, rs140674, |
| | rs7162014, rs3097500, rs3101640, rs140679, rs2066712, rs7177425 |
| GAD1 | rs3791878, rs11542313, rs3828275, rs2241164, rs769407, rs701492, |
| | rs769393, rs769402, rs4297845 |
| GAD2 | rs2236417, rs2236418, rs7919405, rs2839672, rs3781116, rs1330581, |
| | rs4747547, rs2839678, rs1556234, rs7900976, rs3781109, rs4749107, |
| | rs4747550, rs870341, rs8190800 |
| GAL | rs4930241, rs694066, rs3136540, rs3136641, rs3136546 |
| GALR1 | rs11662010, rs5374, rs5375, rs2717162, rs9961622, rs5376, rs5377 |
| GALR2 | rs2443168, rs2598414, rs2256879, rs8836 |
| GALR3 | rs2285179, rs2017022, rs2284058 |
| GBP1 | rs7911, rs1048443, rs1048425, rs1048410, rs1048401, rs10493822, |
| | rs1536670 |
| GBP2 | rs4656093, rs1329119, rs4656095, rs3738053, rs7537937, rs2297025, |
| | rs10754261, rs17130736 |
| GCH1 | rs10483639, rs7142517, rs752688, rs4411417, rs8007201, rs7492600, |
| | rs998259, rs3783641, rs2878172, rs8007287 |
| GDNF | rs11748343, rs3749692, rs1549250, rs2973041, rs3096140, rs2975100 |
| GLRA1 | rs2229962, rs11167557, rs1346489, rs1428155, rs2915890, rs2964608, |
| | rs6579906, rs7709656, rs991738 |
| GLRA2 | rs3027322, rs7889706, rs3027358, rs2238914, rs2188931, rs3027379, |
| | rs7877036, rs6526791, rs1160198, rs6526822, rs5934186, rs5935787, |
| | rs6630811, rs2188886, rs5935799, rs5980064, rs5935802, rs11795712, |
| | rs11796093 |
| GLRB | rs2880691, rs3775725, rs4432799, rs7672929, rs1806572, rs4618360, |
| | rs1801154, rs11945868, rs7662298, rs1129304 |
| GNB2L1 | rs2770997, s2287715, rs3806919, rs888709 |
| GNG5 | rs3813605, rs2794218, rs7555821 |
| GPX4 | rs4807542, rs4807543, rs2302109, rs757228, rs8178967 |
| GRIA1 | rs4145160, rs540375, rs1864205, rs573496, rs1826532, rs480726, |
| | rs1463748, rs10463249, rs1873905, rs716518, rs12153765, rs4958667, |
| | rs778819, rs12658202, rs1493383, rs1873910, rs778833, rs2910266, |
| | rs1422889, rs1363673, rs707176, rs2910269, rs4958672, rs4385264, |
| | rs4077374, rs10042081, rs4530817, rs4299782, rs7735784, rs4502882, |
| | rs11741924, rs4128572, rs3813470, rs4958676, rs1461227, rs10070447 |
| GRIA2 | rs6536221, rs4264878, rs10011589, rs6536224, rs6847043, rs10517665, |
| | rs6844775, rs6536231, rs4302506, rs4475186, rs4691394, rs10007366, |
| | rs4392549, rs6816610, rs6536234, rs6855973, rs6812058 |
| GRIA3 | rs3761555, rs3761554, rs1557545, rs12559450, rs2040404, rs2511034, |
| | rs502434, rs5910006 |
| GRIA4 | rs11226804, rs3758799, rs11226805, rs10750731, rs1445604, rs12421796, |
| | rs7940036, rs1942968, rs1445607, rs977516, rs1258270, rs667713, |
| | rs7931588, rs10895871, rs2186598, rs11226839, rs1954763, rs17478710, |
| | rs7119216, rs748008, rs618301, rs7124769, rs10895877, rs661148, |
| | rs1940964, rs668950, rs599980, rs2277279, rs642544, rs680109, rs2508467, |
| | rs609239, rs1144410, rs3758796, rs2898230, rs502453, rs665554, |
| | rs1939826, rs3758790, rs675091 |
| GRIK1 | rs16984336, rs1977525, rs363504, rs2248989, rs2832405, rs2051182, |
| | rs2018636, rs2832414, rs7509953, rs363526, rs363522, rs363512, |
| | rs6516925, rs3026002, rs363602, rs6516926, rs467407, rs420121, rs466884, |
| | rs464028, rs402280, rs2248845, rs2832469, rs466612, rs466093, rs463479, |
| | rs462393, rs457474, rs467028, rs2245528 |
| GRIN1 | rs4880213, rs2301363, rs10870198, rs12238250, rs6293 |
| GRIN2A | rs1014531, rs7202950, rs12598139, rs765287, rs2284239, rs727605, |
| | rs917834, rs4782041, rs4628972, rs3104703, rs11641062, rs3848328, |
| | rs844395, rs7201574, rs2650429, rs8052800, rs4780784, rs1448239, |
| | rs3852745, rs1345424, rs1071502, rs1071504 |
| GRIN2B | rs1805477, rs1805474, rs2284402, rs2284406, rs2268107, rs1012587, |
| | rs1012586, rs2284411, rs741327, rs2268125, rs220558, rs220575, rs141658, |
| | rs220587, rs2268130, rs220598, rs1120905, rs2193511, rs10845848, |
| | rs7952915, rs2041986, rs10772717, rs219872, rs918168, rs717700, |
| | rs219933, rs219934, rs1345485, rs10505778, rs3764030 |
| GRIN3B | rs2240154, rs2285906 |
| GRK4 | rs2488813, rs16843684, rs2185886, rs2105380, rs2960306, rs1024323, |
| | rs2471350, rs3796468, rs2857844, rs2798298, rs1801058, rs2471347 |
| GRK5 | rs2230347, rs1980030, rs7093673, rs7095989, rs10886437, rs4752275, |
| | rs10128498, rs1473799, rs871196, rs11198874, rs17098707, rs3740563, |
| | rs10886462, rs12415832, rs7101022, rs1413582, rs12416565, rs12780837, |
| | rs3781495, rs4751716, rs928570, rs1889432, rs915120, rs10749320, |
| | rs1999627 |
| GRK6 | rs9313759, rs867755, rs3764925, rs335435 |
| GRK7 | rs1533499, rs2681696, rs2138789, rs13065862, rs4337623, rs4683625, |
| | rs1879287 |
| GRM1 | rs863820, rs9403765, rs9322045, rs9373486, rs4896857, rs4551188, |
| | rs9386147, rs2328729, rs6914239, rs6570754, rs4896864, rs362868, |
| | rs362895, rs9403775, rs362936, rs2300626, rs2268666, rs2941, rs6923492, |
| | rs7770466 |
| GSTM1 | rs412302, rs756637, rs449856, rs611951 |
| GSTT1 | rs4630, s2266637, rs2266633, rs2266636, rs6004035 |
| HIF1A | rs11847020, rs2301106, rs1951795, rs10129270, rs8005745, rs1957756, |
| | rs17099141, rs966824, rs11549465, rs1319462 |
| HN1 | rs4789145, rs7225769, rs11656524 |
| HNRNPG-T | rs7129581, rs4462317 |
| HNRPD | rs11941278, rs2288338, rs1820577, rs1365872, rs2288337 |
| HNRPU | rs1495946, rs3766527, rs12068974, rs1532397 |
| HSPA8 | rs7948948, rs3179174, rs1064585, rs11218941 |
| HSPA9B | rs10117, rs1042665, rs6596438, rs256008, rs690158 |
| HSPCA | rs35997255, rs1059623, rs3742429, rs3736807, rs2224460, rs8005905, |
| | rs10873531, rs34363326, rs34668411 |
| HSPCB | rs476632, rs35074133, rs13296, rs35612006 |
| IFI30 | rs273265, rs2241089, rs2241090, rs11554159, rs7125, rs1045747 |
| IFNG | rs2069734, rs2069705, rs1861493, rs2069707, rs2069732 |
| IFRD1 | rs2520482, rs728273, rs3109117, rs10155882, rs6967593, rs2529587, |
| | rs1024570, rs7817 |
| IGF1 | rs35767, rs5742612, rs12821878, rs7956547, rs5742632, rs10735380, |
| | rs10860865, rs11111267, rs6214 |
| IKBKB | rs7015100, rs3747811, rs5029748, rs9694958, rs2294100, rs2272736, |
| | rs10958713, rs9786118, rs6474388, rs1057741, rs11986055 |
| IL10 | rs3024505, rs3024496, rs1554286, rs1518111, rs1800871, rs1800896 |
| IL13 | rs3091307, rs1800925, rs2066960, rs1295686, rs20541, rs2069757, |
| | rs1295683, rs762534 |
| IL1A | rs4848300, s17561, rs3783531, rs2071373, rs1800587 |
| IL1B | rs1071676, rs1143643, rs1143634, rs1143627, rs16944, rs1143623 |
| IL1RN | rs2234676, rs2234677, rs1794065, rs3181052, rs419598, rs315952, |
| | rs315951, rs4252041, rs9005, rs315946 |
| IL-2 | rs1479922, rs2069772, rs2069763, rs2069762 |
| IL4 | rs2070874, rs2227284, rs2243250, rs2243251, rs2243291 |
| IL-6 | rs4719714, rs3087221, rs1800797, rs3087226, rs2069830, rs2069845, |
| | rs2069860, rs2069849, rs3087237 |
| IL-8 | rs2227525, rs4073, rs2227307, rs2227306, rs4694637 |
| INADL | rs7551399, rs6685551, rs1286837, rs3762321, rs1286823, rs1286831, |
| | rs1286813, rs2185136, rs2799629, rs2799627, rs6698337, rs6685516, |
| | rs9326052, rs1332636, rs1056513, rs10889272, rs10489968, rs11207881, |
| | rs3762448, rs2365738, rs1332631, rs6661849, rs2498982, rs12076103, |
| | rs1475563, rs7418709, rs2481676 |
| INSIG1 | rs17174297, rs9767875, rs9770068 |
| ITGAM | rs4608351, rs1143678, rs4077810, rs7201448, rs11150610, rs1143681, |
| | rs7499077, rs8045402, rs9937837, rs11861251, rs8048583, rs8057320 |
| JUN | rs9989, rs11688, rs1575440, rs4647002, rs4647018 |
| KCNA2 | rs9782928, rs3887820, rs12411052 |
| KCNJ11 | rs5215, rs5217, rs5218, rs886288, rs5219, rs2285676, rs8175351 |
| KCNJ3 | rs3106661, rs3106660, rs16838016, rs3111033, rs11690166, rs12471749, |
| | rs3106653, rs3111017, rs6711727, rs1823003, rs1823001, rs2961956, |
| | rs10497144, rs10804161, rs13390038, rs2591154, rs17566896, rs1445652, |
| | rs1550798, rs2652461, rs1900132, rs17642086, rs1979004 |
| KCNJ5 | rs6590356, rs7924416, rs2846700, rs4937387, rs4937390, rs6590357, |
| | rs7118824, rs2846675, rs3867250 |
| KCNJ6 | rs2835844, rs702859, rs2835848, rs2835855, rs10483038, rs3392, |
| | rs2835885, rs1399592, rs6517428, rs2835896, rs2835903, rs2070995, |
| | rs857958, rs858040, rs858027, rs2835921, rs2835931, rs2835945, |
| | rs1787337, rs1005358, rs2211842, rs2835988, rs991985, rs2836016, |
| | rs981288, rs3827199, rs762146, rs2409943, rs928765, rs928766, rs3787870, |
| | rs11702683, rs6517442 |
| KCNJ8 | rs2307023, rs11046186, rs829064 |
| KCNJ9 | rs2737703, rs2753268, rs3747619, rs2295621 |
| KCNK2 | rs1452634, rs1157493, rs1947364, rs7535436, rs2363561, rs2885816, |
| | rs4375232, rs2363563, rs2363557, rs2363565, rs12118235, rs1556905, |
| | rs1339408, rs1339409, rs4375236, rs4539107, rs6704324, rs10864166 |
| KCNS1 | rs1540310, rs6124684, rs734784, rs6017486, rs6017488, rs6104012 |
| KCTD17 | rs11913810, rs2235320, rs8138791, rs2235321, rs855791, rs760719 |
| KLK1 | rs3212857, rs5517, rs5516, rs1054713, rs5515, rs2659058, rs5514 |
| KLKB1 | rs4253239, rs1511802, rs3733402, rs2304595, rs4253301, rs4253325, |
| | rs925453 |
| KPNB1 | rs11870935, rs3809868, rs6503796 |
| LIPL3 | rs17112186, rs415996, rs412227, rs17349080, rs303459, rs17434481, |
| | rs430517, rs12412357, rs303477, rs303524 |
| MAO-A | rs4570308, rs5906729, rs2310883, rs909525, rs1800659, rs6323, rs3027403, |
| | rs3027405, rs2239448, rs1137070, rs3027407 |
| MAO-B | rs1040398, rs1799836, rs5952294, rs3027449, rs3027452, rs6651806, |
| | rs2238969, rs12010260, rs6520902, rs5905512, rs5952352 |
| MAP2K1 | rs12443313, rs907893, rs7166547, rs12439516, rs12440176, rs1432442, |
| | rs8036023, rs11630608, rs4258558, rs17586159, rs14303, rs8684 |
| MAP2K1IP1 | rs11944405, rs11937985, rs2298734 |
| MAPK1 | rs3810608, rs6928, rs2298432, rs2283791, rs1557288, rs9610338, |
| | rs3729910, rs2266968, rs5999752, rs12172554, rs8136867, rs4521402, |
| | rs9610496 |
| MAPK11 | rs2272857, rs2072878, rs2076139, rs2066762, rs2066765, rs2235356 |
| MAPK13 | rs3761978, rs3761977, rs1059227, rs2859141, rs2252430, rs2071863 |
| MAPK14 | rs3761980, rs611846, rs851024, rs2237094, rs664367, rs2145362, |
| | rs2237093, rs851006, rs2815805, rs7761118, rs6457878, rs3804452 |
| MAPK3 | rs7698, rs1143695, rs11865086, rs9921806, rs9932466 |
| MC1R | rs3212351, rs3212358, rs3212363, rs1805005, rs2228479, rs2229617, |
| | rs1805007, rs1805008, rs885479, rs2228478 |
| MC4R | rs9966412, rs2229616, rs9953038 |
| MFN1 | rs6762399, rs9822116, rs7356002, rs3976523, rs11720405 |
| MFN2 | rs3818157, rs879690, rs879691, rs1474868, rs1810563 |
| MME | rs1836914, rs989692, rs17442808, rs16824558, rs12635515, rs3773885, |
| | rs35152996, rs1436633, rs9830725, rs4679739, rs3773876, rs9864287, |
| | rs701109, rs12765, rs6665 |
| MPDZ | rs722651, rs3264, rs3765550, rs10960954, rs10809907, rs2274856, |
| | rs10809913, rs17273542, rs10738329, rs17182402, rs7041374 |
| MPO | rs8079006, rs2071409, rs7208693, rs2333227 |
| MRGPRD | rs4930634, rs7950368, rs10896389 |
| MSN | rs12011733, rs5964999, rs7058831, rs7891236, rs6624812, rs6525004, |
| | rs13731, rs16989707 |
| MTHFR | rs198413, rs13306561, rs2066470, rs11121832, rs1801133, rs2066462, |
| | rs1801131, rs2274976, rs4846049 |
| NAB1 | rs1023568, rs2270232, rs1978273, rs10185029, rs10490539, rs2192011 |
| NALP12 | rs4619513, rs10410581, rs35064500, rs8110965, rs12460528, rs4806773, |
| | rs2866112, rs34971363, rs34854934, rs34436714, rs4419163 |
| NFKBIA | rs2273650, rs896, rs2233419, rs10782383, rs2233412, rs1957106, |
| | rs2233409, rs2233408 |
| NFKBIZ | rs9841857, rs11718446, rs7644388, rs6441627, rs616597, rs678354, |
| | rs14134 |
| NGFB | rs7523086, rs6330, rs910330, rs2856813, rs12058927, rs6537860, |
| | rs4565713, rs4320778, rs17540656, rs11102930, rs11466066 |
| NOS1 | rs9658478, rs2682826, rs2293044, rs9658501, rs3741475, rs1353939, |
| | rs9658472, rs1047735, rs1093329, rs2293054, rs6490121, rs2293052, |
| | rs3782202, rs2139733, rs3825103, rs478597, rs2077171, rs3782214, |
| | rs9658279, rs545343, rs545654, rs1552227, rs693534, rs1123425, |
| | rs3782221, rs9658258, rs9658255, rs9658254 |
| NOS2A | rs16966522, rs3794756, rs1060826, rs1060822, rs2297518, rs1137933, |
| | rs3730017, rs8072199, rs3730013, rs2779248, rs2779251 |
| NOS3 | rs10277237, rs3918226, rs1800783, rs3918166, rs1549758, rs1799983, |
| | rs3918201, rs743507, rs3918234, rs3918211, rs3800787 |
| NPY | rs16140, rs16147, rs16478, rs16142, rs16139, rs9785023, rs5574, rs16126 |
| NPY1R | rs4552421, rs4234955, rs4691910, rs9764, rs7687423, rs12510104, |
| | rs13306006 |
| NPY2R | rs17304901, rs2234759, rs1047214, rs2880415, rs9990860 |
| NPY5R | rs4632602, rs11100494, rs6536721 |
| NQO1 | rs10517, rs1800566, rs1437135, rs689459 |
| NR3C1 | rs6196, rs258751, rs10482672, rs33389, rs33383, rs9324916, rs11740792, |
| | rs2963155, rs9324918, rs6195, rs6190, rs6189, rs10482610, rs9324924, |
| | rs4518434, rs7719514, rs6868190, rs12521436 |
| NR4A1 | rs1283155, rs2701124, rs2230439, rs2230440, rs2603751 |
| NR4A2 | rs12803, rs834835, rs16840276 |
| NR4A3 | rs4743365, rs1405209, rs1526267, rs12352835, rs10429611, rs1131339 |
| NRG1 | rs4281084, rs7819063, rs7005606, rs4733130, rs3924999, rs7825588, |
| | rs17731664, rs2976532, rs7007436, rs10503929, rs6992642 |
| NTRK1 | rs2150906, rs1800600, rs1888861, rs1998977, rs4661229, rs12145540, |
| | rs1007211, rs6340, rs1800879, rs1410082, rs2274498, rs6334, rs6336, |
| | rs6337, rs2644596, rs6339, rs6338 |
| NTRK2 | rs1187323, rs3739570, rs1211166, rs1187353, rs2265, rs3780632, |
| | rs4877877, rs10746750, rs1662699, rs1187276, rs2120266, rs1822420, |
| | rs2808707, rs2289658, rs2277193, rs3860945, rs2378676, rs1490406 |
| NTRK3 | rs7176429, rs8031871, rs10468138, rs6496460, rs2229910, rs2229909, |
| | rs1128994, rs16941328, rs16941331, rs744994, rs744993 |
| NTSR1 | rs2427400, rs3746780, rs946478, rs3787535, rs6089930, rs2427430, |
| | rs856934, rs2273075, rs2427440, rs2427444 |
| NTSR2 | rs6742234, rs6432224, rs4233895, rs12612207, rs4669765, rs6432225, |
| | rs7567183 |
| OBLR | rs6090041, rs6090043, rs6011291, rs7271530, rs2229205, rs6089789 |
| OLR1 | rs1050286, rs2010655, rs2742115, rs2742113, rs2742112 |
| OPRD1 | rs1042114, rs533123, rs678849, rs6669447, rs188116, rs2236857, |
| | rs2298896, rs529520, rs2298895, rs2234918, rs204069, rs379944 |
| OPRK1 | rs1425910, rs7820807, rs702764, rs7016275, rs2303432, rs1051660, |
| | rs16918955, rs3808627 |
| OPRM1 | rs1294094, rs1319339, rs7776341, rs1074287, rs12205732, rs6912029, |
| | rs1799971, rs495491, rs3798678, rs563649, rs2075572, rs9322446, |
| | rs533586, rs540825, rs675026, rs660756, rs677830, rs1067684, rs623956, |
| | rs609148, rs497332, rs648893, rs548339, rs12660296, rs34427887, |
| | rs13193952, rs13191001, rs7739525 |
| OXT | rs877172, rs6133010, rs2740210, rs2770378 |
| P2RX2 | rs2323973, rs6560891, rs4883544 |
| P2RX3 | rs7106462, rs10896607, rs10732882, rs3781902, rs2276039, rs2276038, |
| | rs3781894 |
| P2RX4 | rs1169721, rs1044249, rs2303998, rs25643, rs25644, rs1653586 |
| P2RX7 | rs684201, rs685019, rs208288, rs17525809, rs208294, rs16950860, |
| | rs7958311, rs1718136, rs1718119, rs6489795, rs2230912, rs3751143, |
| | rs2230913, rs3751142, rs1621388, rs1653625 |
| P2RY1 | rs1439009, rs1065776, rs701265, rs11917883 |
| P2RY12 | rs9877389, rs16846673, rs3821667, rs2172249, rs3821664, rs10935842 |
| P2RY13 | rs6440735, rs1388628, rs1491980, rs1466684, rs3732757, rs4146770 |
| P2RY2 | rs557451, rs508859, rs1790070, rs2511241, rs1783596, rs1626154, |
| | rs17244555 |
| P2RY4 | rs3829708, rs3829709, rs1152187 |
| P2RY6 | rs12787775, rs6592517, rs7103650, rs2027765, rs11235711, rs7127013, |
| | rs1806516, rs3741152 |
| PACSIN1 | rs6927652, rs3600473, rs3846866, rs3846867, rs7748484, rs3904668, |
| | rs11753634, rs4713808, rs2296575, rs2233647 |
| PDGFB | rs130654, rs2857402, rs879180, rs4821877, rs4821875, rs4990919 |
| PDYN | rs2235749, rs10485703, rs742620, rs2281285, rs1997794 |
| PENK | rs16920581, rs4738501, rs1437277, rs2576573, rs1975285, rs2609998 |
| PLA2G4A | rs979924, rs12720485, rs12022299, rs10489406, rs10489407, rs6696406, |
| | rs6685652, rs2223307, rs10911946, rs7519192, rs2223310, rs4336803, |
| | rs4650708, rs11587539, rs7555140, rs12125857, rs932476, rs2307198, |
| | rs10752989, rs12720707 |
| PLA2G4B | rs1043627, rs7174710, rs2303516, rs1122884, rs3816533, rs1672466, |
| | rs1197669, rs883329, rs1061354 |
| PLAUR | rs4802189, rs4760, rs4251912, rs2302524, rs2239372, rs399145, rs2286960 |
| PNMT | rs1053651, rs3764351, rs876493, rs5638, rs2952151 |
| PNOC | rs2722897, rs17058952, rs1563945, rs7825480, rs2645721, rs2645715, |
| | rs904053 |
| POMC | rs1042571, rs10654394, rs6713532, rs934778, rs3754860, rs6545976 |
| PPP3CA | rs2583389, rs1348161, rs2044041, rs6852347, rs2850338, rs2659528, |
| | rs2850992, rs3730251, rs2850979, rs2695219, rs963065, rs2732514, |
| | rs1506801, rs1876267, rs2732504, rs3804357, rs6851231, rs1358312, |
| | rs997926, rs3804350, rs6826912 |
| PPP3CC | rs17060857, rs9785086, rs7821470, rs101080, rs13271367, rs2469749, |
| | rs2461491, rs17733242, rs2449341, rs28764007, rs7430 |
| PPP3R1 | rs6546366, rs2029091, rs930653, rs13029910, rs11692815, rs1868402 |
| PPP3R2 | rs17189401, rs3739723, rs3739724 |
| PRKACA | rs6511913, rs1368, rs8100819, rs729372, rs3745465, rs899173 |
| PRKACB | rs957828, rs12075911, rs7546625, rs10493750, rs10782823, rs1016379, |
| | rs2642183, rs903263, rs2812448, rs589373, rs7547892, rs2134647, |
| | rs7515976, rs11163916, rs600674, rs316630, rs606816, rs1057738, |
| | rs2389717, rs17131308 |
| PRKCABP | rs17555348, rs4821735, rs2076369, rs7289400, rs2012859 |
| PRKCD | rs1483186, rs3773732, rs6778964, rs2306571, rs11546559, rs2306572, |
| | rs2306574 |
| PRKCE | rs610115, rs687914, rs534288, rs588206, rs585156, rs1522984, rs2090414, |
| | rs1533476, rs940052, rs3924523, rs4446102, rs4952774, rs3923011, |
| | rs935661, rs1947195, rs735112, rs935651, rs753572, rs1987070, rs6730511, |
| | rs6742737, rs3768758, rs2345955, rs10495927, rs6544874, rs3754565, |
| | rs951012, rs281508, rs2278773, rs3738894, rs14138 |
| PRKD1 | rs11984, rs2273815, rs3783298, rs3783299, rs8012335, rs17115113, |
| | rs1959437, rs3783305, rs7156359, rs10498310, rs1953722, rs10150674, |
| | rs7154546, rs4329829, rs4424825, rs1953209, rs1958987, rs2151745, |
| | rs10498313 |
| PRKD3 | rs2041837, rs9318, rs1056021, rs3770764, rs2302650, rs10460527, |
| | rs3770761, rs10177176, rs1989172, rs2300880, rs11896614, rs1158219 |
| PRKG1 | rs6479835, rs10822178, rs10995555, rs1881597, rs12255069, rs1528880, |
| | rs12267384, rs10430472, rs1409351, rs10996377, rs10490977, rs9415743, |
| | rs7897669, rs2339630, rs9414806, rs16913257, rs957717, rs10822131, |
| | rs17509759, rs2816825 |
| PTGER1 | rs8598, rs11668633, rs7249305, rs3745459, rs28364035, rs3760703 |
| PTGER2 | rs1254600, rs1353410, rs1254594, rs1042618 |
| PTGER3 | rs959, rs6656853, rs5702, rs1409986, rs12026099, rs1409978, rs11209710, |
| | rs11209715, rs602383, rs661000, rs5695, rs2300164, rs5680, rs8179390, |
| | rs5671, rs5668, rs2744907 |
| PTGER4 | rs4133101, rs2228058, rs6451535, rs16870224, rs7445984 |
| PTGS1 | rs10306114, rs1236913, rs3842787, rs3842788, rs3842790, rs5789, |
| | rs10306163, rs3842802, rs3842803, rs10306194, rs10306202 |
| PTGS2 | rs2206593, rs5275, rs5272, rs5277, rs20426, rs2383515 |
| RAB20 | rs4771685, rs426453, rs419244, rs375814, rs418543, rs2025905, rs2391840, |
| | rs2477911, rs927793, rs1536621, rs4506764, rs766974 |
| Rab5 (RAB5A) | rs4610240, rs10510496, rs6778866, rs4241539, rs4398451, rs7616422, |
| | rs8682, rs7613136 |
| RAB8B | rs34960542, rs2588862, rs8029212, rs13313493, rs7167722, rs1444405, |
| | rs13681 |
| RELA | rs1049728, rs11568304, rs11227247, rs732072, rs12289836 |
| RET | rs3026727, rs2506007, rs3123655, rs1800858, rs1800860, rs1799939, |
| | rs1800861, rs1800863, rs2075912, rs2565200, rs2435355 |
| RGS2 | rs16834852, rs2746071, rs2746073, rs10489515 |
| RGS4 | rs6678136, rs16864782, rs2842030, rs10759, rs2940251 |
| RUNX1 | rs2249233, rs2835195, rs2248898, rs1882766, rs17227210, rs2071029, |
| | rs743289, rs2300400, rs2268290, rs2834653, rs2284613, rs2051394, |
| | rs2268278, rs1055314 |
| RUNX2 | rs12201555, rs12205523, rs16873373, rs16873379, rs10948234, |
| | rs12197755, rs7771980, rs11498192, rs9463087, rs765724, rs2790093, |
| | rs4714854, rs10485422, rs12209785, rs1200428 |
| RUNX3 | rs4265380, rs6672420, rs11249209, rs12117581, rs3845302, rs1003699, |
| | rs9438876, rs13157, rs2003679, rs3208621 |
| S100A12 | rs3006488, rs3006476 |
| S100B | rs9722, rs881827, rs2839361, rs2839364 |
| SAMSN1 | rs12626593, rs2822708, rs2822732, rs2822754, rs7281104, rs13052873, |
| | rs6516877 |
| SC5DL | rs1560409, rs727422, rs1061332, rs7942396 |
| SCD | rs670213, rs1054411, rs1502593, rs11598233, rs3978768, rs11557927, |
| | rs10883465 |
| SCN10A | rs6599240, rs11129800, rs11129801, rs6775197, rs6771157, rs12632942, |
| | rs6800541, rs6599251, rs7431144, rs6809264, rs6599257, rs11716493, |
| | rs11926158, rs9815891, rs9827941 |
| SCN11A | rs6776510, rs4541346, rs4371451, rs4133368, rs6786732, rs4315640, |
| | rs11919589, rs4514993, rs4504116, rs4345016, rs7636049, rs6763211, |
| | rs4076478 |
| SCN1A | rs7591522, rs552878, rs1461195, rs498631, rs692995, rs2298771, |
| | rs6432860, rs1461193, rs10930202, rs1461197, rs1020852, rs6722462, |
| | rs534798 |
| SCN2A1 (SCN2A) | rs17182714, rs6718960, rs12619626, rs3769931, rs13025009, rs12993173, |
| | rs2060199, rs16850532, rs10930162, rs2060198, rs2227899, rs2227898, |
| | rs1007722 |
| SCN3A | rs1439993, rs10930148, rs3213904, rs1158135, rs1946892, rs1439808, |
| | rs13011371, rs4667796, rs11894144, rs2390165, rs3806539 |
| SCN5A | rs1805126, rs1805124, rs3934936, rs7624535, rs6599230, rs11720524, |
| | rs9825294, rs7373686 |
| SCN8A | rs7975319, rs12426436, rs1905248, rs12424271, rs10783462, rs3782478, |
| | rs4761829, rs4761831, rs1816760, rs1439790, rs303802, s303815, rs60637, |
| | rs3741705 |
| SCN9A | rs3750904, rs13430906, rs16851799, rs10930214, rs4633936, rs4453709, |
| | rs3924001, rs6747673, rs13402180, rs4632359, rs9646771, rs9646772, |
| | rs4131162 |
| SET | rs13296296, rs6478846, rs4240432 |
| SGK | rs2758152, rs7755303, rs1057293, rs1763527 |
| SGKL | rs2357998, rs6472285, rs7002479, rs7002788, rs12114734, rs11780700 |
| SLC1A3 | rs2562581, rs1366638, rs1864213, rs13166160, rs1645660, rs3776573, |
| | rs4869682, rs10491374, rs2032892, rs2229894, rs2269272 |
| SLC18A2 | rs363330, rs363332, rs363338, rs363221, rs4752045, rs363230, rs363279, |
| | rs14240 |
| SLC29A1 | rs1057985, rs3778504, rs693955, rs324148, rs760370, rs3734703 |
| SLC32A1 | rs1321099, rs1322183, rs6092933 |
| SLC6A11 | rs2600072, rs9835618, rs971930, rs9835411, rs6442209, rs3774125, |
| | rs2304725, rs3774116, rs1609480, rs6809562, rs6442211, rs4684743, |
| | rs11720592, rs3821767, rs2629133, rs2655280, rs2581206, rs2629135, |
| | rs2272395, rs2697159, rs2272400, rs2245532, rs3732371, rs6782922 |
| SLC6A13 | rs495360, rs2289954, rs555044, rs2289957, rs492540, rs10848623, |
| | rs3782856, rs1548904, rs797765 |
| SLC6A2 | rs2242446, rs3785143, rs192303, rs6499771, rs36024, rs36023, rs36021, |
| | rs3785152, rs1805066, rs11862589, rs1861647, rs5569, rs42460, rs7194256, |
| | rs171798, rs258099 |
| SLC6A3 | rs27072, rs11133767, rs429699, rs6347, rs2963253, rs6348, rs464049, |
| | rs463379, rs403636, rs6346, rs6350, rs2975226 |
| SLC6A4 | rs1042173, rs3794808, rs140701, rs140700, rs2228673, rs2020942, rs6355, |
| | rs2066713, rs2020933, rs25533 |
| SOD2 | rs7855, rs8031, rs5746151, rs10370, rs5746146, rs2758331, rs5746105, |
| | rs1799725, rs5746092, rs5746091 |
| STAU1 (STAU) | rs1043357, rs1043361, rs348298, rs7272164, rs2273653, rs348277, |
| | rs624945, rs2426143, rs348290 |
| STAU2 | rs3088139, rs10112019, rs10458310, rs12680126, rs6991856, rs716009, |
| | rs2891352, rs949493, rs7015090, rs4738390, rs6992006, rs1566772, |
| | rs10086435, rs10100388, rs10106686, rs6995579, rs3808621, rs10086736 |
| TAAR1 | rs9402439, rs8192619, rs8192620, rs9375907 |
| TAAR2 | rs4380767, rs11968252, rs8192646 |
| TAAR3 | rs4078135, rs7738600, rs3813353 |
| TAAR4 | rs7772928, rs4144146, rs9389009 |
| TAAR5 | rs17061477, rs3813354, rs3813355 |
| TAAR6 | rs8192625, rs8192624, rs8192622 |
| TAAR7 | rs2255071, rs17061372 |
| TAAR8 | rs8192627 |
| TAAR7/8 | rs11965773 |
| TAAR7/9 | rs9389004 |
| TAC1 | rs6465606, rs2072100, rs1229434, rs12532490 |
| TACR1 | rs881, rs4439987, rs6546952, rs3755459, rs3821314, rs2160652, rs6741029, |
| | rs3771827, rs10208860, rs4519549, rs2216307, rs10865408, rs3771859, |
| | rs6715729, rs2111375 |
| TCIRG1 | rs884826, s2075609, rs3794186 |
| TGFB1 | rs6957, rs2241719, rs4803455, rs1800471, rs1982073, rs1982072 |
| TH | rs3842738, rs2070762, rs6357, rs6356, rs7950050, rs10770140, rs10840490 |
| THBS1 | rs3784390, rs1478604, rs2228261, rs2292305, rs2228262, rs2228263, |
| | rs1051442, rs3743125 |
| TIEG (KLF10) | rs1434278, rs3191333, rs4734653, rs1076030 |
| TIMP1 | rs2294219 |
| TLR4 | rs2770150, rs11536865, rs1927911, rs1927907, rs5030710, rs4986790, |
| | rs5031050, rs4986791, rs7869402, rs11536889 |
| TMSB10 | rs7580854, rs1804515, rs1052264, rs1382507 |
| TMSB4X | rs5935457, rs9778614, rs17008883, rs3088116 |
| TNF | rs1800629, rs361525, rs2228088, rs3093726, rs3091257 |
| TNFAIP3 | rs3757173, rs5029942, rs5029956, rs610604, rs5029953 |
| TPH2 | rs4570625, rs10748185, rs11179002, rs1386496, rs1386492, rs7305115, |
| | rs1023990, rs7299582, rs4760754, rs1352250, rs1487276, rs1487275, |
| | rs4474484, rs7315855, rs17110747, rs17110563 |
| TRPM8 | rs1003540, rs6709005, rs10803665, rs11562954, rs758275, rs10180847, |
| | rs9646720, rs12472151, rs6740118, rs7593557, rs10929320, rs10929321, |
| | rs12185625, rs10171428, rs13411202, rs10207672, rs10210459, |
| | rs11563056, rs11563208, rs6723922, rs7560562, rs11563071, rs11563202, |
| | rs2052030 |
| TRPV1 | rs7223530, rs4790522, rs224547, rs8065080, rs150908, rs3826501, |
| | rs150846, rs11870382, rs2277675, rs733080, rs182637, rs224495 |
| TRPV2 | rs3813769, rs3813768, rs8079271, rs8121, rs1129235, rs12936240, |
| | rs7208718 |
| TRPV3 | rs2271158, rs7219780, rs7216486, rs925101, rs7212403, rs4790145, |
| | rs395357, rs401643, rs1039519, rs1699138, rs322964, rs4790520 |
| UBE2G2 | rs760431, rs11569, rs183518, rs235275, rs84188 |
| UGT2B7 | rs7668258, rs7438284, rs7439366, rs4356975, rs12642938, rs6851533 |
| VEGF | rs36026135, rs25648, rs833069, rs3025010, rs3025053 |
| VIL2 | rs3205303, rs3102976, rs744893, rs3123116, rs6915189, rs9347258, |
| | rs923198 |
| VPS4A | rs246129, rs8044794, rs153050, rs1127231, rs12258 |
| VPS4B | rs1055002, rs2276317, rs17689135, rs3760572 |
| XDH | rs1042039, rs169596, rs4952085, rs1884725, rs10190201, rs2295475, |
| | rs17011368, rs17323225, rs2281547, rs6733391, rs4407290, rs206847, |
| | rs1265618, rs206860, rs3769616, rs206811, rs206812 |
| YWHAZ | rs3134353, rs1062382, rs3134380, rs1901362, rs2290291, rs4734497 |
| ZA20D2 | rs969, rs2809270, rs11143275, rs909172, rs2984529 |
| ZA20D3 | rs2461649, rs2461641, rs1357335, rs2866368, rs11072880, rs1916048, |
| | rs2103043 |

TABLE 3
ANALYSIS OF ASSOCIATIONS BETWEEN EXEMPLARY CANDIDATE
GENES AND MEASURES OF PAIN SENSITIVITY, SOMATIZATION,
DEPRESSION, TRAIT ANXIETY, AND BLOOD PRESSURE AS
PREDICTORS OF SOMATOSENSORY DISORDERS

| | | | | | staiy2 | |
|---|---|---|---|---|---|---|
| | | Pain | pill1, tbsi1 | beck, tbsi4 | Trait | Blood |
| Gene | SNP ID | Sensitivity | Somatization | Depression | anxiety | Pressure |
| ADRA1A | hCV2957871 | | | | | Yes |
| ADRA1A | hCV2957869 | YES | | | | |
| ADRA1A | hCV2696448 | YES | | | | YES |
| ADRA1A | hCV2696458 | | | | | Yes |
| ADRA1A | hCV2696465 | YES | | | | yes |
| ADRA1A | hCV11850521 | YES | | | | yes |
| ADRA1A | hCV129377 | YES | | | | yes |
| ADRA1A | hCV2696493 | | | YES | | |
| ADRA1A | hCV2696494 | | | YES | | |
| ADRA1A | hCV11850470 | | | | | yes |
| ADRA1A | hCV2696505 | | YES | | | |
| ADRA1A | hCV2696506 | | | YES | | |
| ADRA1A | hCV2315080 | | YES | | | |
| ADRA1A | hCV2315086 | YES | | | | |
| ADRA1A | hCV2696540 | | | | | |
| ADRA1A | hCV2696544 | YES | | | | |
| ADRA1A | hCV2696566 | | YES | YES | YES | |
| ADRA1A | hCV8795096 | | | | | yes |
| ADRA1A | hCV2315113 | | | | | yes |
| ADRA1A | hCV2696588 | | | | | yes |
| ADRA1B | hCV1738255 | yes | YES | | | |
| ADRA1B | hCV1738292 | yes | | | | |
| ADRA1B | hCV1738308 | | | | | yes |
| ADRA1B | hCV1738309 | | | | | yes |
| ADRA1B | hCV11271797 | | yes | | | |
| ADRA1B | hCV26140255 | | | | | yes |
| CALCRL | rs860859 | yes | | | | |
| CALCRL | rs696092 | yes | | | | |
| CALCRL | rs3771095 | yes | yes | | | |
| CALCRL | rs858745 | yes | yes | | | |
| CALCRL | rs17366895 | yes | yes | | | |
| CALCRL | rs3771083 | | YES | | | |
| CALCRL | rs10179705 | YES | | | | |
| CALCRL | rs10203398 | YES | | | | |
| COX2 | rs689470 | yes | | | | |
| COX2 | rs5275 | | | | | yes |
| COX2 | rs2066826 | | yes | | | |
| COX2 | rs5277 | YES | | | | |
| COX2 | rs2383515 | | yes | yes | | yes |
| EAR2 | rs288539 | yes | | | | |
| EAR2 | rs8099896 | yes | | | | |
| EAR2 | rs4808611 | yes | | | | |
| GALR3 | rs2017022 | yes | | | | |
| GALR4 | rs2284058 | yes | | | | |
| GALR5 | rs3091367 | yes | | | | |
| NET | rs1232486 | YES | | | | |
| NET | rs649183 | | | | YES | |
| NET | rs1232433 | | | YES | | |
| GRIN3B | rs16176384 | | | yes | | |
| GRIN3B | rs25964542 | | YES | | | |
| DREAM | rs16102427 | | | Yes | | |
| DREAM | rs2172166 | | | | | |
| DREAM | rs11513235 | | Yes | | Yes | |
| MuOpioid | rs1074287 | yes | | | | yes |
| MuOpioid | rs524731 | | | | | yes |
| MuOpioid | rs563649 | yes | | | | yes |
| MuOpioid | rs677830 | | | | | yes |
| MuOpioid | rs609148 | | | | | yes |
| Delta | rs1042114 | | | | YES | |
| Opioid | | | | | | |
| Delta | rs533123 | YES | | | | |
| Opioid | | | | | | |
| Delta | rs678849 | | YES | | YES | |
| Opioid | | | | | | |
| IL-1B | rs9546517 | | | | | YES |
| IL-1B | rs1839945 | | | | | YES |
| IL-1B | rs1839944 | | | | | YES |
| IL-10 | rs1800896 | YES | | | | |
| IL-10 | rs1800893 | YES | | | | |
| IL-13 | rs2066960 | YES | | | | YES |
| IL-13 | rs1295686 | | | | | YES |
| IL-13 | rs20541 | | | | | YES |
| IL-13 | rs1295685 | | | | | YES |
| IL-2 | rs3136534 | yes | yes | | | |
| IL-2 | rs1479922 | yes | | yes | yes | |
| IL-2 | rs2069772 | yes | | | | |
| IL-2 | rs2069762 | yes | YES | | | yes |
| IL-4 | rs2070874 | yes | | | | |
| IL-4 | rs734244 | yes | | | | |
| IL-4 | rs2227284 | yes | | | | |
| IL-4 | rs2243267 | yes | | | | |
| IL-4 | rs2243270 | yes | | | | |
| IL-4 | rs2243291 | yes | | | | |
| NFKBIA | rs2233419 | yes | | | | |
| NFKBIA | rs1957106 | yes | | | | |
| NFKBKB | rs238338 | yes | | | | YES |
| NFKBKB | rs374907 | yes | | | | YES |
| NFKBKB | rs16186013 | yes | | | | yes |
| NFKBKB | rs15935523 | yes | | | | |
| NFKBKB | rs27504494 | yes | | | | |
| NFKBKB | rs11860688 | yes | | | | yes |
| NFKBKB | rs15746872 | yes | | | | |
| NFKBKB | rs15963514 | yes | | | | |
| NFKBKB | rs57962 | yes | | | | |
| NFKBKB | rs11860684 | yes | | | | yes |
| NFKBKB | rs27504494 | yes | | | | |
| PTGS1 | rs10306114 | | | | yes | |
| PTGS2 | rs1236913 | | yes | | | |
| PTGS3 | rs3842787 | | | | yes | |
| PTGS4 | rs3842788 | | | | | yes |
| PTGS5 | rs5789 | YES | | | | |
| PTGS6 | rs5794 | | | | | yes |
| PTGS7 | rs10306194 | YES | | | | yes |
| RGS4 | rs16864782 | yes | | | | |
| RGS4 | rs2842030 | yes | | | | |
| RGS4 | rs10799897 | yes | | | | |
| RGS4 | rs10759 | yes | | | | |
| RCP9 | rs316314 | | | | | yes |

ANOVA analysis:
YES = P < 0.01,
yes = P < 0.05

TABLE 4
EXEMPLARY GENES ASSOCIATED WITH SOMATOSENSORY
DISORDERS

| Gene | Other | |
|---|---|---|
| Symbol | Symbols | Gene Name |
| HTR1A | | 5-hydroxytryptamine (serotonin) receptor 1A |
| HTR1B | | 5-hydroxytryptamine (serotonin) receptor 1B |
| HTR2A | | 5-hydroxytryptamine (serotonin) receptor 2A |
| HTR2C | | 5-hydroxytryptamine (serotonin) receptor 2C |
| HTR3A | | 5-hydroxytryptamine (serotonin) receptor 3A |
| HTR3B | | 5-hydroxytryptamine (serotonin) receptor 3B |
| ABCB1 | | ATP-binding cassette, sub-family B (MDR/TAP), member 1 |
| ACCN1 | ASIC1 | amiloride-sensitive cation channel 1, neuronal (degenerin) |
| ACCN2 | ASIC2 | amiloride-sensitive cation channel 2, neuronal |
| ACCN3 | ASIC3 | amiloride-sensitive cation channel 3 |
| ACCN4 | | amiloride-sensitive cation channel 4, pituitary |
| ACE | | angiotensin I converting enzyme (peptidyl-dipeptidase A) 1 |
| ACE2 | | angiotensin I converting enzyme (peptidyl-dipeptidase A) 2 |
| ADCY7 | | adenylate cyclase 7 |
| ADORA1 | | adenosine A1 receptor |
| ADORA2A | | adenosine A2a receptor |
| ADORA2B | | adenosine A2b receptor |
| ADORA3 | | adenosine A3 receptor |
| ADRA1A | | adrenergic, alpha-1A-, receptor |
| ADRA1B | | adrenergic, alpha-1B-, receptor |
| ADRA1D | | adrenergic, alpha-1D-, receptor |
| ADRA2A | | adrenergic, alpha-2A-, receptor |
| ADRA2B | | adrenergic, alpha-2B-, receptor |
| ADRA2C | | adrenergic, alpha-2C-, receptor |
| ADRB2 | | adrenergic, beta-2-, receptor, surface |
| ADRB3 | | adrenergic, beta-3-, receptor, surface |
| ADRBK2 | BARK2, | adrenergic, beta, receptor kinase 2 |
| | GRK3 | |
| AGT | | angiotensinogen (serpin peptidase inhibitor, clade A, |
| | | member 8) |
| AGTR1 | | angiotensin II receptor, type 1 |
| AGTR2 | | angiotensin II receptor, type 2 |
| ANXA1 | | annexin A1 |
| ANXA2 | | annexin A2 |
| AP1G1 | | adaptor-related protein complex 1, gamma 1 subunit |
| ARL5B | | ADP-ribosylation factor-like 5B |
| ARRB1 | | arrestin, beta 1 |
| ARRB2 | | arrestin, beta 2 |
| ATF3 | | activating transcription factor 3 |
| ATP1A1 | | ATPase, Na+/K+ transporting, alpha 1 polypeptide |
| ATP1A2 | | ATPase, Na+/K+ transporting, alpha 2 (+) polypeptide |
| ATP1B3 | | ATPase, Na+/K+ transporting, beta 3 polypeptide |
| ATP2B1 | | ATPase, Ca++ transporting, plasma membrane 1 |
| ATP6A1 | | ATPase, H+ transporting, lysosomal, alpha polypeptide, |
| | | 70 kD, isoform 1 |
| ATP6V1B2 | | ATPase, H+ transporting, lysosomal, beta polypeptide, |
| | | 56/58 kD, isoform 2 |
| BDKRB1 | | bradykinin receptor B1 |
| BDKRB2 | | bradykinin receptor B2 |
| BDNF | | brain-derived neurotrophic factor |
| BTG2 | | BTG family, member 2, translocation gene 2, anti- |
| | | proliferative secrited protein |
| CACNA1A | | calcium channel, voltage-dependent, P/Q type, alpha 1A |
| | | subunit |
| CACNA2D1 | | calcium channel, voltage-dependent, alpha 2/delta subunit 1 |
| CACNA2D2 | | calcium channel, voltage-dependent, alpha 2/delta subunit 2 |
| CALCA | | Calcitonin/calcitonin-related polypeptide, alpha |
| CALCRL | | Calcitonin/calcitonin-related polypeptide receptor |
| CALM2 | | calmodulin 2 (phosphorylase kinase, delta) |
| CAMK4 | | calcium/calmodulin-dependent protein kinase IV |
| CAT | | catalase |
| CCK | | cholecystokinin |
| CCKAR | | cholecystokinin A receptor |
| CCKBR | | cholecystokinin B receptor |
| CCL2 | MCP-1 | chemokine (C-C motif) ligand 2 |
| CCL3 | MIP1alpha/ | chemokine (C-C motif) ligand 3 |
| | (GOS19-1) | |
| CCL4 | MIP-1beta | chemokine (C-C motif) ligand 4 |
| CCL5 | RANTES | chemokine (C-C motif) ligand 5 |
| CCR1 | MIP-1-alpha | chemokine (C-C motif) receptor 1 |
| | receptor, | |
| | RANTES | |
| | receptor | |
| CCR2 | MCP-1 | chemokine (C-C motif) receptor 2 |
| | receptor | |
| CCRL2 | | chemokine receptor-like 2 |
| CDK5 | | cyclin-dependent kinase 5, regulatory subunit 1 (p35) |
| CDKN1A | p21, Cip1 | cyclin-dependent kinase inhibitor 1A |
| CHRM1 | | cholinergic receptor, muscarinic 1 |
| CHRM2 | | cholinergic receptor, muscarinic 2 |
| CHRM3 | | cholinergic receptor, muscarinic 3 |
| CHRM4 | | cholinergic receptor, muscarinic 4 |
| CHRM5 | | cholinergic receptor, muscarinic 5 |
| CHRNA4 | | cholinergic receptor, nicotinic, alpha polypeptide 4 |
| CHRNA5 | | cholinergic receptor, nicotinic, alpha 5 |
| CHRNB2 | | cholinergic receptor, nicotinic, beta polypeptide 2 (neuronal) |
| CIAS1 | | cold autoinflammatory syndrome 1 |
| CNR1 | | cannabinoid receptor 1 (brain) |
| CNR2 | | cannabinoid receptor 2 (peripheral) |
| COMT | | catechol-O-methyltransferase |
| CREB1 | | cAMP responsive element binding protein 1 |
| CRH | | corticotropin releasing hormone |
| CRHBP | | corticotropin releasing hormone binding protein |
| CRHR1 | | corticotropin releasing hormone receptor 1 |
| CRHR2 | | corticotropin releasing hormone receptor 2 |
| CRYAA | | crystallin, alpha A |
| CSEN | DREAM | calsenilin, presenilin binding protein, EF-hand transcription |
| | | factor |
| CSNK1A1 | | casein kinase 1, alpha 1 |
| CSNK1E | | casein kinase 1, epsilon |
| CX3CL1 | Fractalkine | chemokine (C—X3—C motif) ligand 1 |
| CX3CR1 | Fractalkine | chemokine (C—X3—C motif) receptor 1 |
| | Receptor | |
| CXCR4 | | chemokine (C—X—C motif), receptor 4 (fusin) |
| CYBB | GP91PHOX, | cytochrome b-245, beta polypeptide (chronic |
| | NOX2 | granulomatous disease) |
| DARPP32 | | protein phosphatase 1, regulatory (inhibitor) subunit 1B |
| | | (dopamine and cAMP regulated phosphoprotein, DARPP- |
| | | 32) |
| DBH | | dopamine beta-hydroxylase (dopamine beta- |
| | | monooxygenase) |
| DBI | | diazepam binding inhibitor (GABA receptor modulator, acyl- |
| | | Coenzyme A binding protein) |
| DDC | | dopa decarboxylase (aromatic L-amino acid decarboxylase) |
| DDX24 | | DEAD/H box polypeptide 24, ATP-dependent RNA helicase |
| DLG4 | PSD-95 | discs, large homolog 4 (Drosophila) |
| DRD1 | | dopamine receptor D1 |
| DRD2 | | dopamine receptor D2 |
| DRD3 | | dopamine receptor D3 |
| DRD4 | | dopamine receptor D4 |
| DRD5 | | dopamine receptor D5 |
| EFNB1 | | ephrin-B1 |
| EFNB2 | | ephrin-B2 |
| EGFR | ERBB1 | epidermal growth factor receptor (erythroblastic leukemia |
| | | viral (v-erb-b) oncogene homolog, avian |
| EGR3 | | early growth response 3 |
| ELOVL3 | fatty acid | elongation of very long chain fatty acids (FEN1/Elo2, |
| | elongase | SUR4/Elo3, yeast)-like 3 |
| EPHB1 | | ephrin EPH receptor B1 |
| EPHB2 | | ephrin EPH receptor B2 |
| EPHB3 | | ephrin EPH receptor B3 |
| EPHB4 | | ephrin EPH receptor B4 |
| EPHB5 | | ephrin EPH receptor B5 |
| EPHB6 | | ephrin EPH receptor B6 |
| EPO | | erythropoietin |
| EPOR | | erythropoietin receptor |
| ERBB2 | NEU; NGL; | v-erb-b2 erythroblastic leukemia viral oncogene homolog 2, |
| | HER2; TKR1; | neuro/glioblastoma derived oncogene homolog (avian) |
| | HER-2; c-erb | |
| | B2; HER- | |
| | 2/neu | |
| ERBB4 | | v-erb-a erythroblastic leukemia viral oncogene homolog 4 |
| | | (avian) |
| EREG | | epiregulin |
| ESR1 | | estrogen receptor 1 (alpha) |
| ESR2 | | estrogen receptor 2 (beta) |
| FAAH | | fatty acid amide hydrolase |
| FACL2 | | fatty-acid-Coenzyme A ligase, long-chain 2 |
| FEV | | FEV (ETS oncogene family) |
| FGF2 | | fibroblast growth factor 2 (basic) |
| FPRL1 | lipoxin A4 | FPRL1 formyl peptide receptor-like 1 |
| | receptor | |
| GABARAPL1 | | GABA(A) receptor-associated protein like 1/early estrogen- |
| | | regulated protein (GEC1) |
| GABBR1 | | gamma-aminobutyric acid (GABA) B receptor, 1 |
| GABBR2 | | gamma-aminobutyric acid (GABA) B receptor, 2 |
| GABRA2 | | gamma-aminobutyric acid (GABA) A receptor, alpha 2 |
| GABRA4 | | gamma-aminobutyric acid (GABA) A receptor, alpha 4 |
| GABRA6 | | gamma-aminobutyric acid (GABA) A receptor, alpha 6 |
| GABRB1 | | gamma-aminobutyric acid (GABA) A receptor, beta 1 |
| GABRB2 | | gamma-aminobutyric acid (GABA) A receptor, beta 2 |
| GABRB3 | | gamma-aminobutyric acid (GABA) A receptor, beta 3 |
| GABRD | | gamma-aminobutyric acid (GABA) A receptor delta |
| GABRG2 | | gamma-aminobutyric acid (GABA) A receptor, gamma 2 |
| GABRG3 | | gamma-aminobutyric acid (GABA) A receptor, gamma 3 |
| GAD1 | | glutamate decarboxylase 1 (brain, 67 kDa) |
| GAD2 | | glutamate decarboxylase 2 (pancreatic islets and brain, |
| | | 65 kDa) |
| GAL | | galanin |
| GALR1 | | galanin receptor 1 |
| GALR2 | | galanin receptor 2 |
| GALR3 | | galanin receptor 3 |
| GBP1 | | guanylate binding protein 1, interferon-inducible, 67 kD |
| GBP2 | | guanylate binding protein 2, interferon-inducible |
| GCH1 | GTPCH1 | GTP cyclohydrolase 1 (dopa-responsive dystonia) |
| GDNF | | glial cell derived neurotrophic factor |
| GLRA1 | | glycine receptor, alpha 1 (startle disease/hyperekplexia, stiff |
| | | man syndrome) |
| GLRA2 | | glycine receptor, alpha 2 |
| GLRB | | glycine receptor, beta |
| GNB2L1 | the receptor | guanine nucleotide binding protein (G protein), beta |
| | for activated | polypeptide 2-like 1 |
| | C kinase | |
| | 1(RACK1) | |
| GNG5 | | guanine nucleotide binding protein (G protein), gamma 5 |
| GPX4 | | glutathione peroxidase 4 (phospholipid hydroperoxidase) |
| GRIA1 | AMPA | glutamate receptor, ionotropic, AMPA 1 |
| | receptor 1 | |
| GRIA2 | AMPA | glutamate receptor, ionotropic, AMPA 2 |
| | receptor 2 | |
| GRIA3 | AMPA | glutamate receptor, ionotropic, AMPA 3 |
| | receptor 3 | |
| GRIA4 | AMPA | glutamate receptor, ionotropic, AMPA 4 |
| | receptor 4 | |
| GRIK1 | | glutamate receptor, ionotropic, kainate 1 |
| GRIN1 | NMDA | glutamate receptor, ionotropic, N-methyl D-aspartate 1 |
| | receptor 1 | |
| GRIN2A | | glutamate receptor, ionotropic, N-methyl D-aspartate 2A |
| GRIN2B | | glutamate receptor, ionotropic, N-methyl D-aspartate 2B |
| GRM1 | | glutamate receptor, metabotropic 1 |
| GRK 4 | | G protein-coupled receptor kinase 4 |
| GRK 5 | | G protein-coupled receptor kinase 5 |
| GRK 6 | | G protein-coupled receptor kinase 6 |
| GRK 7 | | G protein-coupled receptor kinase 7 |
| GSTM1 | | glutathione S-transferase M1 |
| GSTT1 | | glutathione S-transferase theta 1 |
| HIF1A | | HIF1A, alpha subunit |
| HN1 | | Humanin (HN1), mitochondial |
| hnRNP G | Glycoprotein | RNA binding motif protein (RBMX, hnRNP-G), |
| | P43 | Heterogeneous nuclear ribonucleoprotein G |
| HNRPD | | heterogeneous nuclear ribonucleoprotein D (AU-rich |
| | | element RNA binding protein 1, 37 kD) |
| HNRPU | | heterogeneous nuclear ribonucleoprotein U (scaffold |
| | | attachment factor A |
| HSPA8 | | heat shock 70 kD protein 8 (HSPA8) |
| HSPA9B | | heat shock 70 kD protein 9B (mortalin-2) (HSPA9B) |
| HSPCA | | heat shock 90 kD protein 1, alpha) |
| HSPCB | | heat shock 90 kD protein 1, beta |
| HTR2B | | 5-hydroxytryptamine (serotonin) receptor 2B |
| IFI30 | | interferon, gamma-inducible protein 30 |
| IFNG | | interferon, gamma |
| IFRD1 | | interferon-related developmental regulator 1 |
| IGF1 | | insulin-like growth factor 1 (somatomedin C) |
| IKBKB | IKK-beta | inhibitor of kappa light polypeptide gene enhancer in B- |
| | | cells, kinase beta |
| IL10 | | interleukine 10 |
| IL13 | | interleukine 13 |
| IL-1alpha | | interleukine 1 alpha |
| IL-1beta | | interleukine 1 beta |
| IL1RN | | interleukin 1 receptor antagonist |
| IL1RN | | interleukin 1 receptor antogonist |
| IL-2 | | interleukine 2 |
| IL-4 | | interleukine 4 |
| IL-6 | | interleukine 6 |
| IL8 | | interleukine 8 |
| INADL | channel- | InaD-like (Drosophila) |
| | interacting | |
| | PDZ domain | |
| | protein | |
| INSIG1 | | insulin induced protein 1 |
| IRAP | | secreted interleukin 1 receptor antagonist |
| ITGAM | OX42 | integrin, alpha M (complement component receptor 3, |
| | | alpha; also known as CD11b (p170), macrophage antigen |
| | | alpha polypeptide) |
| KCNA2 | Kv1.2 | potassium voltage-gated channel, shaker-related |
| | | subfamily, member 2 |
| KCNJ11 | Kir6.2 | potassium inwardly-rectifying channel, subfamily J, member |
| | | 11 |
| KCNJ3 | Kir3.1 | potassium inwardly-rectifying channel, subfamily J, member 3 |
| KCNJ5 | Kir3.4 | potassium inwardly-rectifying channel, subfamily J, member 5 |
| KCNJ6 | Kir3.2 | potassium inwardly-rectifying channel, subfamily J, member 6 |
| KCNJ8 | Kir6.1 | potassium inwardly-rectifying channel, subfamily J, member 8 |
| KCNJ9 | Kir3.3 | potassium inwardly-rectifying channel, subfamily J, member 9 |
| KCNK2 | TREK-1 | potassium channel, subfamily K, member 2 |
| KCTD17 | | potassium channel tetramerisation domain containing 17 |
| KPNB1 | | karyopherin (importin) beta 1 |
| LIPL3 | | lipase-like, ab-hydrolase domain containing 3 |
| MAO-A | | monoamine oxidase A |
| MAO-B | | monoamine oxidase B |
| MAP2K1IP1 | | mitogen-activated protein kinase kinase 1 interacting |
| | | protein 1 (MAP2K1IP1) |
| MAP3K1 | | MAP kinase kinase kinase 1 (Mekk1) |
| MAPK1 | ERK2 | mitogen-activated protein kinase 1 |
| MAPK11 | p38beta | p38beta |
| MAPK13 | p38delta | p38delta |
| MAPK14 | p38alpha | p38 alpha |
| MAPK3 | ERK1 | mitogen-activated protein kinase 3 |
| MC1R | | melanocortin 1 receptor (alpha melanocyte stimulating |
| | | hormone receptor) |
| MC4R | | melanocortin 4 receptor (alpha melanocyte stimulating |
| | | hormone receptor) |
| MFN1 | | mitofusin 1 |
| MFN2 | | Mitofusin 2 |
| MPDZ | | multiple PDZ domain protein |
| MPO | | myeloperoxidase |
| MSN | | moesin |
| MTMR6 | | myotubularin related protein 6 |
| NAB1 | | NGFI-A binding protein 1 (EGR1 binding protein) |
| NFKBIA | alphaIkBa | nuclear factor of kappa light polypeptide gene enhancer in |
| | | B-cells inhibitor |
| NFKBIZ | zetalkappaB- | nuclear factor of kappa light polypeptide gene enhancer in |
| | zeta | B-cells inhibitor |
| NGF | | nerve growth factor, beta polypeptide |
| NOS1 | | nitric oxide synthase 1 (neuronal) |
| NOS2A | | nitric oxide synthase 2A (inducible, hepatocytes) |
| NOS3 | | nitric oxide synthase 3 (endothelial cell) |
| NPY | | neuropeptide Y |
| NPY1R | | neuropeptide Y receptor Y1 |
| NPY2R | | neuropeptide Y receptor Y2 |
| NPY5R | | neuropeptide Y receptor Y5 |
| NQO1 | | NAD(P)H dehydrogenase, quinone 1 |
| NR3C1 | glucocorticoid | nuclear receptor subfamily 3, group C, member 1 |
| | receptor | |
| NR4A1 | | TR3 orphan receptor NR4A1 |
| NR4A2 | | NGFI-B/nur77 beta homolog |
| NR4A3 | | mitogen induced nuclear orphan receptor (MINOR) |
| NRG1 | ErbB | neuregulin 1 |
| NTRK1 | TrkA | neurotrophic tyrosine kinase, receptor, type 1 |
| NTRK2 | TrkB | neurotrophic tyrosine kinase, receptor, type 2 |
| NTSR1 | | neurotensin receptor 1 |
| NTSR2 | | neurotensin receptor 2 |
| OBLR | | opiate receptor-like 1 |
| OLR1 | | oxidised low density lipoprotein receptor 1 |
| OPRD1 | | opioid receptor, delta 1 |
| OPRK1 | | opioid receptor, kappa 1 |
| OPRM1 | | opioid receptor, mu 1 |
| OXT | | oxytocin, prepro-(neurophysin I) |
| P2RX2 | | purinergic receptor P2X, ligand-gated ion channel, 2 |
| P2RX3 | | purinergic receptor P2X, ligand-gated ion channel, 3 |
| P2RX4 | | purinergic receptor P2X, ligand-gated ion channel, 4 |
| P2RX7 | | purinergic receptor P2X, ligand-gated ion channel, 7 |
| P2RY1 | | purinergic receptor P2Y, G-protein coupled, 1 |
| P2RY12 | | purinergic receptor P2Y, G-protein coupled, 12 |
| P2RY13 | | purinergic receptor P2Y, G-protein coupled, 13 |
| P2RY2 | | purinergic receptor P2Y, G-protein coupled, 2 |
| P2RY4 | | purinergic receptor P2Y, G-protein coupled, 4 |
| P2RY6 | | purinergic receptor P2Y, G-protein coupled, 6 |
| PACSIN1 | | Protein kinase C and casein kinase substrate in neurons 1 |
| PBEF | | pre-B-cell colony-enhancing factor |
| PDGFA | | platelet-derived growth factor alpha polypeptide |
| PDGFB | | platelet-derived growth factor beta polypeptide (simian |
| | | sarcoma viral (v-sis) oncogene homolog) |
| PENK | | proenkephalin |
| PLA2G4A | cPLA2-alpha | phospholipase A2, group IVA (cytosolic, calcium- |
| | | dependent) |
| PLA2G4B | cPLA2-beta | phospholipase A2, group IVB (cytosolic) |
| PLAUR | | plasminogen activator, urokinase receptor |
| PNMT | | phenylethanolamine N-methyltransferase |
| PNOC | orphanin FQ | prepronociceptin |
| PNYD | | prodynorphin |
| POMC | | proopiomelanocortin (adrenocorticotropin/beta-lipotropin/ |
| | | alpha-melanocyte stimulating hormone/beta-melanocyte |
| | | stimulating hormone/beta-endorphin) |
| PPP3CA | | protein phosphatase 3 (formerly 2B), catalytic subunit, |
| | | alpha isoform (calcineurin A alpha) |
| PPP3CB | | protein phosphatase 3 (formerly 2B), catalytic subunit, beta |
| | | isoform (calcineurin A beta) |
| PPP3R1 | | protein phosphatase 3 (formerly 2B), regulatory subunit B, |
| | | 19 kDa, alpha isoform (calcineurin B, type I) |
| PPP3R2 | | protein phosphatase 3 (formerly 2B), regulatory subunit B, |
| | | 19 kDa, beta isoform (calcineurin B, type II) |
| PRKACA | PKA | protein kinase, cAMP-dependent, catalytic, alpha |
| PRKACB | PKA | protein kinase, cAMP-dependent, catalytic, beta |
| PRKCABP | | protein kinase C, alpha binding protein |
| PRKCE | | protein kinase C, epsilon |
| PRKD3 | protein | protein kinase C, D3 |
| | kinase C, nu | |
| PTGER1 | | prostaglandin E receptor 1 (subtype EP1) |
| PTGER2 | | prostaglandin E receptor 2 (subtype EP2) |
| PTGER3 | | prostaglandin E receptor 3 (subtype EP3) |
| PTGER4 | | prostaglandin E receptor 4 (subtype EP4) |
| PTGS1 | COX1-COX3 | prostaglandin-endoperoxide synthase 1 (prostaglandin G/H |
| | | synthase and cyclooxygenase) |
| PTGS2 | COX2 | prostaglandin-endoperoxide synthase 2 (prostaglandin G/H |
| | | synthase and cyclooxygenase) |
| RAB20 | | RAB20, member RAS oncogene family |
| Rab5 | | Rab5 GDP/GTP exchange factor homologue |
| RAB8B | | RAB8B, member RAS oncogene family |
| RBMX | hnRNP-G | |
| RGS2 | | regulator of G-protein signalling 2 |
| RGS4 | | regulator of G-protein signalling 4 |
| S100A12 | | S100 calcium binding protein A12 (calgranulin C) |
| S100A3 | | S100 calcium binding protein A3 |
| S100B | | S100 calcium binding protein, beta (neural) |
| SAMSN1 | | SAM domain, SH3 domain and nuclear localisation signals, 1 |
| SAT | | spermidine/spermine N1-acetyltransferase (SAT) |
| SC5DL | Δ-5 | sterol-C5-desaturase (ERG3 delta-5-desaturase homolog, |
| | desaturase | fungal)-like |
| SCD | Δ-9 | stearoyl-CoA desaturase (delta-9-desaturase) |
| | desaturase | |
| SCN10A | | sodium channel, voltage-gated, type X, alpha |
| SCN11A | | sodium channel, voltage-gated, type XI, alpha |
| SCN1A | | sodium channel, voltage-gated, type I, alpha |
| SCN2A1 | | sodium channel, voltage-gated, type II, alpha 1 |
| SCN3A | | sodium channel, voltage-gated, type III, alpha |
| SCN5A | | sodium channel, voltage-gated, type V, alpha (long QT |
| | | syndrome 3) |
| SCN8A | | sodium channel, voltage gated, type VIII, alpha |
| SCN9A | | sodium channel, voltage-gated, type IX, alpha |
| SET | | SET translocation (myeloid leukemia-associated) |
| SGK | | serum/glucocorticoid regulated kinase |
| SGKL | | serum/glucocorticoid regulated kinase-like |
| SLC18A2 | | solute carrier family 18 (vesicular monoamine), member 2 |
| SLC29A1 | | solute carrier family 29 (nucleoside transporters), member 1 |
| SLC32A1 | | vesicular inhibitory amino acid transporter (solute carrier |
| | | family 32 (GABA vesicular transporter) |
| SLC6A11 | | solute carrier family 6 (neurotransmitter transporter, GABA), |
| | | member 11 |
| SLC6A13 | | solute carrier family 6 (neurotransmitter transporter, GABA), |
| | | member 13 |
| SLC6A2 | | solute carrier family 6 (neurotransmitter transporter, |
| | | noradrenalin), member 2 |
| SLC6A3 | | solute carrier family 6 (neurotransmitter transporter, |
| | | dopamine), member 3 |
| SLC6A4 | | solute carrier family 6 (neurotransmitter transporter, |
| | | serotonin), member 4 |
| SMN1 | | survival of motor neuron 1, telomeric |
| SOD2 | | superoxide dismutase 2, mitochondrial |
| TAC1 | | tachykinin, precursor 1 (substance K, substance P, |
| | | neurokinin 1, neurokinin 2, neuromedin L, neurokinin alpha, |
| | | neuropeptide K, neuropeptide gamma) |
| TACR1 | NK-1 | tachykinin receptor 1 (substance P receptor; neurokinin-1 |
| | receptor | receptor) |
| TCIRG1 | | ATPase, H+ transporting, lysosomal V0 protein a isoform 3, |
| | | T-cell, immune regulator 1 |
| TGFBI | | transforming growth factor, beta-induced, 68 kD |
| TH | | tyrosine hydroxylase |
| THBD | | thrombomodulin |
| THBS1 | | thrombospondin |
| TIEG | | TGFB inducible early growth response |
| TIMP1 | | tissue inhibitor of metalloproteinase 1 |
| TLR4 | | toll-like receptor 4 |
| TMSB10 | | thymosin, beta 10 |
| TMSB4X | | thymosin, beta 4, X chromosome |
| TNF | | tumor necrosis factor (TNF superfamily, member 2) |
| TNFAIP3 | A20 | tumor necrosis factor, alpha-induced protein 3 |
| TPH2 | | tryptophan hydroxylase 2 (is the rate-limiting enzyme in the |
| | | synthesis of serotonin) |
| TRPM8 | | transient receptor potential cation channel, subfamily M, |
| | | member 8 |
| TRPV1 | | transient receptor potential cation channel, subfamily V, |
| | | member 1 |
| TRPV2 | | transient receptor potential cation channel, subfamily V, |
| | | member 2 |
| TRPV3 | | transient receptor potential cation channel, subfamily V, |
| | | member 3 |
| UBE2G2 | | ubiquitin-conjugating enzyme E2G 2 (UBC7 homolog, |
| | | yeast) (UBE2G2) |
| VEGF | | vascular endothelial growth factor |
| VIL2 | ezrin | villin 2 |
| VPS4A | | vacuolar protein sorting 4A (yeast) |
| VPS4B | | vacuolar protein sorting 4B (yeast) |
| XDH | | xanthine dehydrogenase |
| YWHAZ | | tyrosine 3-monooxygenase/tryptophan 5-monooxygenase |
| | | activation protein, zeta polypeptide |
| ZA20D2 | ZNF216 | zinc finger, A20 domain containing 2 |
| ZA20D3 | protein | zinc finger, A20 domain containing 3 |
| | associated | |
| | with | |
| | PRK1(AWP1) | |
| ZNF265 | | zinc finger protein 265 |

TABLE 5
EXEMPLARY SNPs FROM GENES ASSOCIATED WITH
SOMATOSENSORY DISORDERS

| | |
|---|---|
| HTR1A | rs1800045, rs6294, rs878567 |
| HTR1B | rs11568817, rs130058, rs6298, rs6297 |
| HTR2A | rs1058576, rs1923882, rs2296972, rs2770296, rs4142900, rs4941573, |
| | rs6314, rs6561333, rs9316233, rs17068986, rs927544, rs6310, rs6312, |
| | rs977003, rs1805055 |
| HTR2B | rs7604219, rs17619588, rs10194776, rs1549339, rs17586428, rs3806545, |
| | rs6437000, rs4973377 |
| HTR2C | rs3813928, rs3813929, rs2497551, rs2228669, rs6318, rs11798698, |
| | rs12838742, rs2497510, rs2497515, rs2497529, rs475717, rs498177, |
| | rs508865, rs5987817, rs6643915, rs4911878, rs1801412 |
| HTR3A | rs897692, rs1176752, rs1150226, rs2276302, rs3737457, rs1176713, |
| | rs1150219 |
| HTR3B | rs3758987, rs10502180, rs12421126, rs7103572, rs1176744, rs2276305, |
| | rs17116138, rs1176739, rs1176761, rs4936285, rs3782025 |
| ABCB1 | rs17064, rs2235051, rs1045642, rs1882477, rs2032582, rs2229109, |
| | rs9282564, rs3213619, rs2188524, rs4148727, rs10261685 |
| ACCN1 | rs28903, rs28935, rs16567, rs1988598, rs7503296, rs4795742, rs4289044, |
| | rs16968020, rs11657055, rs4133924, rs7214319, rs319773, rs8069909, |
| | rs394886, rs368365, rs4795754, rs1002317, rs1497366, rs731601, |
| | rs7214382, rs2228990, rs2228989, rs2097761, rs28932, |
| | rs11080233 |
| ACCN2 | rs590460, rs653576, rs10875995, rs706793, rs2307082 |
| ACCN3 | rs2303928, rs11977275, rs2288646 |
| ACCN4 | rs907676, rs3731909, rs746233, rs1467116, rs2276642, rs2276643, |
| | rs1043833 |
| ACE | rs4292, rs17236660, rs4303, rs4309, rs12709426, rs4318, rs4343, rs4362, |
| | rs4364, rs4461142, rs4459610, rs8066276, rs12451328, rs4968591, rs4365, |
| | rs3730025, rs4302, rs12720746, rs4316, rs4331 |
| ACE2 | rs4830542, rs4646179, rs1514280, rs4646146, rs971249, rs4646115, |
| | rs4646112, rs4646116 |
| ADCY7 | rs9926131, rs1064448, rs1872688, rs1872691, rs2302679, rs2302717, |
| | rs3760013, rs3815562, rs4611457, rs4785210, rs4785400, rs729229, |
| | rs9936021, rs9939322 |
| ADORA1 | rs2364571, rs6702345, rs1494490, rs11582098, rs722915, rs1874142, |
| | rs10920570, rs3766566, rs3766563, rs3766560, rs3766557, rs10920576, |
| | rs3753472, rs10920568, rs12744240 |
| ADORA2A | rs3761423, rs2236624, rs2267076, rs2779193, rs2228101, rs2535609, |
| | rs2324082 |
| ADORA3 | rs2275797, rs2229155, rs10776727, rs923, rs7737, rs9025, rs1415793, |
| | rs10776733, rs4839145, rs12142663, rs6686510, rs1337912 |
| ADRA1A | rs10089254, rs1079078, rs11991324, rs13261054, rs13270252, rs13281802, |
| | rs1353446, rs1383914, rs1496126, rs17426222, rs1874425, rs2036107, |
| | rs2229124, rs2229125, rs2291776, rs4732880, rs498246, rs511662, |
| | rs523851, rs536220, rs556793, rs6989854, rs7835853, rs7842829 |
| ADRA1B | rs10070745, rs10214093, rs10214211, rs11739589, rs13171967, rs2229181, |
| | rs3729604, rs4921241, rs6884129, rs6892282, rs752266, rs756275, |
| | rs7728708, rs7734327 |
| ADRA1D | rs1556832, rs3787441, rs3803964, rs3810568, rs6052456, rs709024, |
| | rs734290, rs835873, rs835880, rs835882, rs946188 |
| ADRA2A | rs1800763, rs1800544, rs1800035, rs1800036, rs1800038, rs553668, |
| | rs3750625, rs521674 |
| ADRA2B | rs9333567, rs2229169, rs4066772, rs2252697, rs4426564 |
| ADRA2C | rs7692883, rs9790376, rs13112010, rs7696139, rs7434444, rs7678463 |
| ADRB2 | rs879096, rs1432622, rs2400707, rs1042713, rs1042714, rs1042717, |
| | rs3729943, rs3857420, rs17108817, rs1042718, rs1800888, rs1042719, |
| | rs3777124, rs1042711, rs1801704 |
| ADRB3 | rs4998, rs2071493, rs4997, rs4994, rs3901185, rs34659602, rs35361594 |
| ADRBK2 | rs5761122, rs6004701, rs2283811, rs5752108, rs1008673, rs909695, |
| | rs9941944, rs11913984, rs7292634, rs718163, rs1344079, rs5761159, |
| | rs9608416, rs12627968, rs9624896 |
| AGT1 | rs7079, rs7080, rs11568041, rs699, rs4762, rs11568052, rs11568029, |
| | rs2148582, rs5049, rs5046, rs2478522, rs5052 |
| AGTR1 | rs1492078, rs10935724, rs3772616, rs3772608, rs5182, rs5183, rs2638360, |
| | rs380400, rs2675511, rs10513337, rs12721225 |
| AGTR2 | rs12710567, rs1403543, rs3736556, rs5193, rs5194, rs17237820 |
| AKR1B10 | rs10263433, rs2037004, rs1722883, rs706160, rs4732036, rs4728329, |
| | rs706150, rs6467538, rs12668047 |
| ANXA1 | rs2795108, rs2795114, rs1342018, rs4301502, rs10869229, rs1050305 |
| | rs3739959 |
| ANXA2 | rs7170421, rs7163836, rs1551347, rs3759911, rs3743268, rs2100432, |
| | rs1454102 |
| AP1G1 | rs904763, rs12598902 |
| APP | rs1059461, rs2829966, rs2829979, rs214482, rs440666, rs1701004, |
| | rs3787639, rs2830012, rs2070655, rs2830041, rs2234988, rs2830071, |
| | rs2830097, rs466448 |
| ARL5B | rs2130531, rs10741127, rs6482597, rs1055114 |
| ARRB1 | rs528833, rs1676890, rs667791, rs490528, rs506233, rs472112, rs7127461, |
| | rs616714, rs569796, rs12274033 |
| ARRB2 | rs9905578, rs3786047, rs7208257, rs4522461, rs1045280 |
| ATF1 | rs11169552, rs3742065, rs10783389, rs1129406, rs2230674, rs829125 |
| ATF3 | rs1195474, rs3806460, rs1976657, rs3125296, rs10735510, rs8192658, |
| | rs1126526, rs11119989 |
| ATP1A1 | rs12079419, rs1407717, rs850602, rs12079419, rs12085796, rs7547948, |
| | rs850610 |
| ATP1A2 | rs3761685, rs1016732, rs2854248, rs6686067, rs10494336, rs1046995 |
| ATP1B3 | rs10935442, rs16846285, rs2060014, rs1897139, rs1072982,, s6440047, |
| | rs6440049, rs6782694, rs3804772, rs13327276 |
| ATP2B1 | rs10506974, rs2854371, rs3741895, rs17381194, rs11105345, rs2681491, |
| | rs1050395, rs11105356, rs11105358, rs10858915 |
| ATP6V1A | rs1048892, rs9811353, rs1043132, rs12736 |
| ATP6V1B2 | rs2410633, rs1042426 |
| BDKRB1 | rs2069613, rs4905475, rs10143977, rs2071084, rs11625494 |
| BDKRB2 | rs1799722, rs5223, rs8016905, rs4900312, rs945039, rs11847625, |
| | rs4905470, rs4905474, rs2069575, rs1046248, rs2069582, rs885820, rs5224, |
| | rs2227279, rs3809418 |
| BDNF | rs908867, rs12273363, rs11030121, rs2049046, rs7103411, rs1048220, |
| | rs1048221, rs1048218, rs6265, rs7124442, rs4923463, rs1401635 |
| BTG2 | rs17534202, rs4971234, rs6682806, rs12085417 |
| CACNA1A | rs2419233, rs1865033, rs3816027, rs10421681, rs4926240, rs8103699, |
| | rs2074879, rs7251403, rs16030, rs10423506, rs16018, rs2419248, |
| | rs4926278, rs4461194, rs8109003, rs4926285, rs4926286, rs1862262, |
| | rs1422256, rs1978431, rs16029, rs16027, rs16025, rs16022, rs16016, |
| | rs16012, rs16009, rs2248069, rs16006, rs17639705 |
| CACNA2D1 | rs1229502, rs3735517, rs37067, rs1229506, rs37089, rs7797314, rs1011696, |
| | rs7341478, rs10486946, rs3823920, rs3801742, rs3801734, rs10486948, |
| | rs2057894, rs2367912, rs11978472, rs38557, rs3757631, rs929416, rs42051, |
| | rs7794797, rs724118, rs2237528, rs2237528, rs2007111, rs6975647, |
| | rs6967334, rs10486960, rs17155680, rs10226282 |
| CACNA2D2 | rs2071801, rs2239801, rs2071803, rs2269568, rs2236953, rs762897, |
| | rs2282752, rs2282754, rs2236956, rs2282755, rs2236964, rs743755, |
| | rs2236969, rs2236977, rs2236989, rs736471, rs1467913, rs6807916, |
| | rs9814874, rs752183, rs3806706 |
| CALCA | rs2956, rs5241, rs5239, rs155300 |
| CALCRL | rs10179705, rs10203398, rs3771083, rs3771095, rs696092, rs858745, |
| | rs17464221, rs860859 |
| CALM2 | rs17036320, rs1027478, rs815802, rs815815, rs1723482, rs169386 |
| CAMK2A | rs2240793, rs957709, rs2217641, rs2241694, rs2241695, rs919741, |
| | rs3776825, rs3756577, rs10463293, rs13357922, rs10515639, rs919740, |
| | rs873593, rs3806947 |
| CAMK2B | rs7810158, rs2075076, rs11542228, rs17172630, rs4526269, rs12702072, |
| | rs4642534, rs4724298, rs10224124, rs4724299, rs12702079, rs4410809, |
| | rs6962696 |
| CAMK4 | rs919334, rs2290679, rs7704970, rs6875225, rs2434722, rs7707264, |
| | rs2288397, rs216535, rs10500205, rs306083, rs435021, rs306076, |
| | rs1644501, rs1644498, rs376880, rs960452, rs3756612, rs467422, rs306098, |
| | rs306090, rs3797746, rs10491334, rs3797739, rs25923, rs251007, rs25925, |
| | rs31309, rs1469442, rs402420, rs306124, rs2300782 |
| CAT | rs12807961, rs1049982, rs564250, rs494024, rs480575, rs2300181, |
| | rs17881192, rs554576, rs511895, rs7104301 |
| CCK | rs935112, rs10460960, rs11571842, rs754635, rs10865918, rs8192473, |
| | rs20291 |
| CCKAR | rs1800856, rs3822222, rs2000978, rs2725301, rs10016465, rs7665027 |
| CCKBR | rs4349588, rs906895, rs3793993, rs2947027, rs1805002, rs1042 |
| CCL2 | rs11575011, rs4586, rs1080327, rs13900 |
| CCL3 | rs8075808, rs1130371, rs1634499, rs1049131, rs1049121, rs1049114 |
| CCL4 | rs1719140, rs1049750, rs1049807, rs9635771, rs1130750 |
| CCL5 | rs3817655, rs2280788, rs2107538, rs4796123 |
| CCR1 | rs3181080, rs1491961, rs3136667, rs31769 |
| CCR2 | rs3918372, rs1799864, rs1799865, rs3918367, rs743660 |
| CCRL2 | rs11574433, rs11574440, rs11574442, rs11574443, rs6441977, rs3204850, |
| | rs1140865 |
| CDK5 | rs756785, rs735555, rs8192474 |
| CDKN1A | rs2395655, rs3176319, rs4986866, rs4986868, rs1801270, rs4986867, |
| | rs3176358 |
| CHRM1 | rs12295208, rs542269 |
| CHRM2 | rs2067477, rs6957496, rs1424569, rs4475425, rs2278071, rs7800170, |
| | rs1824024, rs324586, rs324587, rs2350786, rs324637, rs324651, rs8191992, |
| | rs11773032 |
| CHRM3 | rs7529470, rs6657343, rs685960, rs621060, rs650751 |
| CHRM4 | rs2067482, rs2229163, rs16938505 |
| CHRM5 | rs661968, rs9806373, rs8030094, rs513706, rs499167, rs2279423 |
| CHRNA4 | rs3787138, rs6011776, rs755204, rs755203, rs1044397, rs1044396, |
| | rs1044393 |
| CHRNA5 | rs684513, rs667282, rs17486278, rs680244, rs692780, rs16969968, |
| | rs615470, rs660652 |
| CHRNB2 | rs4845651, rs4845652, rs3008433, rs2072659, rs3926124 |
| CHUK | rs11597086, rs3818411, rs7903344, rs12251292, rs12762869 |
| CIAS1 | rs3738448, rs10754555, rs3806268, rs12564791, rs1539019, rs7525979, |
| | rs4925543, rs10157379, rs10754558, rs10802501 |
| CNR1 | rs1049353, rs806375, rs806378, rs806381, rs6454674, rs6454676, |
| | rs9344757, rs12720071, rs806368 |
| CNR2 | rs2229580, rs2229579, rs2502993, rs9424339, rs2502967, rs2501397 |
| COMT | rs165599, rs2020917, rs2097603, rs4633, rs4680, rs4818, rs5993883, |
| | rs6267, rs6269, rs737865, rs739368, rs740602, rs9332381, rs11569716, |
| | rs362204, rs1544325, rs165774, rs174697, rs2239393 |
| CPN1 | rs11599750, rs11594585, rs2862925, rs3750717, rs3829161, rs12775433, |
| | rs10883439, rs7921462 |
| CREB1 | rs2253206, rs2551640, rs2709359, rs2059336, rs10932201, rs2551922, |
| | rs2551928, rs6785 |
| CRH | rs28364017, rs3176921, rs6472257 |
| CRHBP | rs3792738, rs32897, rs6453267, rs7718461, rs1053989, rs1875999 |
| CRHR1 | rs12942300, rs7209436, rs4792887, rs17689378, rs12936511, rs242924, |
| | rs16940655, rs81189, rs16940665, rs16940674, rs16940681 |
| CRHR2 | rs2240403, rs973002, rs2190242, rs2251002, rs2284217, rs2267717, |
| | rs2284220, rs255097, rs255125 |
| CRYAA | rs3761381, rs872331, rs3788061 |
| CSEN | rs1559483, rs3772038, rs2113418, rs3772031, rs869185, rs6730587 |
| CSNK1A1 | rs10057083, rs10036211, rs3733847, rs1947582, rs10058728, |
| | rs12163992, rs12108750, rs7719315, rs6883553, rs2279019, rs10075658, |
| | rs13184089 |
| CSNK1E | rs135750, rs1534891, rs6001090, rs6001093, rs135757, rs1997644, |
| | rs7289981, rs5995570, rs7289395, rs13054361 |
| CX3CL1 | rs223815, rs668100, rs170364, rs4151117, rs8323, rs3732378, rs3732379, |
| | rs9862876, rs2669844, rs2853707 |
| CXCR4 | rs2228014, rs17848057, rs17848385, rs99734 |
| CYBB | rs6610650, rs17146226, rs5917471, rs5964125, rs12848910 |
| CYP2C9 | rs9332103, rs1799853, rs7900194, rs4086116, rs2256871, rs2475376, |
| | rs4917639, rs1934963, rs1057910, rs9332242 |
| CYP2D6 | rs1058172, rs3915951, rs1058170, rs17002853, rs11568728, rs1058164, |
| | rs769258, rs28360521, rs17002852, rs742086 |
| CYP2E1 | rs3813865, rs3813867, rs915906, rs6413419, rs743535, rs2515642, |
| | rs2515641, rs9622778, rs3890379, rs11445593, rs2515641 |
| CYPSA4 | rs2687103, rs1851426, rs2740574, rs2738258, rs2687117, rs2242480, |
| | rs17161886 |
| DARPP32 | rs9532, rs734645, rs16965199, rs1495099, rs879606 |
| DBH | rs1076152, rs2797849, rs3025388, rs1108581, rs5320, rs4531, rs2519154, |
| | rs77905, rs2097629, rs2073833, rs1611131, rs129882, rs13306304 |
| DBI | rs3795890, rs3091405, rs3091406, rs8192503, rs8192506, rs2289948, |
| | rs12613135, rs2084202, rs8192503, rs8192506, rs1050698, rs2289948 |
| DDC | rs4947510, rs11575542, rs730092, rs4490786, rs1349492, rs2122822, |
| | rs880028, rs6263, rs6262, rs10244632, rs2329341, rs3829897, rs3837091, |
| | rs12666409 |
| DDX24 | rs4905149, rs1056810, rs3748328, rs3790043, rs8006174 |
| DLG4 (PSD-95) | rs2017365, rs390200, rs17203281, rs2242449 |
| DPP4 | rs2909443, rs12617336, rs2268894, rs1014444, rs2302872, rs2300755, |
| | rs2111850, rs3788979, rs6741949, rs6733162, rs12469968, rs17574, |
| | rs2075302 |
| DRD1 | rs4867798, rs686, rs5326, rs2168631, rs155417 |
| DRD2 | rs6279, rs9282673, rs1801028, rs6277, rs1800499, rs6275, rs4986918, |
| | rs2075652, rs1076563, rs1079596, rs7103679, rs4586205, rs4648318, |
| | rs4274224, rs4581480, rs1799978 |
| DRD3 | rs3732790, rs9824856, rs2134655, rs9288993, rs963468, rs3773678, |
| | rs2630349, rs167770, rs324029, rs10934256, rs3732783, rs6280, rs324026, |
| | rs9825563 |
| DRD4 | rs916457, rs3758653, rs4646983, rs762502, rs11246226 |
| DRD5 | rs10033951, rs2227840, rs2227839, rs2227841, rs2227845, rs2227843, |
| | rs2227852, rs16888561, rs1800762, rs1967550 |
| EFNB1 | rs1155215, rs421069, rs877617, rs7885471, rs688969 |
| EFNB2 | rs7322914, rs9520087, rs4399422, rs9301140, rs7983579, rs8001826, |
| | rs2391333, rs2893262, rs8000078, rs3809348, rs9301143 |
| EGFR | rs12674036, rs759171, rs4947963, rs763317, rs12668421, rs1558542, |
| | rs17172432, rs10244108, rs759170, rs3735061, rs2330951, rs6593206, |
| | rs10488141, rs2072454, rs2075112, rs11543848, rs12538371, rs2241054, |
| | rs845552, rs10251977, rs2075102, rs17518376, rs2740762, rs1140475, |
| | rs2293347, rs17172455, rs884225 |
| EGR3 | rs1996147, rs3750192, rs1533307, rs1008949 |
| ELOVL3 | rs7083450, rs1410416, rs2281983 |
| EPHB1 | rs17763226, rs7644369, rs3732566, rs3182239, rs6786165 |
| EPHB2 | rs294218, rs294231, rs2869513, rs12732926, rs1318720, rs876685, |
| | rs893964, rs4654814, rs7516175, rs2817907, rs2817900, rs16827538, |
| | rs7530478, rs2869511, rs751022, rs10917314, rs4654821, rs10917318, |
| | rs4655130, rs4654824, rs6426770, rs2138542, rs10158095, rs116119, |
| | rs2675494, rs309499, rs309492 |
| EPHB3 | rs7653075, rs12489076, rs4132006, rs9862375, rs7652033, rs7652280 |
| EPHB4 | rs314346, rs2230585, rs144173, rs314313, rs2247445 |
| EPHB6 | rs8177146, rs6464535, rs4987685, rs7789303, rs8177100, rs1009848, |
| | rs8177141 |
| EPO | rs1617640, rs551238 |
| EPOR | rs318717, rs318720, rs431144 |
| ERBB2 | rs2517956, rs4252599, rs1565923, rs1810132, rs4252634, rs1801200, |
| | rs1058808, rs9896218 |
| ERBB4 | rs3748960, rs3748962, rs3791699, rs10497944, rs17804031, rs4131610, |
| | rs10192302, rs7602850, rs6435660, rs13035133, rs13390226, rs12464239, |
| | rs17416172, rs12995889, rs10207020, rs10173511, rs9288452, rs1394785, |
| | rs972488, rs7556832, rs1384292 |
| EREG | rs1563826, rs6837909, rs2367707, rs7687621, rs1542466 |
| ESR1 | rs488133, rs9340771, rs2077647, rs746432, rs17847065, rs9340784, |
| | rs6926750, rs9340802, rs9340820, rs1514348, rs1709183, rs9340835, |
| | rs7761846, rs4869748, rs6557171, rs12154178, rs6912184, rs1801132, |
| | rs3020377, rs7383754, rs726281, rs3020407, rs9340954, rs2207231, |
| | rs3020422, rs9371573, rs3020368, rs2207396, rs3798575, rs3020382, |
| | rs9341069, rs2228480, rs3798577 |
| ESR2 | rs1256061, rs944461, rs8017441, rs1256054, rs1256049, rs1256044, |
| | rs7154455, rs1256030, rs3783736, rs17179740, rs1271572, rs8004842, |
| | rs10483774, rs3020450, rs10137185, rs17101774, rs17226081, rs1256120, |
| | rs12435395 |
| ETV1 | rs41505, rs17739403, rs5882426, rs10215655, rs3801101, rs9639168, |
| | rs6969848, rs2237292, rs3823702, rs9785000 |
| FAAH | rs913168, rs932816, rs6703669, rs3766246, rs324420, rs324419, rs2295633, |
| | rs12029329 |
| FACL2 (ACSL1) | rs1058896, rs8086, rs2292898, rs3792311, rs1803898, rs7681334, |
| | rs3806795, r813112568, rs9997745, rs12503643, rs10027540 |
| FGF2 | rs308395, rs1449683, rs11938826, rs308442, rs308379, rs6534365, |
| | rs308388, rs1476214, rs3804158 |
| FMR1 | rs1805420, rs4949, rs25727, rs25707, rs25714, rs25702, rs25704, |
| | rs6626284, rs28900 |
| FOS | rs2239615, rs7101, rs1046117 |
| FPRL1 | rs11666254, rs4801893, rs10853843, rs17834679, rs17695052 |
| GABARAPL1 | rs4322502, rs4326886, rs11539, rs7248 |
| GABBR1 | rs2267633, rs740884, rs29230, rs2076489, rs29253, rs29225, rs29243 |
| GABBR2 | rs1044637, rs2304391, rs10985765, rs2304389, rs3780446, rs3780445, |
| | rs3205936, rs7020345, rs10986125, rs2808536, rs3750344, rs2779535, |
| | rs2779536, rs7869482, rs3808896, rs529269 |
| GABRA2 | rs573400, rs10938435, rs519270, rs2083422, rs279843, rs279844, rs279827, |
| | rs1442060, rs1442062, rs3756007, rs2119767, rs894269 |
| GABRA4 | rs7678338, rs17599158, rs1160093, rs7689605, rs9291300, rs3792208, |
| | rs10517171, rs16859826, rs2229940, rs3762611 |
| GABRA6 | rs1992646, rs3811995, rs3811992, rs6883829, rs3219151 |
| GABRB1 | rs2236781, rs1866989, rs7666487, rs7677890, rs13107066, rs13107066, |
| | rs6284, rs6289, rs6290, rs16860198, rs4591574, rs10028945, rs3733469 |
| GABRB2 | rs592403, rs2229944, rs10515826, rs2194159, rs7724086, rs1363697, |
| | rs10051667, rs4304105, rs2962406, rs10069900, rs6882041, rs3816596 |
| GABRB3 | rs2017247, rs2912582, rs2077920, rs3928441, rs2033420, rs8036052, |
| | rs2873027, rs7173713, rs2194958, rs10873637, rs981778, rs6576603, |
| | rs4453447, rs8179184, rs4906902, rs12910925, rs17647384 |
| GABRD | rs13303344, rs2376805, rs2229110, rs16824627 |
| GABRG2 | rs209345, rs3219203, rs209350, rs11135176, rs211037, rs211029, rs387661, |
| | rs7728001, rs2205364, rs10491329, rs211014, rs418210 |
| GABRG3 | rs12442092, rs7403021, rs2376481, rs7177870, rs997140, rs140674, |
| | rs7162014, rs3097500, rs3101640, rs140679, rs2066712, rs7177425 |
| GAD1 | rs3791878, rs11542313, rs3828275, rs2241164, rs769407, rs701492, |
| | rs769393, rs769402, rs4297845 |
| GAD2 | rs2236417, rs2236418, rs7919405, rs2839672, rs3781116, rs1330581, |
| | rs4747547, rs2839678, rs1556234, rs7900976, rs3781109, rs4749107, |
| | rs4747550, rs870341, rs8190800 |
| GAL | rs4930241, rs694066, rs3136540, rs3136541, rs3136546 |
| GALR1 | rs11662010, rs5374, rs5375, rs2717162, rs9961622, rs5376, rs5377 |
| GALR2 | rs2443168, rs2598414, rs2256879, rs8836 |
| GALR3 | rs2285179, rs2017022, rs2284058 |
| GBP1 | rs7911, rs1048443, rs1048425, rs1048410, rs1048401, rs10493822, |
| | rs1536670 |
| GBP2 | rs4656093, rs1329119, rs4656095, rs3738053, rs7537937, rs2297025, |
| | rs10754261, rs17130736 |
| GCH1 | rs10483639, rs7142517, rs752688, rs4411417, rs8007201, rs7492600, |
| | rs998259, rs3783641, rs2878172, rs8007267 |
| GDNF | rs11748343, rs3749692, rs1549250, rs2973041, rs3096140, rs2975100 |
| GLRA1 | rs2229962, rs11167557, rs1346489, rs1428155, rs2915890, rs2964608, |
| | rs6579906, rs7709656, rs991738 |
| GLRA2 | rs3027322, rs7889706, rs3027358, rs2238914, rs2188931, rs3027379, |
| | rs7877036, rs6526791, rs1160198, rs6526822, rs5934186, rs5935787, |
| | rs6630811, rs2188886, rs5935799, rs5980064, rs5935802, rs11795712, |
| | rs11796093 |
| GLRB | rs2880691, rs3775725, rs4432799, rs7672929, rs1806572, rs4618360, |
| | rs1801154, rs11945868, rs7662298, rs1129304 |
| GNB2L1 | rs2770997, s2287715, rs3806919, rs888709 |
| GNG5 | rs3813605, rs2794218, rs7555821 |
| GPX4 | rs4807542, rs4807543, rs2302109, rs757228, rs8178967 |
| GRIA1 | rs4145160, rs540375, rs1864205, rs573496, rs1826532, rs480726, |
| | rs1463748, rs10463249, rs1873905, rs716518, rs12153765, rs4958667, |
| | rs778819, rs12658202, rs1493383, rs1873910, rs778833, rs2910266, |
| | rs1422889, rs1363673, rs707176, rs2910269, rs4958672, rs4385264, |
| | rs4077374, rs10042081, rs4530817, rs4299782, rs7735784, rs4502882, |
| | rs11741924, rs4128572, rs3813470, rs4958676, rs1461227, rs10070447 |
| GRIA2 | rs6536221, rs4264878, rs10011589, rs6536224, rs6847043, rs10517665, |
| | rs6844775, rs6536231, rs4302506, rs4475186, rs4691394, rs10007366, |
| | rs4392549, rs6816610, rs6536234, rs6855973, rs6812058 |
| GRIA3 | rs3761555, rs3761554, rs1557545, rs12559450, rs2040404, rs2511034, |
| | rs502434, rs5910006 |
| GRIA4 | rs11226804, rs3758799, rs11226805, rs10750731, rs1445604, rs12421796, |
| | rs7940036, rs1942968, rs1445607, rs977516, rs1258270, rs667713, |
| | rs7931588, rs10895871, rs2186598, rs11226839, rs1954763, rs17478710, |
| | rs7119216, rs748008, rs618301, rs7124769, rs10895877, rs661148, |
| | rs1940964, rs688950, rs599980, rs2277279, rs642544, rs680109, rs2508467, |
| | rs609239, rs1144410, rs3758796, rs2898230, rs502453, rs665554, |
| | rs1939826, rs3758790, rs675091 |
| GRIK1 | rs16984336, rs1977525, rs363504, rs2248989, rs2832405, rs2051182, |
| | rs2018636, rs2832414, rs7509953, rs363526, rs363522, rs363512, |
| | rs6516925, rs3026002, rs363602, rs6516926, rs467407, rs420121, rs466884, |
| | rs464028, rs402280, rs2248845, rs2832469, rs466612, rs466093, rs463479, |
| | rs462393, rs457474, rs467028, rs2245528 |
| GRIN1 | rs4880213, rs2301363, rs10870198, rs12238250, rs6293 |
| GRIN2A | rs1014531, rs7202950, rs12598139, rs765287, rs2284239, rs727605, |
| | rs917834, rs4782041, rs4628972, rs3104703, rs11641062, rs3848328, |
| | rs844395, rs7201574, rs2650429, rs8052800, rs4780784, rs1448239, |
| | rs3852745, rs1345424, rs1071502, rs1071504 |
| GRIN2B | rs1805477, rs1805474, rs2284402, rs2284406, rs2268107, rs1012587, |
| | rs1012586, rs2284411, rs741327, rs2268125, rs220558, rs220575, rs141658, |
| | rs220587, rs2268130, rs220598, rs1120905, rs2193511, rs10845848, |
| | rs7952915, rs2041986, rs10772717, rs219872, rs918168, rs717700, |
| | rs219933, rs219934, rs1345485, rs10505778, rs3764030 |
| GRIN3B | rs2240154, rs2285906 |
| GRK4 | rs2488813, rs16843684, rs2185886, rs2105380, rs2960306, rs1024323, |
| | rs2471350, rs3796468, rs2857844, rs2798298, rs1801058, rs2471347 |
| GRK5 | rs2230347, rs1980030, rs7093673, rs7095989, rs10886437, rs4752275, |
| | rs10128498, rs1473799, rs871196, rs11198874, rs17098707, rs3740563, |
| | rs10886462, rs12415832, rs7101022, rs1413582, rs12416565, rs12780837, |
| | rs3781495, rs4751716, rs928570, rs1889432, rs915120, rs10749320, |
| | rs1999627 |
| GRK6 | rs9313759, rs867755, rs3764925, rs335435 |
| GRK7 | rs1533499, rs2681696, rs2138789, rs13065862, rs4337623, rs4683625, |
| | rs1879287 |
| GRM1 | rs863820, rs9403765, rs9322045, rs9373486, rs4896857, rs4551188, |
| | rs9386147, rs2328729, rs6914239, rs6570754, rs4896864, rs362868, |
| | rs362895, rs9403775, rs362936, rs2300626, rs2268666, rs2941, rs6923492, |
| | rs7770466 |
| GSTM1 | rs412302, rs756637, rs449856, rs611951 |
| GSTT1 | rs4630, s2266637, rs2266633, rs2266636, rs6004035 |
| HIF1A | rs11847020, rs2301106, rs1951795, rs10129270, rs8005745, rs1957756, |
| | rs17099141, rs966824, rs11549465, rs1319462 |
| HN1 | rs4789145, rs7225769, rs11656524 |
| HNRNPG-T | rs7129581, rs4462317 |
| HNRPD | rs11941278, rs2288338, rs1820577, rs1365872, rs2288337 |
| HNRPU | rs1495946, rs3766527, rs12068974, rs1532397 |
| HSPA8 | rs7948948, rs3179174, rs1064585, rs11218941 |
| HSPA9B | rs10117, rs1042665, rs6596438, rs256008, rs690158 |
| HSPCA | rs35997255, rs1059623, rs3742429, rs3736807, rs2224460, rs8005905, |
| | rs10873531, rs34363326, rs34668411 |
| HSPCB | rs476632, rs35074133, rs13296, rs35612006 |
| IFI30 | rs273265, rs2241089, rs2241090, rs11554159, rs7125, rs1045747 |
| IFNG | rs2069734, rs2069705, rs1861493, rs2069707, rs2069732 |
| IFRD1 | rs2520482, rs728273, rs3109117, rs10155882, rs6967593, rs2529587, |
| | rs1024570, rs7817 |
| IGF1 | rs35767, rs5742612, rs12821878, rs7956547, rs5742632, rs10735380, |
| | rs10860865, rs11111267, rs6214 |
| IKBKB | rs7015100, rs3747811, rs5029748, rs9694958, rs2294100, rs2272736, |
| | rs10958713, rs9785118, rs6474388, rs1057741, rs11986055 |
| IL10 | rs3024505, rs3024496, rs1554286, rs1518111, rs1800871, rs1800896 |
| IL13 | rs3091307, rs1800925, rs2066960, rs1295686, rs20541, rs2069757, |
| | rs1295683, rs762534 |
| IL1A | rs4848300,, s17561, rs3783531, rs2071373, rs1800587 |
| IL1B | rs1071676, rs1143643, rs1143634, rs1143627, rs16944, rs1143623 |
| IL1RN | rs2234676, rs2234677, rs1794065, rs3181052, rs419598, rs315952, |
| | rs315951, rs4252041, rs9005, rs315946 |
| IL-2 | rs1479922, rs2069772, rs2069763, rs2069762 |
| IL4 | rs2070874, rs2227284, rs2243250, rs2243251, rs2243291 |
| IL-6 | rs4719714, rs3087221, rs1800797, rs3087226, rs2069830, rs2069845, |
| | rs2069860, rs2069849, rs3087237 |
| IL-8 | rs2227525, rs4073, rs2227307, rs2227306, rs4694637 |
| INADL | rs7551399, rs6685551, rs1286837, rs3762321, rs1286823, rs1286831, |
| | rs1286813, rs2185136, rs2799629, rs2799627, rs6698337, rs6685516, |
| | rs9326052, rs1332636, rs1056513, rs10889272, rs10489968, rs11207881, |
| | rs3762448, rs2365738, rs1332631, rs6661849, rs2498982, rs12076103, |
| | rs1475563, rs7418709, rs2481676 |
| INSIG1 | rs17174297, rs9767875, rs9770068 |
| ITGAM | rs4608351, rs1143678, rs4077810, rs7201448, rs11150610, rs1143681, |
| | rs7499077, rs8045402, rs9937837, rs11861251, rs8048583, rs8057320 |
| JUN | rs9989, rs11688, rs1575440, rs4647002, rs4647018 |
| KCNA2 | rs9782928, rs3887820, rs12411052 |
| KCNJ11 | rs5215, rs5217, rs5218, rs886288, rs5219, rs2285676, rs8175351 |
| KCNJ3 | rs3106661, rs3106660, rs16838016, rs3111033, rs11690166, rs12471749, |
| | rs3106653, rs3111017, rs6711727, rs1823003, rs1823001, rs2961956, |
| | rs10497144, rs10804161, rs13390038, rs2591154, rs17566896, rs1445652, |
| | rs1550798, rs2652461, rs1900132, rs17642086, rs1979004 |
| KCNJ5 | rs6590356, rs7924416, rs2846700, rs4937387, rs4937390, rs6590357, |
| | rs7118824, rs2846675, rs3867250 |
| KCNJ6 | rs2835844, rs702859, rs2835848, rs2835855, rs10483038, rs3392, |
| | rs2835885, rs1399592, rs6517428, rs2835896, rs2835903, rs2070995, |
| | rs857958, rs858040, rs858027, rs2835921, rs2835931, rs2835945, |
| | rs1787337, rs1005358, rs2211842, rs2835988, rs991985, rs2836016, |
| | rs981288, rs3827199, rs762146, rs2409943, rs928765, rs928766, rs3787870, |
| | rs11702683, rs6517442 |
| KCNJ8 | rs2307023, rs11046186, rs829064 |
| KCNJ9 | rs2737703, rs2753268, rs3747619, rs2295621 |
| KCNK2 | rs1452634, rs1157493, rs1947364, rs7535436, rs2363561, rs2885816, |
| | rs4375232, rs2363563, rs2363557, rs2363565, rs12118235, rs1556905, |
| | rs1339408, rs1339409, rs4375236, rs4539107, rs6704324, rs10864166 |
| KCNS1 | rs1540310, rs6124684, rs734784, rs6017486, rs6017488, rs6104012 |
| KCTD17 | rs11913810, rs2235320, rs8138791, rs2235321, rs855791, rs760719 |
| KLK1 | rs3212857, rs5517, rs5516, rs1054713, rs5515, rs2659058, rs5514 |
| KLKB1 | rs4253239, rs1511802, rs3733402, rs2304595, rs4253301, rs4253325, |
| | rs925453 |
| KPNB1 | rs11870935, rs3809868, rs6503796 |
| LIPL3 | rs17112186, rs415996, rs412227, rs17349080, rs303459, rs17434481, |
| | rs430517, rs12412357, rs303477, rs303524 |
| MAO-A | rs4570308, rs5906729, rs2310883, rs909525, rs1800659, rs6323, rs3027403, |
| | rs3027405, rs2239448, rs1137070, rs3027407 |
| MAO-B | rs1040398, rs1799836, rs5952294, rs3027449, rs3027452, rs6651806, |
| | rs2238969, rs12010260, rs6520902, rs5905512, rs5952352 |
| MAP2K1 | rs12443313, rs907893, rs7166547, rs12439516, rs12440176, rs1432442, |
| | rs8036023, rs11630608, rs4258558, rs17586159, rs14303, rs8684 |
| MAP2K1IP1 | rs11944405, rs11937985, rs2298734 |
| MAPK1 | rs3810608, rs6928, rs2298432, rs2283791, rs1557288, rs9610338, |
| | rs3729910, rs2266968, rs5999752, rs12172554, rs8136867, rs4821402, |
| | rs9610496 |
| MAPK11 | rs2272857, rs2072878, rs2076139, rs2066762, rs2066765, rs2235356 |
| MAPK13 | rs3761978, rs3761977, rs1059227, rs2859141, rs2252430, rs2071863 |
| MAPK14 | rs3761980, rs611846, rs851024, rs2237094, rs664367, rs2145362, |
| | rs2237093, rs851006, rs2815805, rs7761118, rs6457878, rs3804452 |
| MAPK3 | rs7698, rs1143695, rs11865086, rs9921806, rs9932466 |
| MC1R | rs3212351, rs3212358, rs3212363, rs1805005, rs2228479, rs2229617, |
| | rs1805007, rs1805008, rs885479, rs2228478 |
| MC4R | rs9966412, rs2229616, rs9953038 |
| MFN1 | rs6762399, rs9822116, rs7356002, rs3976523, rs11720405 |
| MFN2 | rs3818157, rs879690, rs879691, rs1474868, rs1810563 |
| MME | rs1836914, rs989692, rs17442808, rs16824558, rs12635515, rs3773885, |
| | rs35152996, rs1436633, rs9830725, rs4679739, rs3773876, rs9864287, |
| | rs701109, rs12765, rs6665 |
| MPDZ | rs722651, rs3264, rs3765550, rs10960954, rs10809907, rs2274856, |
| | rs10809913, rs17273542, rs10738329, rs17182402, rs7041374 |
| MPO | rs8079006, rs2071409, rs7208693, rs2333227 |
| MRGPRD | rs4930634, rs7950368, rs10896389 |
| MSN | rs12011733, rs5964999, rs7058831, rs7891236, rs6624812, rs6525004, |
| | rs13731, rs16989707 |
| MTHFR | rs198413, rs13306561, rs2066470, rs11121832, rs1801133, rs2066462, |
| | rs1801131, rs2274976, rs4846049 |
| NAB1 | rs1023568, rs2270232, rs1978273, rs10185029, rs10490539, rs2192011 |
| NALP12 | rs4619513, rs10410581, rs35064500, rs8110965, rs12460528, rs4806773, |
| | rs2866112, rs34971363, rs34854934, rs34436714, rs4419163 |
| NFKBIA | rs2273650, rs696, rs2233419, rs10782383, rs2233412, rs1957106, |
| | rs2233409, rs2233408 |
| NFKBIZ | rs9841857, rs11718446, rs7644388, rs6441627, rs616597, rs678354, |
| | rs14134 |
| NGFB | rs7523086, rs6330, rs910330, rs2856813, rs12058927, rs6537860, |
| | rs4565713, rs4320778, rs17540656, rs11102930, rs11466066 |
| NOS1 | rs9658478, rs2682826, rs2293044, rs9658501, rs3741475, rs1353939, |
| | rs9658472, rs1047735, rs1093329, rs2293054, rs6490121, rs2293052, |
| | rs3782202, rs2139733, rs3825103, rs478597, rs2077171, rs3782214, |
| | rs9658279, rs545343, rs545654, rs1552227, rs693534, rs1123425, |
| | rs3782221, rs9658258, rs9658255, rs9658254 |
| NOS2A | rs16966522, rs3794756, rs1060826, rs1060822, rs2297518, rs1137933, |
| | rs3730017, rs8072199, rs3730013, rs2779248, rs2779251 |
| NOS3 | rs10277237, rs3918226, rs1800783, rs3918166, rs1549758, rs1799983, |
| | rs3918201, rs743507, rs3918234, rs3918211, rs3800787 |
| NPY | rs16140, rs16147, rs16478, rs16142, rs16139, rs9785023, rs5574, rs16126 |
| NPY1R | rs4552421, rs4234955, rs4691910, rs9764, rs7687423, rs12510104, |
| | rs13306006 |
| NPY2R | rs17304901, rs2234759, rs1047214, rs2880415, rs9990860 |
| NPY5R | rs4632602, rs11100494, rs6536721 |
| NQO1 | rs10517, rs1800566, rs1437135, rs689459 |
| NR3C1 | rs6196, rs258751, rs10482672, rs33389, rs33383, rs9324916, rs11740792, |
| | rs2963155, rs9324918, rs6195, rs6190, rs6189, rs10482610, rs9324924, |
| | rs4518434, rs7719514, rs6868190, rs12521436 |
| NR4A1 | rs1283155, rs2701124, rs2230439, rs2230440, rs2603751 |
| NR4A2 | rs12803, rs834835, rs16840276 |
| NR4A3 | rs4743365, rs1405209, rs1526267, rs12352835, rs10429611, rs1131339 |
| NRG1 | rs4281084, rs7819063, rs7005606, rs4733130, rs3924999, rs7825588, |
| | rs17731664, rs2976532, rs7007436, rs10503929, rs6992642 |
| NTRK1 | rs2150906, rs1800600, rs1888861, rs1998977, rs4661229, rs12145540, |
| | rs1007211, rs6340, rs1800879, rs1410082, rs2274498, rs6334, rs6336, |
| | rs6337, rs2644596, rs6339, rs6338 |
| NTRK2 | rs1187323, rs3739570, rs1211166, rs1187353, rs2265, rs3780632, |
| | rs4877877, rs10746750, rs1662699, rs1187276, rs2120266, rs1822420, |
| | rs2808707, rs2289658, rs2277193, rs3860945, rs2378676, rs1490406 |
| NTRK3 | rs7176429, rs8031871, rs10468138, rs6496460, rs2229910, rs2229909, |
| | rs1128994, rs16941328, rs16941331, rs744994, rs744993 |
| NTSR1 | rs2427400, rs3746780, rs946478, rs3787535, rs6089930, rs2427430, |
| | rs856934, rs2273075, rs2427440, rs2427444 |
| NTSR2 | rs6742234, rs6432224, rs4233895, rs12612207, rs4669765, rs6432225, |
| | rs7567183 |
| OBLR | rs6090041, rs6090043, rs6011291, rs7271530, rs2229205, rs6089789 |
| OLR1 | rs1050286, rs2010655, rs2742115, rs2742113, rs2742112 |
| OPRD1 | rs1042114, rs533123, rs678849, rs6669447, rs188116, rs2236857, |
| | rs2298896, rs529520, rs2298895, rs2234918, rs204069, rs379944 |
| OPRK1 | rs1425910, rs7820807, rs702764, rs7016275, rs2303432, rs1051660, |
| | rs16918955, rs3808627 |
| OPRM1 | rs1294094, rs1319339, rs7776341, rs1074287, rs12205732, rs6912029, |
| | rs1799971, rs495491, rs3798678, rs563649, rs2075572, rs9322446, |
| | rs533586, rs540825, rs675026, rs660756, rs677830, rs1067684, rs623956, |
| | rs609148, rs497332, rs648893, rs548339, rs12660296, rs34427887, |
| | rs13193952, rs13191001, rs7739525 |
| OXT | rs877172, rs6133010, rs2740210, rs2770378 |
| P2RX2 | rs2323973, rs6560891, rs4883544 |
| P2RX3 | rs7106462, rs10896607, rs10732882, rs3781902, rs2276039, rs2276038, |
| | rs3781894 |
| P2RX4 | rs1169721, rs1044249, rs2303998, rs25643, rs25644, rs1653586 |
| P2RX7 | rs684201, rs685019, rs208288, rs17525809, rs208294, rs16950860, |
| | rs7958311, rs1718136, rs1718119, rs6489795, rs2230912, rs3751143, |
| | rs2230913, rs3751142, rs1621388, rs1653625 |
| P2RY1 | rs1439009, rs1065776, rs701265, rs11917883 |
| P2RY12 | rs9877389, rs16846673, rs3821667, rs2172249, rs3821664, rs10935842 |
| P2RY13 | rs6440735, rs1388628, rs1491980, rs1466684, rs3732757, rs4146770 |
| P2RY2 | rs557451, rs508859, rs1790070, rs2511241, rs1783596, rs1626154, |
| | rs17244555 |
| P2RY4 | rs3829708, rs3829709, rs1152187 |
| P2RY6 | rs12787775, rs6592517, rs7103650, rs2027765, rs11235711, rs7127013, |
| | rs1806516, rs3741152 |
| PACSIN1 | rs6927652, rs3800473, rs3846866, rs3846867, rs7748484, rs3904668, |
| | rs11753634, rs4713808, rs2296575, rs2233647 |
| PDGFB | rs130654, rs2857402, rs879180, rs4821877, rs4821875, rs4990919 |
| PDYN | rs2235749, rs10485703, rs742620, rs2281285, rs1997794 |
| PENK | rs16920581, rs4738501, rs1437277, rs2576573, rs1975285, rs2609998 |
| PLA2G4A | rs979924, rs12720485, rs12022299, rs10489406, rs10489407, rs6696406, |
| | rs6685652, rs2223307, rs10911946, rs7519192, rs2223310, rs4336803, |
| | rs4650708, rs11587539, rs7555140, rs12125857, rs932476, rs2307198, |
| | rs10752989, rs12720707 |
| PLA2G4B | rs1043627, rs7174710, rs2303516, rs1122884, rs3816533, rs1672466, |
| | rs1197669, rs883329, rs1061354 |
| PLAUR | rs4802189, rs4760, rs4251912, rs2302524, rs2239372, rs399145, rs2286960 |
| PNMT | rs1053651, rs3764351, rs876493, rs5638, rs2952151 |
| PNOC | rs2722897, rs17058952, rs1563945, rs7825480, rs2645721, rs2645715, |
| | rs904053 |
| POMC | rs1042571, rs10654394, rs6713532, rs934778, rs3754860, rs6545976 |
| PPP3CA | rs2583389, rs1348161, rs2044041, rs6852347, rs2850338, rs2659528, |
| | rs2850992, rs3730251, rs2850979, rs2695219, rs963065, rs2732514, |
| | rs1506801, rs1876267, rs2732504, rs3804357, rs6851231, rs1358312, |
| | rs997926, rs3804350, rs6826912 |
| PPP3CC | rs17060857, rs9785086, rs7821470, rs101080, rs13271367, rs2469749, |
| | rs2461491, rs17733242, rs2449341, rs28764007, rs7430 |
| PPP3R1 | rs6546366, rs2029091, rs930653, rs13029910, rs11692815, rs1868402 |
| PPP3R2 | rs17189401, rs3739723, rs3739724 |
| PRKACA | rs6511913, rs1368, rs8100819, rs729372, rs3745465, rs899173 |
| PRKACB | rs957528, rs12075911, rs7546625, rs10493750, rs10782823, rs1016379, |
| | rs2642183, rs903263, rs2812448, rs589373, rs7547892, rs2134647, |
| | rs7515976, rs11163916, rs600674, rs316630, rs606816, rs1057738, |
| | rs2389717, rs17131308 |
| PRKCABP | rs17555348, rs4821735, rs2076369, rs7289400, rs2012859 |
| PRKCD | rs1483186, rs3773732, rs6778964, rs2306571, rs11546559, rs2306572, |
| | rs2306574 |
| PRKCE | rs610115, rs687914, rs534288, rs588206, rs585156, rs1522984, rs2090414, |
| | rs1533476, rs940052, rs3924523, rs4446102, rs4952774, rs3923011, |
| | rs935661, rs1947195, rs735112, rs935651, rs753572, rs1987070, rs6730511, |
| | rs6742737, rs3768758, rs2345955, rs10495927, rs6544874, rs3754565, |
| | rs951012, rs281508, rs2278773, rs3738894, rs14138 |
| PRKD1 | rs11984, rs2273815, rs3783298, rs3783299, rs8012335, rs17115113, |
| | rs1959437, rs3783305, rs7156359, rs10498310, rs1953722, rs10150674, |
| | rs7154546, rs4329829, rs4424825, rs1953209, rs1958987, rs2151745, |
| | rs10498313 |
| PRKD3 | rs2041837, rs9318, rs1056021, rs3770764, rs2302650, rs10460527, |
| | rs3770761, rs10177176, rs1989172, rs2300880, rs11896614, rs1158219 |
| PRKG1 | rs6479835, rs10822178, rs10995555, rs1881597, rs12255069, rs1528880, |
| | rs12267384, rs10430472, rs1409351, rs10996377, rs10490977, rs9415743, |
| | rs7897669, rs2339630, rs9414806, rs16913257, rs957717, rs10822131, |
| | rs17509759, rs2816825 |
| PTGER1 | rs8598, rs11668633, rs7249305, rs3745459, rs28364035, rs3760703 |
| PTGER2 | rs1254600, rs1353410, rs1254594, rs1042618 |
| PTGER3 | rs959, rs6656853, rs5702, rs1409986, rs12026099, rs1409978, rs11209710, |
| | rs11209715, rs602383, rs661000, rs5695, rs2300164, rs5680, rs8179390, |
| | rs5671, rs5668, rs2744907 |
| PTGER4 | rs4133101, rs2228058, rs6451535, rs16870224, rs7445984 |
| PTGS1 | rs10306114, rs1236913, rs3842787, rs3842788, rs3842790, rs5789, |
| | rs10306163, rs3842802, rs3842803, rs10306194, rs10306202 |
| PTGS2 | rs2206593, rs5275, rs5272, rs5277, rs20426, rs2383515 |
| RAB20 | rs4771685, rs426453, rs419244, rs375814, rs418543, rs2025905, rs2391840, |
| | rs2477911, rs927793, rs1536621, rs4506764, rs766974 |
| Rab5 (RAB5A) | rs4610240, rs10510496, rs6778866, rs4241539, rs4398451, rs7616422, |
| | rs8682, rs7613136 |
| RAB8B | rs34960542, rs2588862, rs8029212, rs13313493, rs7167722, rs1444405, |
| | rs13681 |
| RELA | rs1049728, rs11568304, rs11227247, rs732072, rs12289836 |
| RET | rs3026727, rs2506007, rs3123655, rs1800858, rs1800860, rs1799939, |
| | rs1800861, rs1800863, rs2075912, rs2565200, rs2435355 |
| RGS2 | rs16834852, rs2746071, rs2746073, rs10489515 |
| RGS4 | rs6678136, rs16864782, rs2842030, rs10759, rs2940251 |
| RUNX1 | rs2249233, rs2835195, rs2248898, rs1882766, rs17227210, rs2071029, |
| | rs743289, rs2300400, rs2268290, rs2834653, rs2284613, rs2051394, |
| | rs2268278, rs1055314 |
| RUNX2 | rs12201555, rs12205523, rs16873373, rs16873379, rs10948234, rs12197755, |
| | rs7771980, rs11498192, rs9463087, rs765724, rs2790093, rs4714854, |
| | rs10485422, rs12209785, rs1200428 |
| RUNX3 | rs4265380, rs6672420, rs11249209, rs12117581, rs3845302, rs1003699, |
| | rs9438876, rs13157, rs2003679, rs3208621 |
| S100A12 | rs3006488, rs3006476 |
| S100B | rs9722, rs881827, rs2839361, rs2839364 |
| SAMSN1 | rs12626593, rs2822708, rs2822732, rs2822754, rs7281104, rs13052873, |
| | rs6516877 |
| SC5DL | rs1560409, rs727422, rs1061332, rs7942396 |
| SCD | rs670213, rs1054411, rs1502593, rs11598233, rs3978768, rs11557927, |
| | rs10883465 |
| SCN10A | rs6599240, rs11129800, rs11129801, rs6775197, rs6771157, rs12632942, |
| | rs6800541, rs6599251, rs7431144, rs6809264, rs6599257, rs11716493, |
| | rs11926158, rs9815891, rs9827941 |
| SCN11A | rs6776510, rs4541346, rs4371451, rs4133368, rs6786732, rs4315640, |
| | rs11919589, rs4514993, rs4504116, rs4345016, rs7636049, rs6763211, |
| | rs4076478 |
| SCN1A | rs7591522, rs552878, rs1461195, rs498631, rs692995, rs2298771, |
| | rs6432860, rs1461193, rs10930202, rs1461197, rs1020852, rs6722462, |
| | rs534798 |
| SCN2A1 (SCN2A) | rs17182714, rs6718960, rs12619626, rs3769931, rs13025009, rs12993173, |
| | rs2060199, rs16850532, rs10930162, rs2060198, rs2227899, rs2227898, |
| | rs1007722 |
| SCN3A | rs1439993, rs10930148, rs3213904, rs1158135, rs1946892, rs1439808, |
| | rs13011371, rs4667796, rs11894144, rs2390165, rs3806539 |
| SCN5A | rs1805126, rs1805124, rs3934936, rs7624535, rs6599230, rs11720524, |
| | rs9825294, rs7373686 |
| SCN8A | rs7975319, rs12426436, rs1905248, rs12424271, rs10783462, rs3782478, |
| | rs4761829, rs4761831, rs1816760, rs1439790, rs303802, s303815, rs60637, |
| | rs3741705 |
| SCN9A | rs3750904, rs13430906, rs16851799, rs10930214, rs4633936, rs4453709, |
| | rs3924001, rs6747673, rs13402180, rs4632359, rs9646771, rs9646772, |
| | rs4131162 |
| SET | rs13296296, rs6478846, rs4240432 |
| SGK | rs2758152, rs7755303, rs1057293, rs1763527 |
| SGKL | rs2357998, rs6472285, rs7002479, rs7002788, rs12114734, rs11780700 |
| SLC1A3 | rs2562581, rs1366638, rs1864213, rs13166160, rs1645660, rs3776573, |
| | rs4869682, rs10491374, rs2032892, rs2229894, rs2269272 |
| SLC18A2 | rs363330, rs363332, rs363338, rs363221, rs4752045, rs363230, rs363279, |
| | rs14240 |
| SLC29A1 | rs1057985, rs3778504, rs693955, rs324148, rs760370, rs3734703 |
| SLC32A1 | rs1321099, rs1322183, rs6092933 |
| SLC6A11 | rs2600072, rs9835618, rs971930, rs9835411, rs6442209, rs3774125, |
| | rs2304725, rs3774116, rs1609480, rs6809562, rs6442211, rs4684743, |
| | rs11720592, rs3821767, rs2629133, rs2655280, rs2581206, rs2629135, |
| | rs2272395, rs2697159, rs2272400, rs2245532, rs3732371, rs6782922 |
| SLC6A13 | rs495360, rs2289954, rs555044, rs2289957, rs492540, rs10848623, |
| | rs3782856, rs1548904, rs797765 |
| SLC6A2 | rs2242446, rs3785143, rs192303, rs6499771, rs36024, rs36023, rs36021, |
| | rs3785152, rs1805066, rs11862589, rs1861647, rs5569, rs42460, rs7194256, |
| | rs171798, rs258099 |
| SLC6A3 | rs27072, rs11133767, rs429699, rs6347, rs2963253, rs6348, rs464049, |
| | rs463379, rs403636, rs6346, rs6350, rs2975226 |
| SLC6A4 | rs1042173, rs3794808, rs140701, rs140700, rs2228673, rs2020942, rs6355, |
| | rs2066713, rs2020933, rs25533 |
| SOD2 | rs7855, rs8031, rs5746151, rs10370, rs5746146, rs2758331, rs5746105, |
| | rs1799725, rs5746092, rs5746091 |
| STAU1 (STAU) | rs1043357, rs1043361, rs348298, rs7272164, rs2273653, rs348277, |
| | rs624945, rs2426143, rs348290 |
| STAU2 | rs3088139, rs10112019, rs10458310, rs12680126, rs6991856, rs716009, |
| | rs2891352, rs949493, rs7015090, rs4738390, rs6992006, rs1566772, |
| | rs10086435, rs10100388, rs10106686, rs6995579, rs3808621, rs10086736 |
| TAAR1 | rs9402439, rs8192619, rs8192620, rs9375907 |
| TAAR2 | rs4380767, rs11968252, rs8192646 |
| TAAR3 | rs4078135, rs7738600, rs3813353 |
| TAAR4 | rs7772928, rs4144146, rs9389009 |
| TAAR5 | rs17061477, rs3813354, rs3813355 |
| TAAR6 | rs8192625, rs8192624, rs8192622 |
| TAAR7 | rs2255071, rs17061372 |
| TAAR8 | rs8192627 |
| TAAR7/8 | rs11965773 |
| TAAR7/9 | rs9389004 |
| TAC1 | rs6465606, rs2072100, rs1229434, rs12532490 |
| TACR1 | rs881, rs4439987, rs6546952, rs3755459, rs3821314, rs2160652, rs6741029, |
| | rs3771827, rs10208860, rs4519549, rs2216307, rs10865408, rs3771859, |
| | rs6715729, rs2111375 |
| TCIRG1 | rs884826,, s2075609, rs3794186 |
| TGFB1 | rs6957, rs2241719, rs4803455, rs1800471, rs1982073, rs1982072 |
| TH | rs3842738, rs2070762, rs6357, rs6356, rs7950050, rs10770140, rs10840490 |
| THBS1 | rs3784390, rs1478604, rs2228261, rs2292305, rs2228262, rs2228263, |
| | rs1051442, rs3743125 |
| TIEG (KLF10) | rs1434278, rs3191333, rs4734653, rs1076030 |
| TIMP1 | rs2294219 |
| TLR4 | rs2770150, rs11536865, rs1927911, rs1927907, rs5030710, rs4986790, |
| | rs5031050, rs4986791, rs7869402, rs11536889 |
| TMSB10 | rs7580854, rs1804515, rs1052264, rs1382507 |
| TMSB4X | rs5935457, rs9778614, rs17008883, rs3088116 |
| TNF | rs1800629, rs361525, rs2228088, rs3093726, rs3091257 |
| TNFAIP3 | rs3757173, rs5029942, rs5029956, rs610604, rs5029953 |
| TPH2 | rs4570625, rs10748185, rs11179002, rs1386496, rs1386492, rs7305115, |
| | rs1023990, rs7299582, rs4760754, rs1352250, rs1487276, rs1487275, |
| | rs4474484, rs7315855, rs17110747, rs17110563 |
| TRPM8 | rs1003540, rs6709005, rs10803665, rs11562954, rs758275, rs10180847, |
| | rs9646720, rs12472151, rs6740118, rs7593557, rs10929320, rs10929321, |
| | rs12185625, rs10171428, rs13411202, rs10207672, rs10210459, rs11563056, |
| | rs11563208, rs6723922, rs7560562, rs11563071, rs11563202, rs2052030 |
| TRPV1 | rs7223530, rs4790522, rs224547, rs8065080, rs150908, rs3826501, |
| | rs150846, rs11870382, rs2277675, rs733080, rs182637, rs224495 |
| TRPV2 | rs3813769, rs3813768, rs8079271, rs8121, rs1129235, rs12936240, |
| | rs7208718 |
| TRPV3 | rs2271158, rs7219780, rs7216486, rs925101, rs7212403, rs4790145, |
| | rs395357, rs401643, rs1039519, rs1699138, rs322964, rs4790520 |
| UBE2G2 | rs760431, rs11569, rs183518, rs235275, rs84188 |
| UGT2B7 | rs7668258, rs7438284, rs7439366, rs4356975, rs12642938, rs6851533 |
| VEGF | rs36026135, rs25648, rs833069, rs3025010, rs3025053 |
| VIL2 | rs3205303, rs3102976, rs744893, rs3123116, rs6915189, rs9347258, |
| | rs923198 |
| VPS4A | rs246129, rs8044794, rs153050, rs1127231, rs12258 |
| VPS4B | rs1055002, rs2276317, rs17689135, rs3780572 |
| XDH | rs1042039, rs169596, rs4952085, rs1884725, rs10190201, rs2295475, |
| | rs17011368, rs17323225, rs2281547, rs6733391, rs4407290, rs205847, |
| | rs1265618, rs206860, rs3769616, rs206811, rs206812 |
| YWHAZ | rs3134353, rs1062382, rs3134380, rs1901362, rs2290291, rs4734497 |
| ZA20D2 | rs969, rs2809270, rs11143275, rs909172, rs2984529 |
| ZA20D3 | rs2461649, rs2461641, rs1357335, rs2866368, rs11072880, rs1916048, |
| | rs2103043 |

TABLE 6
ANALYSIS OF ASSOCIATIONS BETWEEN EXEMPLARY CANDIDATE
GENES AND MEASURES OF PAIN SENSITIVITY, SOMATIZATION,
DEPRESSION, TRAIT ANXIETY, AND BLOOD PRESSURE AS
PREDICTORS OF SOMATOSENSORY DISORDERS

| | | | | | staiy2 | |
|---|---|---|---|---|---|---|
| | | Pain | pill1, tbsi1 | beck, tbsi4 | Trait | Blood |
| Gene | SNP ID | Sensitivity | Somatization | Depression | anxiety | Pressure |
| COMT | rs9306230 | YES | | | | |
| COMT | rs2020917 | YES | | | | |
| COMT | rs737865 | YES | | | | |
| COMT | rs4646312 | YES | | | | |
| COMT | rs3810595 | YES | | | | |
| COMT | rs6269 | YES | | | | |
| COMT | rs4818 | YES | | | | |
| COMT | rs165728 | | | | | Yes |
| ADRA1A | hCV2957871 | | | | | Yes |
| ADRA1A | hCV2957869 | YES | | | | |
| ADRA1A | hCV2696448 | YES | | | | YES |
| ADRA1A | hCV2696458 | | | | | Yes |
| ADRA1A | hCV2696465 | YES | | | | Yes |
| ADRA1A | hCV11850521 | YES | | | | Yes |
| ADRA1A | hCV129377 | YES | | | | Yes |
| ADRA1A | hCV2696493 | | | YES | | |
| ADRA1A | hCV2696494 | | | YES | | |
| ADRA1A | hCV11850470 | | | | | Yes |
| ADRA1A | hCV2696505 | | YES | | | |
| ADRA1A | hCV2696506 | | | YES | | |
| ADRA1A | hCV2315080 | | YES | | | |
| ADRA1A | hCV2315086 | YES | | | | |
| ADRA1A | hCV2696540 | | | | | |
| ADRA1A | hCV2696544 | YES | | | | |
| ADRA1A | hCV2696566 | | YES | YES | YES | |
| ADRA1A | hCV8795096 | | | | | Yes |
| ADRA1A | hCV2315113 | | | | | Yes |
| ADRA1A | hCV2696588 | | | | | Yes |
| ADRA1B | hCV1738255 | Yes | YES | | | |
| ADRA1B | hCV1738292 | Yes | | | | |
| ADRA1B | hCV1738308 | | | | | Yes |
| ADRA1B | hCV1738309 | | | | | Yes |
| ADRA1B | hCV11271797 | | yes | | | |
| ADRA1B | hCV26140255 | | | | | Yes |
| ADRB2 | rs2084740 | | | | | YES |
| ADRB2 | rs11830550 | | yes | YES | yes | YES |
| ADRB2 | rs2084751 | | | yes | YES | YES |
| ADRB2 | rs8950504 | | | yes | YES | YES |
| ADRB2 | rs2084757 | | | yes | yes | YES |
| ADRB2 | rs2084759 | | | yes | yes | YES |
| ADRB2 | rs2084764 | | yes | | | YES |
| ADRB2 | rs2084765 | | | | | YES |
| ADRB2 | rs2084766 | | yes | yes | | |
| ADRB2 | rs8950496 | | | | | |
| ADRB2 | rs2084769 | | yes | | | |
| ADRB3 | rs3273557 | | | | | YES |
| ADRB3 | rs3273556 | | yes | | | |
| ADRB3 | rs12106153 | | yes | | | |
| ADRB3 | rs2215549 | | yes | | | |
| CALCRL | rs860859 | Yes | | | | |
| CALCRL | rs696092 | Yes | | | | |
| CALCRL | rs3771095 | Yes | yes | | | |
| CALCRL | rs858745 | Yes | yes | | | |
| CALCRL | rs17366895 | Yes | yes | | | |
| CALCRL | rs3771083 | | YES | | | |
| CALCRL | rs10179705 | YES | | | | |
| CALCRL | rs10203398 | YES | | | | |
| COX2 | rs689470 | Yes | | | | |
| COX2 | rs5275 | | | | | Yes |
| COX2 | rs2066826 | | yes | | | |
| COX2 | rs5277 | YES | | | | |
| COX2 | rs2383515 | | yes | yes | | Yes |
| EAR2 | rs288539 | Yes | | | | |
| EAR2 | rs8099896 | Yes | | | | |
| EAR2 | rs4808611 | Yes | | | | |
| GALR3 | rs2017022 | Yes | | | | |
| GALR3 | rs2284058 | Yes | | | | |
| GALR3 | rs3091367 | Yes | | | | |
| NET | rs1232486 | YES | | | | |
| NET | rs649183 | | | | YES | |
| NET | rs1232433 | | | YES | | |
| GRIN3B | rs16176384 | | | yes | | |
| GRIN3B | rs25964542 | | YES | | | |
| DREAM | rs16102427 | | | Yes | | |
| DREAM | rs2172166 | | | | | |
| DREAM | rs11513235 | | Yes | | Yes | |
| MuOpioid | rs1074287 | Yes | | | | Yes |
| MuOpioid | rs524731 | | | | | Yes |
| MuOpioid | rs563649 | Yes | | | | Yes |
| MuOpioid | rs677830 | | | | | Yes |
| MuOpioid | rs609148 | | | | | Yes |
| Delta | rs1042114 | | | | YES | |
| Opioid | | | | | | |
| Delta | rs533123 | YES | | | | |
| Opioid | | | | | | |
| Delta | rs678849 | | YES | | YES | |
| Opioid | | | | | | |
| IL-1B | rs9546517 | | | | | YES |
| IL-1B | rs1839945 | | | | | YES |
| IL-1B | rs1839944 | | | | | YES |
| IL-10 | rs1800896 | YES | | | | |
| IL-10 | rs1800893 | YES | | | | |
| IL-13 | rs2066960 | YES | | | | YES |
| IL-13 | rs1295686 | | | | | YES |
| IL-13 | rs20541 | | | | | YES |
| IL-13 | rs1295685 | | | | | YES |
| IL-2 | rs3136534 | Yes | yes | | | |
| IL-2 | rs1479922 | Yes | | yes | yes | |
| IL-2 | rs2069772 | Yes | | | | |
| IL-2 | rs2069762 | Yes | YES | | | Yes |
| IL-4 | rs2070874 | Yes | | | | |
| IL-4 | rs734244 | Yes | | | | |
| IL-4 | rs2227284 | Yes | | | | |
| IL-4 | rs2243267 | Yes | | | | |
| IL-4 | rs2243270 | Yes | | | | |
| IL-4 | rs2243291 | Yes | | | | |
| NFKBIA | rs2233419 | Yes | | | | |
| NFKBIA | rs1957106 | Yes | | | | |
| NFKBKB | rs238338 | Yes | | | | YES |
| NFKBKB | rs374907 | Yes | | | | YES |
| NFKBKB | rs16186013 | Yes | | | | Yes |
| NFKBKB | rs15935523 | Yes | | | | |
| NFKBKB | rs27504494 | Yes | | | | |
| NFKBKB | rs11860688 | Yes | | | | Yes |
| NFKBKB | rs15746872 | Yes | | | | |
| NFKBKB | rs15963514 | Yes | | | | |
| NFKBKB | rs57962 | Yes | | | | |
| NFKBKB | rs11860684 | Yes | | | | Yes |
| NFKBKB | rs27504494 | Yes | | | | |
| PTGS1 | rs10306114 | | | | yes | |
| PTGS1 | rs1236913 | | yes | | | |
| PTGS1 | rs3842787 | | | | yes | |
| PTGS1 | rs3842788 | | | | | Yes |
| PTGS1 | rs5789 | YES | | | | |
| PTGS1 | rs5794 | | | | | Yes |
| PTGS1 | rs10306194 | YES | | | | Yes |
| RGS4 | rs16864782 | Yes | | | | |
| RGS4 | rs2842030 | Yes | | | | |
| RGS4 | rs10799897 | Yes | | | | |
| RGS4 | rs10759 | Yes | | | | |
| RCP9 | rs316314 | | | | | Yes |

ANOVA analysis: YES = P < 0.01, yes = P < 0.05

### EXAMPLES

The following Examples have been included to illustrate modes of the presently disclosed subject matter. In light of the present disclosure and the general level of skill in the art, those of skill will appreciate that the following Examples are intended to be exemplary only and that numerous changes, modifications, and alterations can be employed without departing from the scope of the presently disclosed subject matter.

### Materials and Methods for Examples 1-3

A three-year, prospective cohort study of first-onset TMJD among healthy, female volunteers aged 18-34 years at the time of recruitment was undertaken. The goal was to follow 238 subjects for up to three years, this being the number calculated to provide statistical power of 0.80 to detect risk ratios of at least 2.7 assuming a three year cumulative incidence of 9% which was estimated based on results reported by Von Korff et al. (1993).

Prior to enrolment in the study, volunteers were screened and underwent a baseline physical examination of the head and neck conducted using the research diagnostic criteria (RDC) for an exemplary somatosensory disorder, TMJD (Dworkin and LeResche, 1992). Volunteers were excluded if they were diagnosed with TMJD or if they reported a significant medical history including traumatic facial injuries or use of centrally acting medications. At baseline, peripheral blood samples were collected from enrolled subjects and they completed psychological questionnaires and psychophysical pain assessments. For up to 42 months after their baseline assessment, subjects were contacted every three months by research staff who administered a medical history update questionnaire. Any subjects responding positively to key questions about TMJD symptoms were re-examined using the RDC protocol. Additionally, each year all subjects were invited to attend for RDC examination. New cases of TMJD myalgia and/or TMJD arthralgia were defined using the RDC protocol (Dworkin and LeResche, 1992) that is based on: a) reported experience of pain in their face, jaw, temple, or ear and b) a clinical finding of tenderness to palpation of TM muscles and joints that was confirmed independently by two examiners.

Subjects were pain phenotyped with respect to their sensitivity to pressure pain, heat pain, and ischemic pain. Indices of the temporal summation of heat evoked pain were also examined. To control for the effects of menstrual cycle on pain sensitivity all pain measurements, except pressure pain threshold, were performed during the follicular phase (between days 3 and 10) of the subject's menstrual cycle. All subjects were asked to refrain from consuming over-the-counter pain relieving medications for at least 48 hours before visiting the laboratory and all subjects were free of prescription pain medications for at least two weeks prior to testing. During each session, pain measurements were performed in the following order: pressure pain, thermal pain, temporal summation of heat pain, and ischemic pain. The sequence of procedures was not randomized between subjects because of the possible long lasting effects of the more prolonged noxious stimuli (i.e. ischemic pain & repeated application of high intensity heat pulses) on neural and hormonal systems.

Pain Phenotyping Procedures.

A. Pressure Pain Threshold

Pressure pain threshold (PPT) was assessed over the right and left temporalis muscle, masseter muscle, temporomandibular joint, and ventral surface of the wrist with a hand-held pressure algometer (Pain Diagnosis and Treatment, Great Neck, N.Y., U.S.A.). The PPT was defined as the amount of pressure (in kg) at which the subjects first perceived the stimulus to be painful. One pre-trial assessment was performed at each site followed by additional assessments until two consecutive measures were obtained that differed by less than 0.2 kg. The values from the right and left sides were averaged to obtain one pressure pain threshold value per anatomical site.

B. Heat Pain Threshold and Tolerance

Measures of thermal pain threshold and tolerance were obtained with a 10 mm diameter computer controlled contact thermal stimulator. Thermal stimuli were applied to the skin overlaying the right masseter muscle, right forearm, and dorsal surface of the right foot. Thermal pain threshold was defined as the temperature (° C.) at which the subjects first perceived heat pain, whereas thermal pain tolerance was defined as the temperature (° C.) at which the subjects would no longer tolerate the pain and requested the removal of the stimulus. Six heat ramps were applied to each site for each measure from a neutral adapting temperature of 32° C. at a rate of 0.5° C./sec.

C. Responses to Repeated Heat Stimuli Responses to sequential presentations of heat pulses were assessed. A total of fifteen 53° C. heat pulses were applied to the skin overlying the thenar region of the right hand. Each heat pulse was 1.5 sec in duration and was delivered at a rate of 10° C./sec from a 40° C. base temperature with an inter-trial interval of 1.5 sec. Subjects were instructed to verbally rate the intensity of each thermal pulse using a 0 to 100 numerical scale with ‘0’ representing ‘no sensation’, ‘20’ representing ‘just painful’, and ‘100’ representing ‘the most intense pain imaginable’.

D. Ischemic Pain Threshold and Tolerance

A modified sub-maximal effort tourniquet procedure was used to evoke ischemic pain. The subject's right arm was elevated for 30 sec followed by the inflation of a blood pressure cuff to 220 mmHg. A stopwatch was started and the subject squeezed a handgrip dynamometer at 30% of maximum force of grip for 20 repetitions. The times to ischemic pain onset and tolerance were determined. The tourniquet remained in place for 25 min or until pain tolerance had appeared.

Blood pressure measurements. Resting systolic and diastolic blood pressures were assessed on the right arm with an automatic blood pressure monitor (DINAMAP®, Johnson & Johnson Corporation, New Brunswick, N.J., U.S.A.). Five measures obtained at 2 minute intervals after a 15 minute rest period were averaged to derive measures of resting systolic and diastolic arterial blood pressure.

Psychological measures: Psychological questionnaires, which assessed a broad range of psychological characteristics, were administered at the time of subject recruitment. The Brief Symptom Inventory (BSI), a short form of the Symptom Checklist 90 Revised, consists of 53 items designed to assess nine aspects of psychological function (Derogatis & Melisaratos, 1983). Prescribed instructions to compute t-scores for each of nine subscales; somatization, obsessive, internal sensitivity, depression, anxiety, hostility, phobias, paranoid, and psychotic were used. The Profile of Mood States-Bi-Polar (POMS-Bi) consists of 72 mood-related items yielding seven subscales measuring affective dimensions of mood (Lorr and McNair, 1988). The subscales were: agreeable-hostile, elated-depressed, confident-unsure, energetic-tired, clearheaded-confused, and composed-anxious. The Perceived Stress Scale (PSS) asks about financial stress, occupational stress, significant other stress, parental stress, and stress within friendships to provide a single, global assessment of major sources of life stress (Cohen et al., 1983). The State-Trait Anxiety Inventory (STAI) contains 20 statements measuring two subscales: state and trait anxiety (Spielberger et al., 1983).

Data analysis: The research questions were evaluated in sequence, recognizing that there could be insufficient statistical power to evaluate all hypothesized relationships using multivariate modeling alone. TMJD risk was first quantified by computing average incidence rates of TMJD (incidence density). Pain sensitivity phenotype was measured by summarizing responses to 13 standardized noxious stimuli, yielding a single index of pain sensitivity. The incidence density ratio (IDR) was computed to compare TMJD risk between subjects who had relatively high sensitivity versus subjects who had relatively low sensitivity. Psychological variables were dichotomized to assess associations with TMJD risk.

### Example 1

### Neurological and Psychological Predictors of TMJD Development

Neurological and psychological factors are two primary domains that contribute to the risk of somatosensory disorders (Diatchenko, 2006; FIG. 1). In the present Example, several neurological variables including pain sensitivity and resting arterial blood pressure were identified as predictors of TMJD development. Several psychological variables including somatization, anxiety, depression, and perceived stress were identified as predictors of TMJD onset.

The present Example demonstrates that neurological factors (e.g., pain sensitivity) and psychological factors can be used to predict the risk of developing somatosensory disorders, including TMJD.

### Results of Example 1

Two hundred and seventeen of the 244 participants (−89%) completed one or more follow-up assessments, and 185 of them provided samples and consent for genotyping. Fifteen participants (7% of the cohort; 8% of genotyped subjects) were diagnosed as incident cases of TMJD, eight with myalgia and the remainder diagnosed with both myalgia and arthralgia. Diagnoses occurred at varying time periods ranging from nine months to three years after recruitment, yielding an average incidence rate of 3.7 cases per 100 person-years of follow-up. At the time of diagnosis, the amount of pain reported on a 100-point visual analog scale averaged 40 units (sd=5.4), with a mean of 64 (sd=6.1) for most severe pain. Subjects reported experiencing pain an average of one third of the time (34.4±8.7%). At one or more of the follow-up examinations, a further ninety-two subjects (−38%) reported “subclinical” signs of a TMJD-like condition consisting of short episodes (<2 weeks) of transient facial pain, jaw locking or fatigue, and/or headaches of at least 5 per month.

Risk of TMJD and Pain Sensitivity. To determine if sensitivity to noxious stimuli at the time of recruitment was predictive of TMJD risk, subjects were categorized into two groups, above or below the 2^{nd} tertile of a summary z-score of pain responsiveness. The summary score was computed by first transforming tolerance, threshold, or pain rating measurements to unit normal deviates (z-scores), and then summing values for each of the noxious stimuli (see Diatchenko et al. 2005). The annual TMJD incidence rate was 5.8 cases per 100 person-years among subjects with relatively high responsiveness compared with 2.2 cases per 100 person-years among subjects with lower sensitivity to pain, yielding a statistically significant incidence density ratio (IDR) of 2.7 (95% confidence interval [CI]=1.3-5.7). The findings provide evidence that increased sensitivity to pain is associated with the risk of developing TMJD, and other comorbid somatosensory disorders.

Risk of TMJD and Resting Arterial Blood Pressure. Two summary measures of blood pressure were significant risk factors for TMJD onset. It was not possible to calculate the IDR for systolic blood pressure because no incident cases were observed for individual with resting systolic blood pressure greater than 115 mm Hg. The IDR for diastolic blood pressure was 3.5 (95% CI: 1.8-7.0. These findings are consistent with the hypothesis that higher resting arterial blood pressure protects against the risk of TMJD onset (Maixner et al. 1997; Hagen et al., 2005), and other comorbid somatosensory disorders.

Psychological Factors and Risk of TMJD Development. When dichotomized at the median value, several psychological characteristics assessed at baseline had higher rates of incident TMJD (Table 7). Furthermore, five psychological characteristics were significantly associated with the summary z-score of responsiveness to experimental pain and with TMJD incidence. Specifically, for each of the following psychological variables, subjects with scores in the upper median showed significantly greater experimental pain sensitivity (p's<0.05) and had higher rates of incident TMJD: trait anxiety, BSI depression, and perceived stress and two POMS scores (confident-unsure and clearheaded-confused) compared to individuals with scores below the median. Somatization, neuroticism, and coping skills (CSQ increased behavioral) were not correlated with pain sensitivity (i.e., sum z-score) but these items were associated with the risk of TMJD onset. Thus, these findings provide evidence that higher levels of somatization, neuroticism, CSQ increased behavioral, depression, trait anxiety, and psychosocial stress are associated with the risk of developing TMJD, and other comorbid somatosensory disorders.

TABLE 7
TMJD INCIDENCE RATE IN PSYCHOLOGICAL SUB-GROUPS

| | | | | Upper | Bonferroni |
|---|---|---|---|---|---|
| | TMJD Incidence | | Lower 95% Cl | 95% Cl of | significance |
| Psychological subscale | density ratio (IDR) | P-value | of IDR | IDR | (P < 0.00128) |
| Child abuse | 0.34 | 0.11955 | 0.08 | 1.33 | No |
| Adult abuse | 1.63 | 0.21232 | 0.76 | 3.53 | No |
| Child + Adult abuse | 1.39 | 0.41827 | 0.62 | 3.10 | No |
| AX total anger expression | 1.40 | 0.40103 | 0.64 | 3.07 | No |
| AX anger-in | 0.71 | 0.39681 | 0.33 | 1.56 | No |
| AX anger-out | 0.73 | 0.43789 | 0.34 | 1.60 | No |
| Beck scale | 0.88 | 0.73917 | 0.40 | 1.91 | No |
| BSI Somatization (T-score) | 4.29 | 0.00085 | 1.82 | 10.08 | Yes |
| BSI Obsessive (T-score) | 2.51 | 0.02434 | 1.13 | 5.61 | No |
| BSI Internal sensitivity (T-score) | 1.01 | 0.97480 | 0.47 | 2.18 | No |
| BSI Depression (T-score) | 2.69 | 0.01019 | 1.26 | 5.72 | No |
| BSI Anxiety (T-score) | 3.35 | 0.01890 | 1.22 | 9.18 | No |
| BSI Hostility (T-score) | 1.11 | 0.84289 | 0.40 | 3.11 | No |
| BSI Phobias (T-score) | 2.03 | 0.07404 | 0.93 | 4.42 | No |
| BSI Paranoid (T-score) | 1.33 | 0.52265 | 0.55 | 3.20 | No |
| BSI Psychotic (T-score) | 1.55 | 0.26134 | 0.72 | 3.33 | No |
| All BSI items (T-score) | 4.25 | 0.00373 | 1.60 | 11.29 | No |
| CSQ: Diverting attention | 0.92 | 0.83978 | 0.42 | 2.01 | No |
| CSQ: Reinterpreting pain | 1.59 | 0.23908 | 0.73 | 3.47 | No |
| CSQ: Coping self | 0.56 | 0.16188 | 0.25 | 1.26 | No |
| CSQ: Ignoring sensations | 0.68 | 0.33585 | 0.31 | 1.49 | No |
| CSQ: Praying/hoping | 0.89 | 0.76985 | 0.41 | 1.94 | No |
| CSQ: Catastrophizing | 1.70 | 0.17935 | 0.78 | 3.70 | No |
| CSQ: Increase behavioral | 2.87 | 0.00975 | 1.29 | 6.38 | No |
| EPQR P scale | 1.59 | 0.24952 | 0.72 | 3.53 | No |
| EPQR E scale | 1.33 | 0.48457 | 0.60 | 2.93 | No |
| EPQR N scale | 3.73 | 0.00291 | 1.57 | 8.86 | No |
| EPQR L scale | 1.31 | 0.51760 | 0.58 | 2.94 | No |
| LOT-R | 0.39 | 0.03389 | 0.16 | 0.93 | No |
| All PILL items | 6.56 | 0.00011 | 2.53 | 17.05 | Yes |
| Agreeable-hostile | 0.69 | 0.35674 | 0.32 | 1.51 | No |
| Elated-depressed | 0.98 | 0.95729 | 0.45 | 2.11 | No |
| Confident-unsure | 0.39 | 0.03450 | 0.16 | 0.93 | No |
| Energetic-tired | 0.58 | 0.18294 | 0.26 | 1.30 | No |
| Clearheaded-confused | 9.38 | 0.00084 | 2.52 | 34.88 | Yes |
| Composed-anxious | 2.37 | 0.03516 | 1.06 | 5.29 | No |
| STAIY State | 1.65 | 0.20733 | 0.76 | 3.57 | No |
| STAIY Trait | 6.09 | 0.00031 | 2.28 | 16.26 | Yes |
| Perceived stress | 3.71 | 0.00288 | 1.57 | 8.79 | No |

### Discussion of Example 1

The present Example provides a demonstration that some otherwise-healthy female subjects exhibited neurological characteristics, physiological characteristics, and psychological characteristics that predict the risk of TMJD. The observed IDRs are comparable to risk ratios reported for predictors of other multifactorial conditions such as schizophrenia (Shifman et al., 2002) and for TMJD (Von Korff et al., 1993). Nonetheless, these represent only moderately strong predictors, highlighting the noted characteristic of many somatosensory disorders in general, that no single neurological or psychological characteristic is usually sufficient to explain variability associated with a complex condition such as TMJD.

Pain Sensitivity: A Determinant of Onset and Persistence of Somatosensory Disorders. A handful of studies have sought to prospectively identify risk factors or risk determinants that are associated with or mediate the onset and maintenance of somatosensory disorders. A well-established predictor of onset is the presence of another chronic pain condition, characterized by a state of pain amplification (Von Korff et al. 1988). Additionally, widespread pain is a risk indicator for dysfunction associated with painful TMJD and for lack of response to treatment (Raphael and Marbach 2001). The outcomes of several cross-sectional studies also suggest that somatosensory disorders, including TMJD, are influenced by a state of pain amplification (Sarlani and Greenspan 2003; Maixner 2004). In general, a relatively high percentage of patients with somatosensory disorders show enhanced responses to noxious stimulation compared to controls (McBeth et al. 2001; Bradley and McKendree-Smith 2002; (McCreary et al. 1992); Gracely et al. 2004). Enhanced pain perception experienced by patients with somatosensory disorders may result from a dysregulation in peripheral afferent and central systems that produces dynamic, time dependent changes in the excitability and response characteristics of neuronal and glial cells. This dysregulation likely contributes to altered mood, motor, autonomic, and neuroendocrine responses as well as pain perception (FIG. 1; Maixner et al. 1995; Maixner 2004).

Psychological Distress: A Determinant of Onset and Persistence of somatosensory disorders. Heightened psychological distress is another domain or pathway of vulnerability that can lead to somatosensory disorders (FIG. 1). Patients with TMJD, and other somatosensory disorders, display a complex mosaic of depression, anxiety (Vassend et al., 1995), and perceived stress relative to pain-free controls (Beaton et al. 1991). As shown in Table 7 multiple psychological measures were predictive to the risk of onset of TMJD.

Five psychological characteristics were also significantly correlated with pain sensitivity (trait anxiety, BSI depression, perceived stress and two POMS scores (confident-unsure and clearheaded-confused). Somatization, neuroticism, and CSQ increased behavioral were not correlated with pain sensitivity (i.e., summary z-score) but these items were associated with the risk of TMJD onset providing evidence that certain psychological measures act independently of pain sensitivity in predicting the onset of a somatosensory disorder.

Somatization, which is the tendency to report numerous physical symptoms in excess to that expected from physical exam (Escobar et al. 1987), is associated with more than a two fold increase in TMJD incidence, decreased improvement in TMJD facial pain after 5 years (Ohrbach & Dworkin 1998), and increased pain following treatment (McCreary et al. 1992). Somatization is also highly associated with widespread pain, the number of muscle sites painful to palpation (Wilson et al. 1994), and the progression from acute to chronic TMJD (Garofalo et al. 1998). The results provided by the present Example show that somatization, negative affect/mood, and environmental stress independently or jointly contribute to the risk of onset and maintenance of a common somatosensory disorder.

The significance of these findings is strengthened by the prospective cohort study design, which overcomes a major limitation of previous case-control studies of TMJD, and other somatosensory disorders, in which it has been unclear whether putative risk factors such as pain sensitivity, blood pressure, and psychological distress existed in subjects prior to the onset of a somatosensory disorder or arose as a consequence of it. Moreover, subjects in the present Example were diagnosed independently by examiners using RDC guidelines. This provides confidence that the elevated risk of TMJD is not simply an artifact of reporting bias among subjects found to be at elevated risk.

There are several significant clinical implications from these results. First, the present Example demonstrates that multiple neurological and psychological factors acting independently or jointly can contribute to the etiology of somatosensory disorders. Second, these multiple factors desirably should be taken into account when determining the clinical diagnosis and treatment options for the individual patient. Finally, since these factors are associated with a variety of genetic variables, the inclusion of genetic markers associated with neurological and psychological variables can further enhance the ability to clinically diagnose and determine treatment options for the individual patient (See e.g., Examples 2 and 3).

### Example 2

### Association Analysis Between Genotypes and Biological Factors Predictive for TMJD Development

Neurological and psychological factors that can contribute to somatosensory disorders are influenced by an individual's genetic composition and exposure to environmental factors (Diatchenko et al. 2006; FIG. 1). A defining feature of complex phenotypes, such as somatosensory disorders, is that no single locus contains alleles that are necessary or sufficient for disease (Pritchard 2001b; Pritchard and Przeworski 2001; Pritchard 2001a; Risch 2000). This suggests that the most efficient approach to study the genetics of complex somatosensory disorders is to examine the additive effect of polygenic variants of multiple functionally related groups of candidate genes (Comings et al. 2000).

Based on clinical and pharmacological data, it was hypothesized that the pathogenesis of somatosensory disorders such as TMJD is associated with genetic polymorphisms in several genes that influence pain sensitivity, resting arterial blood pressure, and psychosocial profiles (Diatchenko et al. 2006; FIG. 1). A sample of candidate genes that play a role in these pathways was selected (Table 6) to test this hypothesis. The associations between individual genotypes and both biological and psychological factors implicated in TMJD etiology (Keefe and Dolan 1986; Carlson et al. 1993; Vassend, Krogstad, and Dahl 1995; Oakley et al. 1989; Rammelsberg et al. 2003) were analyzed and correlations demonstrated, as disclosed in the present Example.

### Materials and Methods for Example 2

Subjects were recruited, phenotyped for pain sensitivity, resting arterial blood pressure, and psychosocial status as disclosed in Materials and Methods for Examples 1-3.

Genotyping. Two hundred and two enrollees consented to genotyping. Genomic DNA was purified from 196 subjects using QIAAMP® 96 DNA Blood Kit (Qiagen, Valencia, Calif., U.S.A.) and used for 5′ exonuclease assay (Shi et al., 1999). The primer and probes were used as described in (Belfer et al., 2004). The genotyping error rate was directly determined and was <0.005. Genotype completion rate was 95%. The Haploview™ program was used for haplotype reconstruction. Each candidate gene was genotyped at a density of approximately one SNP per 3 kb and each SNP in each gene was associated with measures of pain sensitivity (aggregated z-score), somatization scores (BSI somatization and PILL questionnaires), depression scores (BSI depression and Beck questionnaires), trait anxiety score (STAI 2), and blood pressure (systolic and diastolic blood pressure) using an ANOVA followed by post hoc analysis using the Simes procedure (Simes 1986) for multiple comparisons (Table 6). An association of a specific gene with a specific phenotype was considered significant if at least one SNP or haplotype was significantly associated with the measured phenotype.

### Results of Example 2

Twenty four of the initially assessed candidate genes showed significant associations with at least one of the examined putative risk determinants for TMJD onset (Table 6). Multiple polymorphisms (i.e., SNPs) in candidate genes were identified that were associated with pain sensitivity, somatization, depression, trait anxiety, and resting arterial blood pressure. These risk factors have been shown to be associated with somatosensory disorders (Example 1).

### Discussion of Example 2

The present subject matter provides evidence that there are two major domains that can contribute to the vulnerability of developing somatosensory disorders: enhanced pain sensitivity and psychological distress (Diatchenko et al., 2006; FIG. 1). Each of these domains can be influenced by specific genetic variants mediating the activity of physiological pathways that underlie pain amplification and psychological distress. Thus, individual polymorphic variations in genes coding for key regulators of these pathways, when coupled with environmental factors or exposures such as injury, physical stress, emotional stress, or pathogens interact with each other to produce a phenotype that is vulnerable to a somatosensory disorder.

Both clinical and experimental pain perception are influenced by genetic variants (Mogil 1999; Zubieta et al. 2003; Diatchenko et al. 2005). Although the relative importance of genetic versus environmental factors in human pain perception remains unclear, reported heritability for nociceptive and analgesic sensitivity in mice is estimated to range from 28% to 76% (Mogil 1999). Several recent studies have also established a genetic association with a variety of psychological traits and disorders that influence risk of developing somatosensory disorders. Twin studies show that 30%-50% of individual variability in the risk to develop an anxiety disorder is due to genetic factors (Gordon and Hen 2004). The heritability of unipolar depression is also remarkable, with estimates ranging from 40% to 70% (Lesch 2004). Moreover, normal variations in these psychological traits show substantial heritability (Exton et al. 2003; Bouchard, Jr. and McGue 2003; Eid, et al. 2003).

With advances in high throughput genotyping methods, the number of genes associated with pain sensitivity, resting arterial blood pressure and complex psychological disorders such as depression, anxiety, stress response and somatization has increased exponentially. A few examples of the genes associated with these traits include catechol-O-methyltransferase (COMT; Wiesenfeld et al. 1987; Gursoy, et al. 2003; Diatchenko et al. 2005), adrenergic receptor β2 (ADRB2; Diatchenko et al. 2006), serotonin transporter (5-HTT; Herken et al. 2001; Caspi, et a/2003; Gordon and Hen 2004), cyclic AMP-response element binding protein 1 (Zubenko et al. 2003), monoamine oxidase A (Deckert et al. 1999), GABA-synthetic enzyme (Smoller et a/2001), D2 dopamine receptor (Lawford, et al. 2003), glucocorticoid receptor (Wust et al. 2004), interleukines 1 beta and alpha (Yu et al. 2003), Na+, K+-ATPase and voltage gated calcium channel gene (Estevez and Gardner 2004).

The co-inventors have reported that the gene encoding COMT, an enzyme involved in catechol and estrogen metabolism, has been implicated in the onset of TMJD (Diatchenko et al. 2005). It was shown that three common haplotypes of the human COMT gene are associated with pain sensitivity and the likelihood of developing TMJD. Haplotypes associated with heightened pain sensitivity produce lower COMT activity. Furthermore, inhibition of COMT activity results in heightened pain sensitivity and proinflammatory cytokine release in animal models via activation of β2/3-adrenergic receptors (Nackley et al. 2006). Consistent with these observations, the co-inventor have has also determined that three major haplotypes of the human ADRB2 are strongly associated with the risk of developing TMJD, a common somatosensory disorder (Diatchenko et al. 2006).

The functional genetic variants shown in Table 6 can also be associated with other co-morbid somatosensory disorders and related signs and symptoms. For example, a common SNP in codon 158 (val158met) of COMT gene is associated with pain ratings, μ-opioid system responses (Rakvag, et al. 116), TMJD risk (Diatchenko et al. 2005), and FMS development (Gursoy, et al. 2003) as well as addiction, cognition, and common affective disorders (Oroszi and Goldman 2005). Common polymorphisms in the promoter of the 5-HTT gene are associated with depression, stress-related suicidality (Caspi et al. 2003), anxiety (Gordon and Hen 2004), somatization, and TMJD risk (Herken et al. 2001).

On the other hand, a defining feature of complex common phenotypes is that no single genetic locus contains alleles that are necessary or sufficient to produce a complex disease or disorder. A substantial percentage of the variability observed with complex clinical phenotypes can be explained by genetic polymorphisms that are relatively common (i.e, greater than 10%) in the population, although the phenotypic penetrance of these common variants is frequently not very high (Risch 2000). Thus, and without intending to be limited by theory, the varied clinical phenotypes associated with somatosensory disorders could be the result of interactions between many genetic variants of multiple genes. As a result, interactions among these distinct variants produce a wide range of clinical signs and symptoms so that not all patients show the same broad spectrum of abnormalities in pain amplification and psychological distress. Furthermore, environmental factors also play a crucial role in gene penetrance in multifactorial complex diseases. For example, functional polymorphism in the promoter region of the 5-HTT gene is associated with the influence of stressful life events on depression, providing evidence of a gene-by-environment interaction, in which an individual's response to environmental insult is moderated by his or her genetic makeup (Caspi et al. 2003).

Since each individual patient will experience unique environmental exposures and possess unique genetic antecedents to a somatosensory disorder, an efficient approach to identify genetic markers for somatosensory disorders or efficient therapeutic targets, is to analyze the interactive effects of polymorphic variants of multiple functionally related candidate genes. The complex interaction between these polymorphic variants can yield several unique subtypes of patients who are susceptible to a variety of somatosensory disorders. Recognition of the fact that multiple genetic pathways and environmental factors interact to produce a diverse set of somatosensory disorders, with persistent pain as a primary symptom, requires a new paradigm to diagnose, classify, and treat somatosensory disorders patients, which can be facilitated by the development of genetic tests associated with the genes listed in Table 4.

### Example 3

### Determination of Functional SNPS within the OPRM1 Gene Locus

μ-opioid receptor (MOR) is the major target of both endogenous and exogenous opiate and has been shown to mediate both baseline nociception and response to μ-opioid receptor agonists (Matthes et al., 1996; Sora et al., 1997; Uhl et al., 1999). Both animal and human studies have indicated that reduced basal nociceptive sensitivity is associated with greater opioid analgesia (Mogil et al/, 1999; Edwards et al., 2006), and suggested genetic polymorphisms in the human OPRM1 gene, which codes for MOR, are candidate sources of clinically relevant variability in opiate sensitivity and baseline nociception (Uhl et al., 1999; Han et al., 2004; Mogil, 1999). Several polymorphisms have been found in the promoter, coding and intron regions of the gene that are associated with several pharmacological and physiological effects mediated by MOR stimulation (for review see (Kitscg & Geusslinger, 2005). However, among SNPs with relatively high reported allelic frequency, which can mediate a significant degree of the variable clinical effects observed in a population, only the A118G OPRM1 SNP (Asp40Asn) has been repeatedly shown to have functional consequences. This missense SNP changes the N-terminal region amino acid asparagine to aspartic acid, which decreases the number of sites for N-linked glycosylation of the MOR receptor from five to four. The G allele is reported to increase the affinity of MOP receptor for β-endorphin by threefold (Bond et al., 1998). Several studies have demonstrated associations between the frequencies of the A118G OPRM1 genomic polymorphisms and several MOR-dependent phenotypes, including responses to opiates (Ikeda et al., 2005) and variations in pressure pain thresholds (Fillingim et al., 2005). However, only a small percentage of the variability of related phenotypes has been explained and conflicting and/or inconsistent results have been reported (Ikeda et al., 2005). Collectively, these findings suggest the existence of the other functional SNPs within OPRM1 gene locus and possibly within other yet undiscovered functional elements of the gene.

There is growing evidence from rodent studies that demonstrate an important role of alternatively-spliced forms of OPRM1 in mediating opiate analgesia (Pasternak, 2004). The synergistic activities of these splice variants has been proposed to explain the complex pharmacology of the μ-opioid (Pasternak, 2004). Yet, it is unclear whether the findings from the rodent studies are applicable to human opioid responses because there is a striking discrepancy between knowledge about genomic organization of mouse OPRM1 and genomic organization of human OPRM1. According to NCBI database, the mouse OPRM1 gene consists of 15 exons and codes for 39 alternative-spliced forms (Pasternak, 2004; Pan, 2005; Kvam et al., 2004). In contrast, the human OPRM1 gene consists of only 6 exons and codes for only 19 alternative-spliced forms (see NCBI database). The presence of a human analog of mouse exon 5 has been recently reported by Pan et al. (Pan et al., 2005). However, for the majority of exons of the mouse OPRM1 gene, no human homologue has been identified. It is suggested herein that all 15 of the reported mouse exons, or a substantial number of these exons, should have analogous exons within the human OPRM1 gene locus.

In the present Example, it is shown that human OPRM1 gene is more complex than presently appreciated and is analogous to the complexity of the mouse OPRM1 gene. It is further shown that SNPs commonly present in the human population within these newly identified human OPRM1 exons are associated with human pain perception and can modify function of the receptor. The present Example demonstrates that the analgesic efficacy and/or side effect profile of opioids is strongly associated with the identified functional OPRM1 polymorphisms.

### Materials and Methods for Example 3

Methods for subject requirements, pain phenotyping, blood pressure measuring and genotyping procedures are presented in Materials and Methods for Examples 1-3.

Computer modeling. Orthologous genomic regions of human and mouse genomes were compared and the locations of the initial and the terminal exons boundaries using programs were identified using BLAST (Altschul et al., 1997), BLAT, GENSCAN (Burge & Karlin, 1997); and OWEN (Ogurtsov et al., 2002).

Statistical analyses. Associations with each of the SNPs were evaluated for 202 genotyped subjects using ANOVA and Tukey PostHoc test.

### Results of Example 3

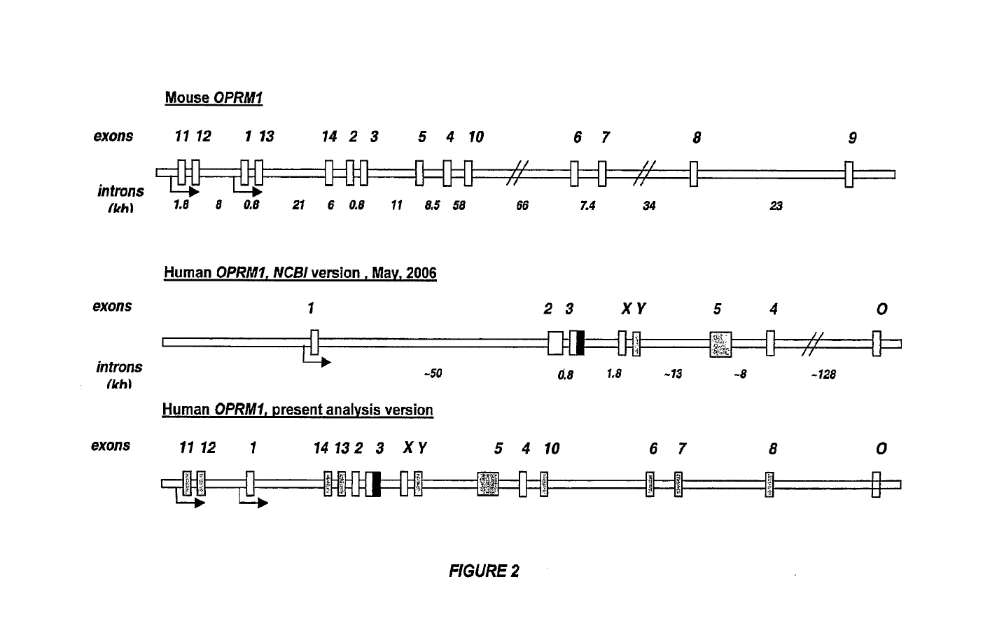

New exons in the human OPRM1. To identify the human analogues of mouse OPRM1 exons, the pattern of similarity within the OPRM1 genes and their sequences with GENBANK® were analysed and the synteny of the compared long sequences with BLAST (Altschul et al., 1997) and BLAT confirmed. GENBANK® annotations, patterns of similarity in interspecies alignments, and GENSCAN (Burge & Karlin, 1997) were used to find the corresponding human and mouse exons, and to refine locations of the initial and terminal exons in both species. This approach permitted finding of putative sites of initiation and termination of transcription. In all cases, alignments supported putative exons that were presented in GENBANK® annotations. Because similarities between low complexity sequences and repetitive sequences obscured the pattern of orthology, these sequences were masked using REPEATMASKER™ (Institute for Systems Biology, Seattle, Wash., U.S.A.). The nucleotide sequence alignment for the OPRM1 orthologous pairs of mRNA and genome sequences were produced using OWEN (Ogurtsov et al., 2002). Six alternative spliced forms of mouse OPRM1 were used that covered the known expressed exons: MOR-1B, MOR-1F, MOR-1I, MOR-1J, MOR-1K and MOR-1L (Pasternak, 2004). For each of the mouse exons, orthologous human exons were found, with the highest homology for exons 5 and 11 (FIG. 2).

Selection of the new candidate SNPs. Having established the areas of exonic conservation within the OPRM1 gene locus, a set of candidate SNPs that potentially cover all functional allelic diversity of the gene including newly identified exonic and promoter regions was selected. SNPs were selected based on the following three criteria. First, the choice was restricted based on the frequency of the SNP because abundant SNPs with a minor allele frequency in the population of >0.15 rather than rare mutations are more likely to contribute to complex traits like pain responsiveness and blood pressure (Risch, 2000), which are two phenotypic variables that are mediated by OPRM1 activity. Second, SNPs were chosen that are most likely to impact gene function, which are SNPs in the coding region, exon-intron junctions, 5′ promoter regions, putative transcription factor binding sites (TFBS) and 3′ and 5′ untranslated regions (UTRs). Third, equally spaced SNPs were chosen to represent the haplotype structure of the OPRM1 gene (Gabriel et al., 2002).

Table 8 presents a summary of the characteristics and potential functional significance of the selected SNPs. Both the NCBI database and published data were used to construct Table 8. SNPs in the transcribed region with a known frequency of the minor allele of no less that 15% were first identified. If the frequency of minor allele was not available, SNPs in the transcribed regions that have been reported in both NCBI and CELERA databases were chosen.

TABLE 8
CANDIDATE POLYMORPHISM IN OPRM1 GENE LOCUS

| | | | | | specific for | | | |
|---|---|---|---|---|---|---|---|---|
| | | | | specific for | human | | | |
| | | | | mouse | OPRM1 | | MIF | |
| | | | | OPRM1 slice | slice | | reported | actual |
| # | NSBI SNP ID | Variation | Location | variant | variant | Potential functional significance | by NCBI | MIF |
| 1 | rs1294094 | A > T | 5′ intragenic | mMOR-1G-N | N/A | 1kb upstream of conservation for | 0.458 | 0.493 |
| | | | | | | exon 11 | | |
| 2 | rs1319339 | A > G | 5′ intragenic | mMOR-1G-N | N/A | 700 nt upstream of conservation | 0.133 | 0.16 |
| | | | | | | for exon 11 | | |
| 3 | rs7776341 | A > C | 5′ intragenic | mMOR-1J | N/A | within human analog of mouse | 0.133 | 0.042 |
| | | | | | | exon 12^{th} | | |
| 4 | rs1074287 | A > G | 5′ intragenic | mMOR-1J | N/A | in human analog of mouse exon | 0.208 | 0.264 |
| | | | | | | 12^{th} | | |
| 5 | rs1799971 | Asp40Ans | 1^{st} exon | all excluding | all exp | Nonsynonymous | 0.145 | 0.131 |
| | | | | mMOR1-K-L | mu3 | | | |
| 6 | rs524731 | C > A | 1^{st} intron | | | | 0.292 | 0.17 |
| 7 | rs495491 | C > T | 1^{st} intron | | | | ?? | 0.267 |
| 8 | rs1381376 | G > A | 1^{st} intron | | | | 0.152 | 0.174 |
| 9 | rs3798678 | A > G | 1^{st} intron | mMOR1-L | N/A | within human analog of mouse | 0.15 | 0.16 |
| | | | | | | exon 14th | | |
| 10 | rs563649 | G > A | 1^{st} intron | mMOR1-K | N/A | in human analog of mouse exon | 0.083 | 0.078 |
| | | | | | | 13th | | |
| 11 | rs9322446 | G > A | 1^{st} intron | mMOR1-K | N/A | within human analog of mouse | 0.158 | 0.169 |
| | | | | | | exon 13th | | |
| 12 | rs2075572 | C > G | 2^{nd} intron | | | | 0.438 | 0.386 |
| 13 | rs533586 | A > G | 3d intron | mMOR1-E-F | N/A | Close proximity to human | 0.264 | 0.238 |
| | | | | | | analog of mouse exon 15th | | |
| 14 | rs540825 | His464Gln | exon X | N/A | hMOR1-X | nonsynonymous | 0.355 | 0.238 |
| 15 | rs675026 | Gly503Gly | exon X | N/A | hMOR1-X | synonymous | 0.417 | 0.341 |
| 16 | rs660756 | A > C | exon Y | mMOR1-C- | hMOR1-Y | 3′ UTR | 0.333 | 0.352 |
| | | | | F, M, N, S | | | | |
| 17 | rs677830 | stop388Gln | exon 5 | mMOR1-B | hMOR-1B | nonsynonymous | 0.207 | 0.236 |
| 18 | rs650245 | C > T | exon 5 | mMOR1-B | hMOR-1B | 3′ UTR | 0.206 | 0.103 |
| 19 | rs623956 | T > C | exon 5 | mMOR1-B | hMOR-1B | 3′ UTR | 0.371 | 0.414 |
| 20 | rs609148 | C > T | exon 5 | mMOR1-B | hMOR- | 3′ UTR | 0.214 | 0.233 |
| | | | | | 1B, Y | | | |
| 21 | rs497332 | C > G | exon 5 | mMOR1-B | hMOR- | 3′ UTR | ?? | |
| | | | | | 1B, Y | | | |
| 22 | rs648893 | C > T | 3d intron | | | | 0.203 | 0.229 |
| 23 | rs7759388 | G > A | 4^{th} intron | N/A | hMOR-1O | 20 nt before exon O | 0.209 | 0.141 |
| 24 | rs9322453 | G > C | 3′ intragenic | N/A | hMOR-1O | 150 nt after exon O | 0.388 | 0.402 |

For the predicted exons, regions flanking the ˜400 nt of the conservation zone were also considered. Several abundant SNPs in the intronic regions at an interval of ˜10 kb were also chosen to be either a surrogate for functional alleles, which are in the same haploblock, moderately abundant and effective but yet unknown, or to be a candidate for the functional SNP situated within an unidentified exon. SNPs within OPRM1 gene locus were evaluated with the emphasis on the newly identified exons and promoter sites.

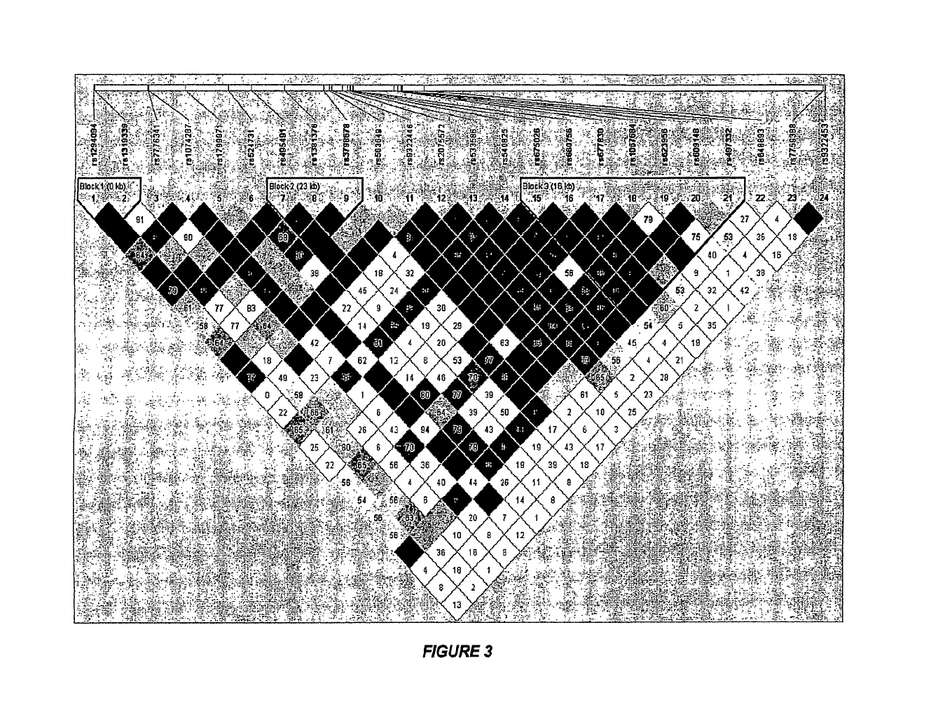

Genotyping of OPRM1. Genotyping data were collected from 196 healthy Caucasian female volunteers, participating in the prospective cohort study that was sought to determine factors contributing to inter-individual variability in pain perception and development of persistent pain states. Twenty eight SNPs were examined, of which 4 (rs1323040, rs7775848, rs1799972, and rs1042753) were found to be monomorphic and were not considered in subsequent analyses. The remaining 24 SNPs were analyzed (Table 8). The linkage disequilibrium (LD) between paired SNPs was analyzed for significance using the HAPLOVIEW™ program. The derived D′ values are presented in FIG. 3, where a D′ value of 0.0 implies independence, and a value of 1.0 implies dependence.

Association analysis between selected SNPs, pain sensitivity, and blood pressure. Each participant in the analyzed cohort was quantified for responsiveness to a variety of noxious stimuli applied to various anatomical sites (Diatchenko et al. 2005). The stimuli elicit both cutaneous and deep muscle pain which are transmitted and modulated by different neural mechanisms (Yu et al., 1991; Yu & Mense, 1990; Mense, 1993). Resting systolic and diastolic blood pressures were also measured on the right arm with an automatic blood pressure monitor because resting blood pressure has been shown to be association with pain sensitivity (Bruehl & Chung, 2004) and opioid peptides and their receptors have established roles in cardiovascular regulation (Rao et al., 2003). Furthermore, hypotension is commonly associated with opioid analgesia (Bruehl & Chung, 2004). It was hypothesized that functional genetic polymorphisms in OPRM1 would be associated with population variations in experimental pain sensitivity and blood pressure.

The relationship between individual OPRM SNPs and pain phenotypes associated with each homozygous and heterozygous genotype (3 points) were tested by Analysis of Variance (ANOVA) (Table 9). Statistically significant associations were found between several measures of heat pain sensitivity, pressure pain sensitivity, average systolic blood pressure and SNP rs563649 (ANOVA, P<0.05). Next, associations were found between the heat pain tolerance (foot), average systolic and diastolic blood pressure and two SNPs: rs1074287 and rs495491 (ANOVA, P<0.05). The association was stronger for rs1074287. Because these two SNPs are in a strong LD (FIG. 3) it is suggested that association is defined by the functional SNP is rs1074287 and that SNP rs295491 was a marker of this association. SNP rs1319339 was significantly associated with mean resting heart rate values (ANOVA, P<0.05) and is marginally associated with average resting diastolic blood pressure (ANOVA, P=0.089). Finally, variations in resting diastolic blood pressure, but not in resting systolic blood pressure were associated with SNPs rs677830 and rs609148 (ANOVA, P<0.01). The remaining SNPs, including nonsynonymous polymorphisms Asn40Aps, did not contribute significantly (P>0.10) to the variance in pain sensitivity or blood pressure. Thus, six new functional (i.e. pain-related) polymorphisms along the OPRM1 gene—rs1319339, rs1074287, rs495491, rs563649, rs677830 and rs609148 have been identified.

TABLE 9
P-VALUES OF THE ASSOCIATION ANALYSIS BETWEEN 16 OPRM1 SNPS AND
VARIATION IN PAIN SENSITIVITY AND BLOOD PRESSURE

| | Measured pain phenotypes* | | | | | | | | | |
|---|---|---|---|---|---|---|---|---|---|---|
| SNP rs ID | Pressure 1 | Pressure 2 | Pressure 3 | Pressure 4 | Heat 2 | Heat 3 | Heat 6 | Avgsbp | Avgdbp | Avghr |
| 1294094 | 0.679 | 0.864 | 0.457 | 0.668 | 0.687 | 0.188 | 0.342 | 0.394 | 0.065 | 0.471 |
| 1319339 | 0.585 | 0.842 | 0.659 | 0.690 | 0.548 | 0.300 | 0.139 | 0.969 | 0.089 | 0.025 |
| 7776341 | 0.522 | 0.834 | 0.537 | 0.991 | 0.739 | 0.305 | 0.363 | 0.234 | 0.215 | 0.126 |
| 1074287 | 0.872 | 0.831 | 0.819 | 0.810 | 0.109 | 0.281 | 0.034 | 0.012 | 0.031 | 0.440 |
| 1799971 | 0.642 | 0.877 | 0.766 | 0.868 | 0.592 | 0.995 | 0.640 | 0.377 | 0.817 | 0.217 |
| 524731 | 0.713 | 0.764 | 0.933 | 0.892 | 0.536 | 0.375 | 0.122 | 0.196 | 0.113 | 0.056 |
| 495491 | 0.917 | 0.775 | 0.830 | 0.992 | 0.232 | 0.461 | 0.042 | 0.049 | 0.040 | 0.593 |
| 1381376 | 0.602 | 0.667 | 0.299 | 0.233 | 0.820 | 0.079 | 0.597 | 0.104 | 0.271 | 0.344 |
| 563649 | 0.062 | 0.071 | 0.060 | 0.045 | 0.042 | 0.045 | 0.016 | 0.014 | 0.472 | 0.378 |
| 2075572 | 0.505 | 0.243 | 0.065 | 0.429 | 0.200 | 0.455 | 0.249 | 0.765 | 0.396 | 0.096 |
| 677830 | 0.520 | 0.462 | 0.521 | 0.781 | 0.305 | 0.656 | 0.739 | 0.334 | 0.002 | 0.103 |
| 1067684 | 0.491 | 0.393 | 0.419 | 0.355 | 0.315 | 0.429 | 0.825 | 0.494 | 0.672 | 0.774 |
| 609148 | 0.663 | 0.741 | 0.540 | 0.849 | 0.491 | 0.704 | 0.988 | 0.587 | 0.004 | 0.133 |
| 497332 | 0.548 | 0.524 | 0.300 | 0.258 | 0.689 | 0.683 | 0.699 | 0.600 | 0.715 | 0.952 |
| 648893 | 0.381 | 0.109 | 0.514 | 0.513 | 0.888 | 0.692 | 0.866 | 0.692 | 0.614 | 0.192 |

*Pain-related phenotypes are indicated as: Pressure 1 - average pressure pain threshold at wrist; Pressure 2 - average pressure pain threshold at temporalis muscle; Pressure 3 - average pressure pain threshold at masseter muscle; Pressure 4 - Average pressure pain threshold at TMJ muscle; Heat 2 - average heat pain tolerance at arm; Heat 3 - average heat pain threshold at check; Heat 6 - average heat pain tolerance at foot; Avgsbp—average systolic blood pressure; Avgdbp—average diastolic blood pressure; Avghr—average heart rate.

### Discussion of Example 3

Evidences for multiple subtypes of human MOR. The complex pharmacology of the μ-opioid has been recognized (Pasternak, 2004). At least two major MOR subtypes, μ₁ and μ₂, have been proposed by a variety of receptor binding and pharmacological studies (Wolozin & Pasternak, 1981). The naloxonazine-sensitive μ₁-receptor subtype is thought to play an important role in supraspinal analgesia, whereas the naloxonazine-insensitive μ₂-receptor subtype mediates spinal analgesia, respiratory depression and inhibition of gastrointestinal transit (Stefano et al., 2000; Pasternak, 2001a; Pasternak, 2001b). Furthermore, significant variations in responses to different μ-opioids among patients, where a given patient responds better to one μ-opioid compared to another has been reported (Galer et al., 1992). Similar observations have been made from rodent studies that have shown strain differences to the sensitivity of different opioids (Flores & Mogil, 2001; Narita et al., 2003). Furthermore, clinicians have long exploited the incomplete cross-tolerance among μ-opioid agonist by use of opioid rotation where highly tolerant patients are rotated to a different μ-opioid receptor agonist to regain analgesic sensitivity (Cherny et al., 2001). Incomplete cross-tolerance can also be illustrated in animal models (Pasternak, 2004; Pasternak, 2001a; Pasternak, 2001b).

These lines of evidence suggest the existence of multiple subtypes of MOR. A number of functional animal studies that have employed in vitro cell expressing models, antisense mapping and gene knockout strategies attributed these heterogeneous responses to multiple alternatively spliced forms of OPRM1 (Pasternak, 2004). The mouse OPRM1 spans over 250 kb and contains at least 15 exons, coding for over 39 alternatively spliced forms (Unigene data, (Pasternak, 2004; Kvam, 2004)). These alternatively spliced forms differ only in their 5′ and 3′ exons that code for N- or C-terminus of receptor, keeping the core seven-transmembrane domain constant and preserving the receptor specificity for p opioids. A number of important findings have confirmed the functional significance of these multiple alternatively-spliced forms of OPRM1. In knockout mice with a specific disruption of exon 1 morphine analgesia is loss, but retains both M6G and heroin induced analgesia (Schuller et al., 1999). MOR-1B-knockdown CXBK mice show reduced antinociceptive responses to endomorphin-1 compared to wild-type C57BL/6 mice. It has been shown that treatment with antisense oligodeoxynucleotide against exon 5 of OPRM1 produces a specific reduction in the expression of MOR-1B mRNA and a significant suppression of the endomorphin-1-induced antinociception (Narita et al., 2003). Furthermore, cell expression studies have demonstrated that there is marked differences in the ability of different opioids to stimulate [³⁵S]GTPγS binding in cell lines that express different MOR splice variants. The potency (EC₅₀) of some of the drugs also vary extensively among spliced variants, with a poor correlation between the potency of the drugs to stimulate [³⁵S]GTPγS binding and their binding affinities (Bolan et al., 2004). Together, these findings reveal marked functional differences among the MOR variants in mice and suggest that clinical variability in response to p opioids in humans may originate from common polymorphic variants in these 5′ and 3′ alternative exons, rather than from the core seven-transmembrane domain coding exons 1, 2 and 3. However, the majority of human analogues of mouse 5′ and 3′ alternative exons have not been reported prior to the presently disclosed subject matter (FIG. 2).

Expansion of human OPRM1 gene structure. The striking discrepancy between reported exonic organization of the mouse OPRM1 and human OPRM1 raises the possibility of undiscovered exons within the human OPRM1 gene locus that are homologous to the mouse OPRM1. Underrecognition of the exonic structure of the human OPRM1 gene can be attributed to several methodological problems related to studying the human OPRM1 gene. First, this gene is in low abundance and is expressed at lower level in humans compared to mice. Moreover, different alternatively splice forms of OPRM1 are expressed in a anatomically-specific and cell type specific manner (Pasternak, 2004). There are only 11 human OPRM1 ESTs in NCBI databases compared to 47 mouse ESTs (NCBI, Unigene databases). Taking into account that there are about 2 times higher numbers of human ESTs in the NCBI dbEST database compared to mouse ESTs, OPRM1 is expressed at about a 10 fold higher level in mice. Consequently, there is very little information regarding the expressed human OPRM1 RNA variants in the NCBI databases suggesting that this gene is very difficult to clone or even amplify. Second, the 5′ and 3′ OPRM1 exons are very short. For example, exon 7 spans only 88 nucleotides and exon 11 spans only 97 nucleotides. Furthermore, these exons code for only a small portion of the total MOR protein. These two features make employment of standard alignment programs like BLAST or BLAT inefficient in terms of recognising the interspecies homology of these exons.

The OWEN program was employed in the present Example, which uses alternative algorithm for homology searching (Ogurtsov et al., 2002). The regions of nucleotide similarity between exons of the well-studied OPRM1 alternatively-spliced forms summarized in the recent review of Pasternak (Pasternak, 2004) and human genomic DNA were searched.

Homologous regions were found for each mouse exons with the human OPRM1 gene locus, including 9 exons that have not been previously identified in the human OPRM1. These exons correspond to mouse exons 6-14 (FIG. 2). The screening of the common polymorphism within the region of exonic conservation can yield potentially clinically important SNPs associated with MOR function and alteration in opioids responses, and serves as indirect evidence of functional importance of newly identified exons.

Potential mechanism of alteration of OPRM1 function by identified SNPs. Prior to the present disclosure, the most consistent and reliable demonstration of functional polymorphism within the OPRM1 gene locus had been reported for only SNP rs1799971, which codes for the well-studied common nonsynonymous polymorphisms Asn40Aps. This SNP has been shown to alter β-endorphin binding and receptor activity (Bond et al., 1998). Carriers of the mutant Asp allele: 1) need more alfentanil for postoperative pain relief (Caraco, 2001); 2) need more morphine for cancer pain treatment (Klepstad et al., 2004), 3) show decreased miotic responses to morphine (Skarke et al., 2003) and morphine-6-glucuronide (M6G) (Skarke et al., 2003; Lotsch et al., 2002); 4) show increased demands for M6G to produce analgesia but less frequent vomiting despite slightly higher doses of M6G (Skarke et al., 2003); 5) show good tolerance of high M6G plasma concentrations during morphine therapy; 6) show decreased analgesic responses to morphine (Hirota et al., 2003) and M6G (Romberg et al., 2004); and 7) show an impaired responsiveness of the hypothalamic-pituitary-adrenal axis to opioid receptor blockade (Wand et al., 2002; Hernandez-Avila et al., 2003). Recently, Fillingim et al. showed that human subjects carrying the G allele report significantly higher pressure pain thresholds than homozygous for the A allele (Fillingim et al., 2005). The present data are in agreement with this observation, homozygotes for G allele have the lowest mean values for mechanical pain thresholds and homozygotes for A allele have the highest mean values for mechanical pain thresholds. However, this difference was only marginally significant. Importantly, the association observed by Fillingim et al. achieved statistical significance only among males but not females and the present cohort included only females.

Statistically significant associations in the present Example were observed for six SNPs situated within the OPRM1 gene locus: rs1319339, rs1074287, rs495491, rs563649, rs677830 and rs609148. According to the NCBI database, all these SNPs are in the introns of OPRM1. However, based on the presently disclosed prediction, all of these SNPs, except of rs495491, are situated within areas of mouse-human exonic conservation. To predict how alterations in these nucleotides can change receptor function, the position of the SNPs relative to existing promoters and exons was inspected.

The strongest association with pain phenotypes and blood pressure observed was for rs563649 (Table 9). The SNP rs563649 is situated in the area of conservation of mouse exon 13. Functional associations of SNPs within exons 13 with pain perception suggest the presence of alternatively spliced forms containing human homologs of mouse exon 13 and 14. Mouse splice variants containing exons 13 and 14 start from exon 11 and lack exon 1. The transcription of these mouse RNA variants are initiated by an alternative promoter situated upstream of exon 11 (FIG. 2). This suggests the existence of human homologs of both mouse exon 11 and a second alternative promoter upstream of exon 11. The presence of human OPRM1 variants without exon 1 can be of considerable clinical importance since exon 1 knockout mice demonstrate loss of morphine analgesia but retain M6G and heroin analgesia (Schuller et al., 1999). An alternative possibility for the functional effect of SNP s563649 could be related to its likely regulation of MOR-3 expression. Recently, Cadet et al. reported a new splice variant of the OPRM1 gene called MOR-3, which begins at exon 2 of the OPRM1 gene (Cadet et al., 2003). The SNP rs563649 is situated 3 kb upstream of exon 2 and is within the promoter region of MOR-3. Consequently, SNP rs563649 can possibly affect the transcription efficiency of MOR-3 RNA. However, some reservations exist regarding the interpretation of the findings by Cadet and co-workers: i) the authors did not show promoter activity in the up-stream genomic region 2; ii) the start of translation of MOR-3 variant, the first ATG codon, is situated within 10 nt of the transcriptional start site which makes 5′UTR unusually short; iii) although over 30 splice variants of mouse OPRM1 have been reported, a transcriptional start site at the beginning of exon 2 has not been identified; and iv) the presence of a functional promoter of a MOR-3 was examined in the inventor's laboratory by cloning a 3.5 kb genomic DNA region upstream of the exon 2 into a pGL3 basic luciferase reporter vector. Luciferase activity after transient transfection of the promoter construct into PC-12 cells was not detected, suggesting the absence of a functional promoter upstream to exon 2. Thus, it can be concluded that SNP rs563649 is unlikely to affect the promoter activity of OPRM1. Furthermore, as noted hereinabove, there are no common SNPs in the other 3 exons of OPRM1 that are in high LD with SNP rs563649 that can explain the observed associations. Collectively, these findings provide evidence that association of SNP rs563649 with pain ratings and systolic blood pressure is related to its position within exon 13.

Other SNPs showing a significant association with pain ratings and blood pressure were SNPs rs1074287 and rs495491, both of which showed similar patterns of association (Table 9). From two SNPs situated within homologous regions of exon 12, only SNP rs1074287, but not rs7776341 was associated with the assessed phenotypes. Importantly, SNP rs1074287 is situated in the middle of the conserved region, while SNP rs7776341 is situated 100 nt up-stream of conserved region, suggesting that this region of DNA is functionally important. SNP rs495491 can not be attributed to any of the newly identified exons. However, SNP rs495491 is in high LD with SNP rs1074287, and it is plausible that it serves as a surrogate marker of the functional SNP rs1074287. Existence of a human analog of mouse exon 12 implies the existence of a human analog of mouse exon 11 and a second alternative promoter upstream to exon 11 (Pasternak, 2004): similar to exon 13, mouse RNA transcript containing exon 12 starts from exon 11. However, strong associations between SNPs situated within exon 11 region and the assessed pain-related phenotypes were not observed, except for SNP rs1319339 that was significantly associated with mean resting heart rate (ANOVA, P<0.05) and showed a marginal association with average resting diastolic blood pressure (ANOVA, P=0.089). Because the conservation between human and mouse genomic DNA was very significant for exon 11, human exon 11 can be concluded to have been identified with a high degree of accuracy. Importantly, the absence of functional SNPs in this region does not imply the absence of exon 11.

Additional SNPs that showed significant association were SNPs rs677830 and rs609148. These two SNPs are situated in exon 5, which was predicted by the present model and recently reported by Pan et al. (Pan et al., 2005). Human exon 5 spans almost 3 kb (Pan et al., 2005) and, besides the three tested SNPs rs677830, rs1067684 and rs609148, covers at least 13 other SNPs. SNP rs677830 creates a new stop codon, and two other tested SNPs rs1067684 and rs609148 are in the 3′UTR region of exon 5. Both SNPs rs677830 and rs609148, but not SNP rs1067684, are strongly associated with variations in resting diastolic blood pressure. Because these SNPs, but not rs1067684, are in high LD, it is possible that only one of these SNPs is functional. These data suggest that the MOR spliced form within exon 5 can modify resting diastolic blood pressure, and these identified SNPs can be associated with rapid onset hypotension, recognized as one of the adverse effect associated with of p opioids. Furthermore, CXBK mice that are considered as MOR-1B-knockdown mice, under-expressing OPRM1 variant with exon 5, were not assessed for resting blood pressure. However, these mice showed reduced antinociceptive responses to endomorphin-1. This provides a strong rationale for testing SNPs rs677830 and rs609148 for association with human variations in responses to p opioid receptor agonists.

MOR-dependent phenotypes. Although a clinical interest in the OPRM1 gene relates to individual differences in the efficiency of opiate analgesia, tolerance and dependence, there are number of other nociception-related and behavioral phenotypes that are firmly dependent on MOR activity. Since endogenous opioid peptides, such as endomorphins, enkephalins and endorphins, and endogenous morphine are normally synthesized in animal tissue (Stefano et al., 2000), individual differences in the sensitivity to these endogenous ligands of the MOR receptor can be associated with differences in pain sensitivity and emotion (Ikeda et al., 2005). Basal nociceptive sensitivity is increased in MOR knockout mice compared with that in wild-type mice, without the presence of opiates (Sora et al., 1997).

Furthermore, MOR activity has been attributed to stress responses and OPRM1 polymorphisms have been associated with basal cortisol levels, cortisol responses to opioid peptide receptor blockade, and cortisol responses to stimulation by adrenocorticotropic hormone (ACTH) (review see (Ikeda et al., 2005)). Diseases that have been associated with OPRM1 polymorphisms in at least one study include schizophrenia, epilepsy and other psychogenic disorders (for a review see Ikeda et al., 2005).

It is suggested that functional polymorphisms within OPRM1 gene can affect a spectrum of MOR-dependent phenotypes. In the present association study, two phenotypes were used as surrogate parameters of both central and peripheral nervous opioid effects: sensitivity to experimental painful stimuli and resting blood pressure. In fact, it has been suggested that studies on human research volunteers who receive carefully controlled thermal, electrical or mechanical noxious stimuli should be conducted for association studies with the OPRM1 gene since these experimental approaches may significantly reduce the influences of non-genetic factors that are associated with many persistent or chronic pain states (Ikeda et al., 2005).

The present association analysis between allelic variations within the extended version of OPRM1 and inter-individual variability in these phenotypes identified new functional SNPs in the human OPRM1 gene. It is suggested by the present data that these SNPs can be important markers of multiple phenotypes and complex diseases, with a much broader spectrum of phenotypes than just opioid analgesia, pain perception or blood pressure.

Collectively, the present data strongly suggest the presence of new exons within the human OPRM1 gene locus which are the likely source of new clinically relevant splice variants and newly identified functional SNPs within the OPRM1 gene locus. In addition to the potential significance of these findings in our understanding of the basic biology of the MOR, these results are believed to be of considerable clinical importance and can facilitate the development of new approaches for the prediction of analgesic efficacy and side effect profiles of opioids used in clinical practice.

### REFERENCES

The references listed below, as well as all references cited in the specification, are incorporated herein by reference to the extent that they supplement, explain, provide a background for, or teach methodology, techniques, and/or compositions employed herein.
Aaron et al., Archives of Internal Medicine 160:221-7, 2000.
Abiola et al. (2003) Nat. Rev. Genet., 4, 911-916.
Akaike, H. (1974) IEEE Trans. Biomed. Engin., AU-19, 716-722.
Aley, K. O. et al., J Neurosci 21, 6933-9 (2001).
Altschul, S. F. et al., Nucleic Acids Res. 25, 3389-3402 (1997).
Aston-Jones et al., (1999) Biol. Psychiatry, 46, 1309-1320.
Beaton et al., (1991) Journal of Prosthet Dent 65:289-293.
Beck, et al., (1961) Arch. Gen. Psychiatry, 4, 561-571.
Belfer et al., (2004) Eur. J. Hum. Genet.
Berkow et al., (1997) The Merck Manual of Medical Information, Home ed. Merck Research Laboratories, Whitehouse Station, N.J.
Bolan et al., Synapse 51, 11-18 (2004).
Bond, C. et al., Proc. Natl. Acad. Sci. U.S. A 95, 9608-9613 (1998).
Bortoluzzi & Danieli, (1999) Trends Genet, 15, 118-119.
Bouchard & McGue, J. Neurobiol. 2003. Jan., (1954) 445.
Box & Cox (1964) Journal of the Royal Statistical Society, 26, 211-252.
Bradley et al., Current Opinion Rheumatology 14:45-51, 2002.
Bradley & McKendree-Smith, Curr. Opin. Rheumatol., 14 (2002) 45-51.
Bragdon, E. E. et al. Pain 96, 227-237 (2002).
Bray et al., Am. J. Hum. Genet., 2003; 73:152-161.
Bray et al., (2000) Circulation, 101, 2877-2882.
Brodde & Michel, M. C. (1992), J. Hypertens. Suppl, 10, S133-S145.
Bruehl & Chung, O. Y. (2004) Neurosci. Biobehav. Rev., 28, 395-414.
Burge & Karlin, J. Mol. Biol. 268, 78-94 (1997).
Busjahn et al., (2002) Biol. Psychol., 61, 97-109.
Cadet et al., J. Immunol. 170, 5118-5123 (2003).
Camu & Vanlersberghe, Best. Pract. Res. Clin. Anaesthesiol. 16, 475-488 (2002).
Caraco, Clinical Pharmacology & Therapeutics 69, 63 (2001).
Carlson et al., Jour. of Orofacial Pain 7, 15-22 (1993).
Carlsson & Le Resche (1995) In Sessle, B. J., Bryant, P. S., and Dionne, R. A. (eds), Temporomandibular Disorders and Related Pain Conditions. IASP Press, Seattle, Vol. 4, pp. 211-226.
Caspi et al., Science, 301 (2003) 386-389.
Chandra, G. et al., J Immunol 155, 4535-43 (1995).
Chaplan et al., J Neurosci Methods 53, 55-63 (1994).
Chaplan et al., (1994) J. Pharmacol. Exp. Ther., 269, 1117-1123.
Cherny, N. et al., J. Clin. Oncol. 19, 2542-2554 (2001).
Cohen et al., J. Health Social Behavior. 1983; 24:385-396.
Comeron, J. M. (2004) Genetics, 167, 1293-1304.
Comings D E et al. (2000) Clin. Genet. 57 (3):178-196.
Coppack, Proc Nutr Soc 60, 349-56 (2001).
Cunha, T. M. et al., Proc Natl Acad Sci USA 102, 1755-60 (2005).
Dao et al., Pain 1994; 56:85-94.
Deckert et al., Hum. Mol. Genet., 8 (1999) 621-624.
DeMille et al., (2002) Hum. Genet, 111, 521-537.
Derogatis & Melisaratos (1983) Psychol. Med., 13, 595-605.
Diatchenko et al., Pain. 2006 August; 123(3):226-30.
Diatchenko, L. et al., Hum. Mol. Genet. 14, 135-143 (2005).
Diatchenko et al., Am J Med Genet B Neuropsychiatr Genetics, (2006), in press.
Drangsholt & LeResche, Temporomandibular disorder pain. In Crombie I K, Croft P R, Linton S J, LeResche L, Von Korff M, editors. Epidemiology of Pain. Seattle: IASP Press, 1999.
Drysdale et al., (2000) Proc. Natl. Acad. Sci. U.S.A, 97, 10483-10488.
Duan et al., (2003) Hum. Mol. Genet., 12, 205-216.
Duch et al., (1998) Toxicol. Lett. 100-101:255-263.
Duguay et al., Clin. Pharmacol. Ther. 75, 223-233 (2004).
Dworkin & LeResche, J. Craniomandibular Disorders 1992; 6:302-355.
Easton & Sherman, (1976) Arch. Neurol., 33, 689-691.
Ebadi (1998) CRC Desk Reference of Clinical Pharmacology. CRC Press, Boca Raton, Fla.
Edwards et al., Anesthesiology 104, 1243-1248 (2006).
Eid et al., J. Pers. 2003. Jun., (1971) 319-346.
Elenkov et al., Pharmacol Rev 52, 595-638 (2000).
Enoch et al., Psychiatr Genet. 2003; 13:33-41.
Escobar J I et al. (1987) Arch. Gen. Psychiatry 44 (8):713-718.
Estevez, M. and Gardner, K. L., Hum. Genet., 114 (2004) 225-235.
Exton et al., Neuroreport. 2003. Mar. 3, 531-533.
Fagius, A. N., Wahren, L. K. (1981) J. Neural. Sci., 51, 11-27.
Fillingim, R. B. et al., J. Pain 6, 159-167 (2005).
Fillingim & Maixner, W. (1996) Psychosomatic Med., 58, 326-332.
Fillingim et al., (1998) International Journal of Psychophysiology, 30, 313-318.
Fillingim et al., The Clinical Journal of Pain 12, 260-269 (1996).
Flores & Mogil, Pharmacogenomics. 2, 177-194 (2001).
Freireich et al., (1966) Cancer Chemother Rep. 50:219-244
Fruhstorfer et al., (1976) J. Neurol., Neurosurg., & Psych., 39, 1071-1075.
Gabriel et al., (2002) Science, 296, 2225-2229.
Gaiddon et al., (1999) J. Neurochem., 73, 1467-1476.
Galer et al., Pain 49, 87-91 (1992).
Garofalo et al., J. Am. Dent. Assoc., 129 (1998) 438-447.
Giesecke et al., Obstet. & Gynecol. 104:126-133, 2004.
Glass, P. S A. Anesthesia. Miller, R. D. (ed.), pp. 377411 (Livingston, Churchill, 2000).
Glatt et al., Am J Psychiatry 2003; 160:469-76.
Goldstein, J. Am. Osteopath. Assoc. 102, S15-S21 (2002).
Goodman et al., (1996) Goodman & Gilman's the Pharmacological Basis of Therapeutics, 9th ed. McGraw-Hill Health Professions Division, New York.
Gordon & Hen, Annu. Rev. Neurosci., 27 (2004) 193-222.
Gracely, Studies of pain in human subjects. In Wall, P. D. & Melzack, R. Textbook of Pain. 4^{th} Ed. Edinburgh, Scotland: Churchill Livingstone, 1999. pp 385-407.
Gracely et al., Brain, 127 (2004) 835-843.
Granges et al., Arthritis and Rheumatism 36:642-646, 1993.
Gratze et al., (1999) Hypertension, 33, 1425-1430.
Gursoy et al., Rheumatol. Int., 23 (2003) 104-107.
Hagen et al., (2005) Arch. Intern. Med., 165, 916-922.
Han et al., Ann. N.Y. Acad. Sci. 1025, 370-375 (2004).
Hargreaves, et al., (1988) Pain, 32, 77-88.
Hemminger et al., (2006) Bioinformatics. 22, 626-627.
Herken et al., Am. J. Orthod. Dentofacial Orthop., 120 (2001) 308-313.
Hernandez-Avila et al., Am. J. Med. Genet. B Neuropsychiatr. Genet. 118, 60-65 (2003).
Hirota, T. et al., Drug Metab Dispos. 31, 677-680 (2003).
Hoit et al., (2000) Am. Heart J., 139, 537-542.
Iaccarino et al., Circulation, 106, 349-355.
Ikeda, K. et al., Trends Pharmacol Sci. 26, 311-317 (2005).
Inturrisi, Clin. J. Pain 18, S3-13 (2002).
Jaeger, B. & Reeves, J. L., Pain 27, 203-210 (1986).
John et al., (2003) Pain, 102, 257-263.
Kato et al., Archives of Internal Medicine 166:1649-54, 2006.
Katzung, (2001) Basic & Clinical Pharmacology, 8th ed. Lange Medical Books/McGraw-Hill Medical Pub. Division, New York.
Keefe & Dolan (1986) Pain 24:49-56.
Keefe & Dolan, Pain 24, 49-56 (1986).
Khasar et al., J Neurophysiol 81, 1104-12 (1999).
Khasar et al., (2003) Eur. J. Neurosci., 17, 909-915.
Kiefer et al., Prog Neurobiol 64, 109-27 (2001).
Klepstad, P. et al., Acta Anaesthesiol. Scand. 48, 1232-1239 (2004).
Koopman, (1984) Biometrics, 40, 513-517.
Kopin, I. J. (1984) Psychopathology, 17 Suppl 1, 83-97.
Kotanko et al., (1997) Hypertension, 30, 773-776.
Kress, Neuroimmunology and Pain: Peripheral Effects of Proinflammatory Cytokines. in Hyperalgesia: Molecular Mechanisms and Clinical Implications, Progress in Pain Research Management, Vol. 30 (ed. Brune, K. a. H., H. O.) 57-65 (IASP Press, Seattle, 2004).
Kvam, T. M. et al., J. Mol. Med. 82, 250-255 (2004).
Lader, M. (1988) J. Clin. Psychiatry, 49, 213-223.
Langemark et al., Pain 38:203-210, 1989.
Lawford et al., Eur. Neuropsychopharmacol., 13 (2003) 313-320.
Lesch, J. Psychiatry Neurosci., 29 (2004) 174-184.
Li et al., Mol. Psychiatry, 5, 452.
Liggett, Am Rev Respir Dis 139, 552-5 (1989).
Lorr & McNair (1988) Profile of Mood States: Bipolar Form. Educational and Industrial Testing Service, San Diego, Calif.
Lotsch, J. & Geisslinger, G., Trends Mol. Med. 11, 82-89 (2005).
Lotsch, J. et al., Pharmacogenetics 12, 3-9 (2002).
Lotta et al., (1995) Biochem., 34, 4202-4210.
Magliozzi et al., (1989) Biol. Psychiatry, 26, 15-25.
Maixner et al., Pain (1998); 76:71-81.
Maixner et al., Am. J. Physiol. 1990; 259, R1156-R1163.
Maixner, J. Cardiovas. Electrophysiol. (Supplement) 2, S2-S12 (1991).
Maixner et al., Pain 63, 341-351 (1995b).
Maixner et al., (1997) Psychosomatic Med., 59, 503-511.
Maixner et al., (1990) Am J Physiol, 259, R1156-R1163.
Maixner, Myogenous Temporomandibular Disorder: A Persistent Pain Condition Associated with Hyperalgesia and Enhanced Temporal Summation of Pain. In: K. Brune and H. O. Handwerker (Eds.), Hyperalgesia: Molecular Mechanisms and Clinical Implications, Vol. 30. IASP Press, Seattle, 2004, pp. 373-386.
Maixner et al., Orofacial Pain and Temporomandibular Disorders. Fricton, J. R. & Dubner, R. B. (eds.), pp. 85-102 (Raven Press, Ltd., New York, 1995a).
Maixner et al., Brain Res. 237, 137-145 (1982).
Mannisto & Kaakkola, S. (1999) Pharmacol. Rev., 51, 593-628.
Masuda et al., Ann. Clin. Biochem., 39, 589-594.
Matthes et al., Nature 383, 819-823 (1996).
McBeth et al., Arthritis Rheum., 44 (2001) 940-946.
McCreary, J. Craniomandib. Disord. 6, 161-169 (1992).
McCubbin & Bruehl, Pain 57, 63-67 (1994).
McDermid et al., Pain 66, 133-144 (1996).
McGraw et al., (1998) J. Clin. Invest, 102, 1927-1932.
Mense (1993) Pain, 54, 241-289.
Mogil, Proc. Natl. Acad. Sci. 96, 7744-7751. 1999.
Mogil et al., Pain 80, 67-82 (1999).
Mogil et al., (2003) Proc. Natl. Acad. Sci. U.S.A, 100, 4867-4872.
Nackley, et al., Soc. Neurosci. 393.14. 2006.
Narita et al., Eur. J. Neurosci. 18, 3193-3198 (2003).
Oakley et al. (1989) J. Am. Dent. Assoc. 118 (6):727-730.
O'Donnell et al., J Pharmacol Exp Ther 271, 246-54 (1994).
Ogurtso et al., Bioinformatics. 18, 1703-1704 (2002).
Ohrbach & Dworkin (1998) Pain 74 (2-3):315-326.
Okeson et al. In: J. P. Okeson (Ed.), Orofacial Pain. Chicago: Quintessence, 1996. pp. 113-184.
Oroszi & Goldman, D., Pharmacogenomics (2005) 1037-1048.
Pan, et al. Neuroscience 133, 209-220 (2005).
Pan, DNA Cell Biol. 24, 736-750 (2005).
Pasternak, Trends Pharmacol. Sci. 22, 67-70 (2001).
Pasternak, Life Sci. 68, 2213-2219 (2001).
Pasternak, Neuropharmacology 47 Suppl 1, 312-323 (2004).
PCT International Application No PCT/US05/26201.
PCT International Publication No. WO 93/25521.
PCT International Publication No. WO 95/25116.
PCT International Publication No. WO 98/41531.
Pfleeger et al. (1997) Int. J. Beh. Med.
Price, Pain 68, 1-3 (1996).
Price et al., (1977) Pain, 3, 57-68.
Pritchard (2001a) Am. J. Hum. Genet. 69 (1):124-137.
Pritchard (2001b) Nat. Genet. 28 (3):203-204.
Pritchard & Przeworski (2001) Am. J. Hum. Genet. 69 (1):1-14.
Rakvag et al., Pain 116 (2005) 73-78.
Rammelsberg et al., J. Orofac. Pain 17, 9-20 (2003).
Randich & Maixner (1984) Neurosci. Biobehav. Rev., 8, 343-367.
Rao et al., Peptides 24, 745-754 (2003).
Raphael & Marbach, J. Am. Dent. Assoc., 132 (2001) 305-316.
Ready, L. B. Anesthesia. Miller, R. D. (ed.), pp. 2323-2350 (Livingstone, Churchill, 2000).
Remington et al., (1975) Remington's Pharmaceutical Sciences, 15th ed. Mack Pub. Co., Easton, Pa.
Report of the Panel on Communicative Disorders and Stroke Council. No: 81-1914.6-1-1979. Washington, D.C., Public Health Service, NIH. National Ambulatory Medical Care Survey.
Risch (2000) Nature 405 (6788):847-856.
Roach et al., Infect Immun 73, 514-22 (2005).
Rockman & Wray (2002) Mol. Biol. Evol., 19, 1991-2004.
Romberg, R. et al., Anesthesiology 100, 120-133 (2004).
Routledge & Marsden (1987) Neuropharmacology, 26, 823-830.
Rowlingson & Murphy Anesthesia. Miller, R. D. (ed.), pp. 7752-7755 (Livingston, Churchill, 2000).
Saavedra, Brain Res. 209, 245-249 (1981).
Sambrook et al. (1989) Molecular Cloning: A Laboratory Manual (Cold Spring Harbor Laboratory Press, Cold Spring Harbor, N.Y.).
Sarlani & Greenspan, Pain, 102 (2003) 221-226.
Sarlani et al., J. Orofac. Pain 18, 41-55 (2004).
Schuller et al., Nat. Neurosci. 2, 151-156 (1999).
Shagin et al. (2002) Genome Res., 12, 1935-1942.
Sheps et al., (1992) Am. J. Cardiol., 70, 3F-5F.
Shi et al. (1999) Mol. Diagn., 4, 343-351.
Shifman et al., (2002) Am. J Hum. Genet., 71, 1296-1302.
Simes (1986) Biometrika, 73, 751-754.
Skarke et al., Clin. Pharmacol. Ther. 73, 107-121 (2003).
Slade et al. (2006), J. Dent. Res. (In Press).
Small et al., (2003) Annu. Rev. Pharmacol. Toxicol, 43, 381-411.
Smoller et al., Am. J. Med. Genet., 105 (2001) 226-235.
Snapir et al., (2003) Clin. Sci. (Lond), 104, 509-520.
Sommer & Kress, Neurosci Lett 361, 184-7 (2004).
Sora et al., Proc. Natl. Acad. Sci. U.S. A 94, 1544-1549 (1997).
Speight et al., (1997) Avery's Drug Treatment: A Guide to the Properties, Choice, Therapeutic Use and Economic Value of Drugs in Disease Management, 4th ed. Adis International, Auckland/Philadelphia.
Spielberger et al., (1983) Manual for the State-Trait Anxiety Inventory (Form Y1). Consulting Psychologists Press, Palo Alto, Calif.
Stefano et al., Trends Neurosci. 23, 436-442 (2000).
Stephens & Donnelly, (2003) Am. J. Hum. Genet, 73, 1162-1169.
Stephens et al., (2001) Am. J. Hum. Genet., 68, 978-989.
Strosberg, Annu Rev Pharmacol Toxicol 37, 421-50 (1997).
Svensson et al., Pain 92:399-409, 2001.
Svensson, J Orofacial Pain 2001; 15:117-145.
Syed & Chen, Z. J. (2004) Heredity.
Tattersfield & Hall (2004) Lancet, 364, 1464-1466.
Thiessen et al., (1990) Arch. Intern. Med., 160, 2286-2290.
Thompson et al., Anesthesiology 92, 1392-1399 (2000).
Tsujii et al., Physiol Behav 63, 723-8 (1998).
U.S. Pat. No. 4,736,866.
U.S. Pat. No. 5,162,215.
U.S. Pat. No. 5,234,933.
U.S. Pat. No. 5,326,902.
U.S. Pat. No. 5,449,754.
U.S. Pat. No. 5,489,742.
U.S. Pat. No. 5,550,316.
U.S. Pat. No. 5,573,933.
U.S. Pat. No. 5,614,396.
U.S. Pat. No. 5,625,125.
U.S. Pat. No. 5,648,061.
U.S. Pat. No. 5,741,957.
U.S. Pat. No. 5,807,522.
U.S. Pat. No. 6,171,797.
U.S. Pat. No. 6,180,082.
U.S. Pat. No. 6,180,351.
U.S. Pat. No. 6,232,072.
U.S. Pat. No. 6,242,266.
Uhl et al., Proc. Natl. Acad. Sci. U.S. A 96, 7752-7755 (1999).
Vandvik et al., Scand J Gastroenterol. 2006 June; 41(6):650-6.
Vassend et al., (1995) J Psychosom Res 39:889-899.
Verme et al., Pain 93:7-14, 2001.
Verne, G. N. and Price, D. D., Irritable bowel syndrome as a common precipitant of central sensitization, Curr. Rheumatol. Rep., 4 (2002) 322-328.
Von Korff et al., Pain, 32 (1988) 173-183.
Von Korff et al., (1993) Pain, 55, 251-258.
Wand et al., Neuropsychopharmacology 26, 106-114 (2002).
Ward-Routledge et al., (1988) Br. J. Pharmacol., 94, 609-619.
Watkins et al., Adv. Exp. Med. Biol., 521 (2003) 1-21.
Wetmur & Davidson (1968) J. Mol. Biol. 31:349-370.
Wiesenfeld et al., Acta Physiol. Scand., 129 (1987) 55-59.
Wilson et al., Pain 57, 55-61 (1994).
Wolozin & Pasternak, Proc. Natl. Acad. Sci. U.S.A. 78, 6181-6185 (1981).
Wust et al., J. Clin. Endocrinol. Metab, 89 (2004) 565-573.
Xie et al. (1999) Mol. Pharmacol., 56, 31-38.
Yaksh (1999) Pain Suppl 6:S149-S152.
Yeomans et al., Pain 68, 133-140 (1996).
Yu & Mense, Neuroscience 39, 823-831 (1990).
Yu et al. (1991) Neuroscience, 715-723.
Yu et al., Neuropsychopharmacology, 28 (2003) 1182-1185.
Zhang et al., J Biol Chem 263, 6177-82 (1988).
Zhang et al. (2003) Psychopharmacology (Berl), 170, 102-107.
Zolnoun et al., Obstet Gynecol Surv. 61:395-401, 2006.
Zondervan & Cardon, Nat. Rev. Genet. 5, 89-100 (2004).
Zubenko et al., Am. J. Med. Genet., 123B (2003) 1-18.
Zubieta J K, et al., Science 2003; 299:1240-3.

It will be understood that various details of the presently disclosed subject matter may be changed without departing from the scope of the present subject matter. Furthermore, the foregoing description is for the purpose of illustration only, and not for the purpose of limitation.

What is claimed is:

1. A method of predicting susceptibility of a subject to develop a somatosensory disorder, comprising:
(a) determining a genotype of the subject with respect to one or more of genes selected from Table 1; and
(b) comparing the genotype of the subject with one or more of reference genotypes associated with susceptibility to develop the somatosensory disorder, whereby susceptibility of the subject to develop the somatosensory disorder is predicted.

2. The method of claim 1, wherein determining the genotype of the subject comprises:
(i) identifying at least one haplotype from each of the one or more genes selected from Table 1;
(ii) identifying at least one polymorphism unique to at least one haplotype from each of the one or more genes selected from Table 1;
(iii) identifying at least one polymorphism exhibiting high linkage disequilibrium to at least one polymorphism unique to each of the one or more genes selected from Table 1;
(iv) identifying at least one polymorphism exhibiting high linkage disequilibrium to at least one of the one or more genes selected from Table 1; or
(v) combinations thereof.

3. The method of claim 2, wherein the at least one polymorphism unique to the at least one haplotype is a single nucleotide polymorphism from Table 2.

4. The method of claim 2, wherein the at least one polymorphism unique to the at least one haplotype is a single nucleotide polymorphism from Table 3.

5. The method of claim 1, wherein the somatosensory disorder is selected from the group consisting of chronic pain conditions, fibromyalgia syndrome, tension headache, migraine headache, phantom limb sensations, irritable bowel syndrome, chronic lower back pain, chronic fatigue, multiple chemical sensitivities, temporomandibular joint disorder, post-traumatic stress disorder, chronic idiopathic pelvic pain, Gulf War Syndrome, vulvar vestibulitis, osteoarthritis, rheumatoid arthritis, angina pectoris, postoperative pain, and neuropathic pain.

6. The method of claim 1, wherein predicting susceptibility of a subject to develop a somatosensory disorder comprises predicting a pain response in the subject.

7. The method of claim 1, wherein predicting susceptibility of a subject to develop a somatosensory disorder comprises predicting somatization in the subject.

8. A method of predicting susceptibility of a subject to develop a somatosensory disorder, comprising:
(a) determining a genotype of the subject with respect to one or more genes selected from the group consisting of ADRB2, ADRB3, and COMT in combination with at least one gene selected from Table 1; and
(b) comparing the genotype of the subject with one or more reference genotypes associated with susceptibility to develop the somatosensory disorder, whereby susceptibility of the subject to develop the somatosensory disorder is predicted.

9. The method of claim 8, wherein determining the genotype of the subject comprises:
(i) identifying at least one haplotype of ADRB2, ADRB3, COMT or combinations thereof and the at least one gene selected from Table 1;
(ii) identifying at least one polymorphism unique to at least one haplotype of ADRB2, ADRB3, COMT, or combinations thereof and the at least one gene selected from Table 1;
(iii) identifying at least one polymorphism exhibiting high linkage disequilibrium to at least one polymorphism unique to at least one haplotype of ADRB2, ADRB3, COMT, or combinations thereof and the at least one gene selected from Table 1;
(iv) identifying at least one polymorphism exhibiting high linkage disequilibrium to at least one haplotype of ADRB2, ADRB3, COMT, or combinations thereof and the at least one gene selected from Table 1; or
(v) combinations thereof.

10. The method of claim 9, wherein the at least one polymorphism unique to the at least one haplotype is a single nucleotide polymorphism from ADRB2, ADRB3, COMT or Table 2.

11. The method of claim 9, wherein the at least one polymorphism unique to the at least one haplotype is a single nucleotide polymorphism from ADRB2, ADRB3, COMT or Table 3.

12. The method of claim 8, wherein the somatosensory disorder is selected from the group consisting of chronic pain conditions, fibromyalgia syndrome, tension headache, migraine headache, phantom limb sensations, irritable bowel syndrome, chronic lower back pain, chronic fatigue, multiple chemical sensitivities, temporomandibular joint disorder, post-traumatic stress disorder, chronic idiopathic pelvic pain, Gulf War Syndrome, vulvar vestibulitis, osteoarthritis, rheumatoid arthritis, angina pectoris, postoperative pain, and neuropathic pain.

13. The method of claim 8, wherein predicting susceptibility of a subject to develop a somatosensory disorder comprises predicting a pain response in the subject.

14. The method of claim 8, wherein predicting susceptibility of a subject to develop a somatosensory disorder comprises predicting somatization in the subject.

15. A method of predicting susceptibility of a subject to develop a somatosensory disorder, comprising:
(a) determining a psychosocial assessment, a neurological assessment, or both, of a subject;
(b) determining a genotype of the subject with respect to one or more genes selected from Table 4; and
(c) predicting susceptibility of the subject to develop a somatosensory disorder based on the determined psychosocial assessment, neurological assessment, or both, and the determined genotype of the subject.

16. The method of claim 15, wherein determining the psychosocial assessment of the subject comprises testing the subject with at least one psychosocial questionnaire comprising one or more questions that each assess anxiety, depression, somatization, stress, cognition, pain perception, or combinations thereof of the subject.

17. The method of claim 16, wherein the at least one psychosocial questionnaire is selected from the group consisting of Eysenck Personality Questionnaire, Life Experiences Survey, Perceived Stress Scale, State-Trait Anxiety Inventory (STAI) Form Y-2, STAI Form Y-1, Pittsburgh Sleep Quality Index, Kohn Reactivity Scale, Pennebaker Inventory for Limbic Languidness, Short Form 12 Health Survey v2, SF-36, Pain Catastrophizing Scale, In vivo Coping Questionnaire, Coping Strategies Questionnaire-Rev, Lifetime Stressor List & Post-Traumatic Stress Disorder (PTSTD) Checklist for Civilians, Multidimensional Pain Inventory v3, Comprehensive Pain & Symptom Questionnaire, Symptom Checklist-90-R(SCL-90R), Brief Symptom Inventory (BSI), Beck Depression Inventory (BDI), Profile of Mood States Bi-polar, Pain Intensity Measures, and Pain Unpleasantness Measures.

18. The method of claim 15, wherein determining the neurological state of the subject comprises testing the subject with at least one neurological testing apparatus.

19. The method of claim 16, wherein the neurological testing apparatus is selected from the group consisting of Thermal Pain Delivery and Measurement Devices, Mechanical Pain Delivery and Measurement Devices, Ischemic Pain Delivery and Measurement Devices, Chemical Pain Delivery and Measurement Devices, Electrical Pain Delivery and Measurement Devices, Vibrotactile Delivery and Measurement Devices, Blood Pressure Measuring Devices, Heart Rate Measuring Devices, Heart Rate Variability Measuring Devices, Baroreceptor Monitoring Devices, Cardiac Output Monitoring Devices, Blood Flow Monitoring Devices, and Skin Temperature Measuring Devices.

20. The method of claim 15, wherein determining the genotype of the subject comprises:
(i) identifying at least one haplotype of the one or more genes selected from Table 4;
(ii) identifying at least one polymorphism unique to at least one haplotype of the one or more genes selected from Table 4;
(iii) identifying at least one polymorphism exhibiting high linkage disequilibrium to at least one polymorphism unique to at least one haplotype of the one or more genes selected from Table 4;
(iv) identifying at least one polymorphism exhibiting high linkage disequilibrium to at least one haplotype of the one or more genes selected from Table 4; or
(v) combinations thereof.

21. The method of claim 20, wherein the at least one polymorphism unique to the at least one haplotype is a single nucleotide polymorphism from Table 5.

22. The method of claim 9, wherein the at least one polymorphism unique to the at least one haplotype is a single nucleotide polymorphism from Table 6.

23. The method of claim 15, wherein the somatosensory disorder is selected from the group consisting of chronic pain conditions, fibromyalgia syndrome, tension headache, migraine headache, phantom limb sensations, irritable bowel syndrome, chronic lower back pain, chronic fatigue, multiple chemical sensitivities, temporomandibular joint disorder, post-traumatic stress disorder, chronic idiopathic pelvic pain, Gulf War Syndrome, vulvar vestibulitis, osteoarthritis, rheumatoid arthritis, angina pectoris, postoperative pain, and neuropathic pain.

24. The method of claim 15, wherein predicting susceptibility of a subject to develop a somatosensory disorder comprises predicting a pain response in the subject.

25. The method of claim 15, wherein predicting susceptibility of a subject to develop a somatosensory disorder comprises predicting somatization in the subject.

26. A method of selecting a therapy, predicting a response to a therapy, or both, for a subject having a somatosensory disorder, comprising:
(a) determining a genotype of the subject with respect to one or more genes selected from Table 1; and
(b) selecting a therapy, predicting a response to a therapy, or both, based on the determined genotype of the subject.

27. The method of claim 26, wherein determining the genotype of the subject comprises:
(i) identifying at least one haplotype from each of the one or more genes selected from Table 1;
(ii) identifying at least one polymorphism unique to at least one haplotype from each of the one or more genes selected from Table 1;
(iii) identifying at least one polymorphism exhibiting high linkage disequilibrium to at least one polymorphism unique to each of the one or more genes selected from Table 1;
(iv) identifying at least one polymorphism exhibiting high linkage disequilibrium to at least one of the one or more genes selected from Table 1; or
(v) combinations thereof.

28. The method of claim 27, wherein the at least one polymorphism unique to the at least one haplotype is a single nucleotide polymorphism from Table 2.

29. The method of claim 27, wherein the at least one polymorphism unique to the at least one haplotype is a single nucleotide polymorphism from Table 3.

30. The method of claim 26, wherein the therapy is selected from the group consisting of a pharmacological therapy, a behavioral therapy, a psychotherapy, a surgical therapy, and combinations thereof.

31. The method of claim 30, wherein the subject is undergoing or recovering from a surgical therapy and the method comprises selecting a pain management therapy, predicting a response to a pain management therapy, or both based on the determined genotype of the subject.

32. The method of claim 26, wherein the somatosensory disorder is selected from the group consisting of chronic pain conditions, fibromyalgia syndrome, tension headache, migraine headache, phantom limb sensations, irritable bowel syndrome, chronic lower back pain, chronic fatigue, multiple chemical sensitivities, temporomandibular joint disorder, post-traumatic stress disorder, chronic idiopathic pelvic pain, Gulf War Syndrome, vulvar vestibulitis, osteoarthritis, rheumatoid arthritis, angina pectoris, postoperative pain, and neuropathic pain.

33. A method of selecting a therapy, predicting a response to a therapy, or both, for a subject having a somatosensory disorder, comprising:
(a) determining a genotype of the subject with respect to one or more genes selected from the group consisting of ADRB2, ADRB3, and COMT in combination with at least one gene selected from Table 1; and
(b) selecting a therapy based on the determined genotype of the subject.

34. The method of claim 33, wherein determining the genotype of the subject comprises:
(i) identifying at least one haplotype of ADRB2, ADRB3, COMT or combinations thereof and the at least one gene selected from Table 1;
(ii) identifying at least one polymorphism unique to at least one haplotype of ADRB2, ADRB3, COMT, or combinations thereof and the at least one gene selected from Table 1;
(iii) identifying at least one polymorphism exhibiting high linkage disequilibrium to at least one polymorphism unique to at least one haplotype of ADRB2, ADRB3, COMT, or combinations thereof and the at least one gene selected from Table 1;
(iv) identifying at least one polymorphism exhibiting high linkage disequilibrium to at least one haplotype of ADRB2, ADRB3, COMT, or combinations thereof and the at least one gene selected from Table 1; or
(v) combinations thereof.

35. The method of claim 34, wherein the at least one polymorphism unique to the at least one haplotype is a single nucleotide polymorphism from ADRB2, ADRB3, COMT or Table 2.

36. The method of claim 34, wherein the at least one polymorphism unique to the at least one haplotype is a single nucleotide polymorphism from ADRB2, ADRB3, COMT or Table 3.

37. The method of claim 33, wherein the therapy is selected from the group consisting of a pharmacological therapy, a behavioral therapy, a psychotherapy, a surgical therapy, and combinations thereof.

38. The method of claim 37, wherein the subject is undergoing or recovering from a surgical therapy and the method comprises selecting a pain management therapy, predicting a response to a pain management therapy, or both based on the determined genotype of the subject.

39. The method of claim 33, wherein the somatosensory disorder is selected from the group consisting of chronic pain conditions, fibromyalgia syndrome, tension headache, migraine headache, phantom limb sensations, irritable bowel syndrome, chronic lower back pain, chronic fatigue, multiple chemical sensitivities, temporomandibular joint disorder, post-traumatic stress disorder, chronic idiopathic pelvic pain, Gulf War Syndrome, vulvar vestibulitis, osteoarthritis, rheumatoid arthritis, angina pectoris, postoperative pain, and neuropathic pain.

40. A method of selecting a therapy, predicting a response to a therapy, or both for a subject having a somatosensory disorder, comprising:
(a) determining a psychosocial assessment, a neurological assessment, or both, of a subject
(b) determining a genotype of the subject with respect to one or more genes selected from Table 4; and
(c) selecting a therapy, predicting a response to a therapy, or both for the subject having the somatosensory disorder based on the determined psychosocial assessment, neurological assessment, or both, and the determined genotype of the subject.

41. The method of claim 40, wherein determining the psychosocial assessment of the subject comprises testing the subject with at least one psychosocial questionnaire comprising one or more questions that each assess anxiety, depression, somatization, stress, cognition, pain perception, or combinations thereof of the subject.

42. The method of claim 41, wherein the at least one psychosocial questionnaire is selected from the group consisting of Eysenck Personality Questionnaire, Life Experiences Survey, Perceived Stress Scale, State-Trait Anxiety Inventory (STAI) Form Y-2, STAI Form Y-1, Pittsburgh Sleep Quality Index, Kohn Reactivity Scale, Pennebaker Inventory for Limbic Languidness, Short Form 12 Health Survey v2, SF-36, Pain Catastrophizing Scale, In vivo Coping Questionnaire, Coping Strategies Questionnaire-Rev, Lifetime Stressor List & Post-Traumatic Stress Disorder (PTSTD) Checklist for Civilians, Multidimensional Pain Inventory v3, Comprehensive Pain & Symptom Questionnaire, Symptom Checklist-90-R(SCL-90R), Brief Symptom Inventory (BSI), Beck Depression Inventory (BDI), Profile of Mood States Bi-polar, Pain Intensity Measures, and Pain Unpleasantness Measures.

43. The method of claim 40, wherein determining the neurological state of the subject comprises testing the subject with at least one neurological testing apparatus.

44. The method of claim 43, wherein the neurological testing apparatus is selected from the group consisting of Thermal Pain Delivery and Measurement Devices, Mechanical Pain Delivery and Measurement Devices, Ischemic Pain Delivery and Measurement Devices, Chemical Pain Delivery and Measurement Devices, Electrical Pain Delivery and Measurement Devices, Vibrotactile Delivery and Measurement Devices, Blood Pressure Measuring Devices, Heart Rate Measuring Devices, Heart Rate Variability Measuring Devices, Baroreceptor Monitoring Devices, Cardiac Output Monitoring Devices, Blood Flow Monitoring Devices, and Skin Temperature Measuring Devices.

45. The method of claim 40, wherein determining the genotype of the subject comprises:
(i) identifying at least one haplotype of the one or more genes selected from Table 4;
(ii) identifying at least one polymorphism unique to at least one haplotype of the one or more genes selected from Table 4;
(iii) identifying at least one polymorphism exhibiting high linkage disequilibrium to at least one polymorphism unique to at least one haplotype of the one or more genes selected from Table 4;
(iv) identifying at least one polymorphism exhibiting high linkage disequilibrium to at least one haplotype of the one or more genes selected from Table 4; or
(v) combinations thereof.

46. The method of claim 45, wherein the at least one polymorphism unique to the at least one haplotype is a single nucleotide polymorphism from Table 5.

47. The method of claim 45, wherein the at least one polymorphism unique to the at least one haplotype is a single nucleotide polymorphism from Table 6.

48. The method of claim 40, wherein the therapy is selected from the group consisting of a pharmacological therapy, a behavioral therapy, a psychotherapy, a surgical therapy, and combinations thereof.

49. The method of claim 48, wherein the subject is undergoing or recovering from a surgical therapy and the method comprises selecting a pain management therapy, predicting a response to a pain management therapy, or both based on the determined genotype of the subject.

50. The method of claim 40, wherein the somatosensory disorder is selected from the group consisting of chronic pain conditions, fibromyalgia syndrome, tension headache, migraine headache, phantom limb sensations, irritable bowel syndrome, chronic lower back pain, chronic fatigue, multiple chemical sensitivities, temporomandibular joint disorder, post-traumatic stress disorder, chronic idiopathic pelvic pain, Gulf War Syndrome, vulvar vestibulitis, osteoarthritis, rheumatoid arthritis, angina pectoris, postoperative pain, and neuropathic pain.

51. A method of classifying a somatosensory disorder afflicting a subject, comprising:
(a) determining a genotype of the subject with respect to one or more genes selected from Table 1; and
(b) classifying the somatosensory disorder into a genetic subclass somatosensory disorder based on the determined genotype of the subject.

52. The method of claim 51, wherein determining the genotype of the subject comprises:
(i) identifying at least one haplotype from each of the one or more genes selected from Table 1;
(ii) identifying at least one polymorphism unique to at least one haplotype from each of the one or more genes selected from Table 1;
(iii) identifying at least one polymorphism exhibiting high linkage disequilibrium to at least one polymorphism unique to each of the one or more genes selected from Table 1;
(iv) identifying at least one polymorphism exhibiting high linkage disequilibrium to at least one of the one or more genes selected from Table 1; or
(v) combinations thereof.

53. The method of claim 52, wherein the at least one polymorphism unique to the at least one haplotype is a single nucleotide polymorphism from Table 2.

54. The method of claim 52, wherein the at least one polymorphism unique to the at least one haplotype is a single nucleotide polymorphism from Table 3.

55. The method of claim 51, wherein classifying the somatosensory disorder into the genetic subclass somatosensory disorder is utilized to select an effective therapy for use in treating the genetic subclass somatosensory disorder.

56. The method of claim 51, wherein the somatosensory disorder is selected from the group consisting of chronic pain conditions, fibromyalgia syndrome, tension headache, migraine headache, phantom limb sensations, irritable bowel syndrome, chronic lower back pain, chronic fatigue, multiple chemical sensitivities, temporomandibular joint disorder, post-traumatic stress disorder, chronic idiopathic pelvic pain, Gulf War Syndrome, vulvar vestibulitis, osteoarthritis, rheumatoid arthritis, angina pectoris, postoperative pain, and neuropathic pain.

57. A method of classifying a somatosensory disorder afflicting a subject, comprising:
(a) determining a genotype of the subject with respect to one or more genes selected from the group consisting of ADRB2, ADRB3, and COMT in combination with at least one gene selected from Table 1; and
(b) classifying the somatosensory disorder into a genetic subclass somatosensory disorder based on the determined genotype of the subject.

58. The method of claim 57, wherein determining the genotype of the subject comprises:
(i) identifying at least one haplotype of ADRB2, ADRB3, COMT or combinations thereof and the at least one gene selected from Table 1;
(ii) identifying at least one polymorphism unique to at least one haplotype of ADRB2, ADRB3, COMT, or combinations thereof and the at least one gene selected from Table 1;
(iii) identifying at least one polymorphism exhibiting high linkage disequilibrium to at least one polymorphism unique to at least one haplotype of ADRB2, ADRB3, COMT, or combinations thereof and the at least one gene selected from Table 1;
(iv) identifying at least one polymorphism exhibiting high linkage disequilibrium to at least one haplotype of ADRB2, ADRB3, COMT, or combinations thereof and the at least one gene selected from Table 1; or
(v) combinations thereof.

59. The method of claim 58, wherein the at least one polymorphism unique to the at least one haplotype is a single nucleotide polymorphism from ADRB2, ADRB3, COMT or Table 2.

60. The method of claim 58, wherein the at least one polymorphism unique to the at least one haplotype is a single nucleotide polymorphism from ADRB2, ADRB3, COMT or Table 3.

61. The method of claim 57, wherein classifying the somatosensory disorder into the genetic subclass somatosensory disorder is utilized to select an effective therapy for use in treating the genetic subclass somatosensory disorder.

62. The method of claim 57, wherein the somatosensory disorder is selected from the group consisting of chronic pain conditions, fibromyalgia syndrome, tension headache, migraine headache, phantom limb sensations, irritable bowel syndrome, chronic lower back pain, chronic fatigue, multiple chemical sensitivities, temporomandibular joint disorder, post-traumatic stress disorder, chronic idiopathic pelvic pain, Gulf War Syndrome, vulvar vestibulitis, osteoarthritis, rheumatoid arthritis, angina pectoris, postoperative pain, and neuropathic pain.

63. A method of classifying a somatosensory disorder afflicting a subject, comprising:
(a) determining a psychosocial assessment, a neurological assessment, or both, of a subject;
(b) determining a genotype of the subject with respect to one or more genes selected from Table 4; and
(c) classifying a somatosensory disorder afflicting the subject based on the determined psychosocial assessment, neurological assessment, or both, and the determined genotype of the subject.

64. The method of claim 63, wherein determining the psychosocial assessment of the subject comprises testing the subject with at least one psychosocial questionnaire comprising one or more questions that each assess anxiety, depression, somatization, stress, cognition, pain perception, or combinations thereof of the subject.

65. The method of claim 64, wherein the at least one psychosocial questionnaire is selected from the group consisting of Eysenck Personality Questionnaire, Life Experiences Survey, Perceived Stress Scale, State-Trait Anxiety Inventory (STAI) Form Y-2, STAI Form Y-1, Pittsburgh Sleep Quality Index, Kohn Reactivity Scale, Pennebaker Inventory for Limbic Languidness, Short Form 12 Health Survey v2, SF-36, Pain Catastrophizing Scale, In vivo Coping Questionnaire, Coping Strategies Questionnaire-Rev, Lifetime Stressor List & Post-Traumatic Stress Disorder (PTSTD) Checklist for Civilians, Multidimensional Pain Inventory v3, Comprehensive Pain & Symptom Questionnaire, Symptom Checklist-90-R(SCL-90R), Brief Symptom Inventory (BSI), Beck Depression Inventory (BDI), Profile of Mood States Bi-polar, Pain Intensity Measures, and Pain Unpleasantness Measures.

66. The method of claim 63, wherein determining the neurological state of the subject comprises testing the subject with at least one neurological testing apparatus.

67. The method of claim 66, wherein the neurological testing apparatus is selected from the group consisting of Thermal Pain Delivery and Measurement Devices, Mechanical Pain Delivery and Measurement Devices, Ischemic Pain Delivery and Measurement Devices, Chemical Pain Delivery and Measurement Devices, Electrical Pain Delivery and Measurement Devices, Vibrotactile Delivery and Measurement Devices, Blood Pressure Measuring Devices, Heart Rate Measuring Devices, Heart Rate Variability Measuring Devices, Baroreceptor Monitoring Devices, Cardiac Output Monitoring Devices, Blood Flow Monitoring Devices, and Skin Temperature Measuring Devices.

68. The method of claim 63, wherein determining the genotype of the subject comprises:
(i) identifying at least one haplotype of the one or more genes selected from Table 4;
(ii) identifying at least one polymorphism unique to at least one haplotype of the one or more genes selected from Table 4;
(iii) identifying at least one polymorphism exhibiting high linkage disequilibrium to at least one polymorphism unique to at least one haplotype of the one or more genes selected from Table 4;
(iv) identifying at least one polymorphism exhibiting high linkage disequilibrium to at least one haplotype of the one or more genes selected from Table 4; or
(v) combinations thereof.

69. The method of claim 68, wherein the at least one polymorphism unique to the at least one haplotype is a single nucleotide polymorphism from Table 5.

70. The method of claim 68, wherein the at least one polymorphism unique to the at least one haplotype is a single nucleotide polymorphism from Table 6.

71. The method of claim 63, wherein classifying the somatosensory disorder into the genetic subclass somatosensory disorder is utilized to select an effective therapy for use in treating the genetic subclass somatosensory disorder.

72. The method of claim 63, wherein the somatosensory disorder is selected from the group consisting of chronic pain conditions, fibromyalgia syndrome, tension headache, migraine headache, phantom limb sensations, irritable bowel syndrome, chronic lower back pain, chronic fatigue, multiple chemical sensitivities, temporomandibular joint disorder, post-traumatic stress disorder, chronic idiopathic pelvic pain, Gulf War Syndrome, vulvar vestibulitis, osteoarthritis, rheumatoid arthritis, angina pectoris, postoperative pain, and neuropathic pain.

73. A kit for determining a genotype of a subject that is associated with a somatosensory disorder, comprising:
(a) an array comprising a substrate and a plurality of polynucleotide probes arranged at specific locations on the substrate, wherein each probe has a binding affinity for a different polynucleotide sequence comprising a single nucleotide polymorphism selected from Table 5; and
(b) a set of instructions for using the array.

74. The kit of claim 73, wherein the substrate comprises a plurality of addresses, wherein each address is associated with at least one of the polynucleotide probes.

75. The kit of claim 73, wherein the polynucleotide sequence comprises a single nucleotide polymorphism selected from Table 6.

76. The kit of claim 73, wherein the set of instructions comprises instructions for interpreting results from the array.

77. A system, comprising:
(a) an array comprising a substrate and a plurality of polynucleotide probes arranged at specific locations on the substrate, wherein each probe has a binding affinity for a different polynucleotide sequence comprising a single nucleotide polymorphism selected from Table 5; and
(b) at least one neurological testing apparatus for determining a neurological assessment of the subject, at least one psychosocial questionnaire for determining a psychosocial assessment of the subject, or both the neurological testing apparatus and the psychosocial questionnaire.

78. The system of claim 77, comprising software for assessing results of the array, the neurological testing apparatus, and the psychosocial questionnaire.

79. The system of claim 78, wherein the software provides diagnostic information, therapeutic information, or both related to a somatosensory disorder about the subject.

80. The system of claim 77, wherein the substrate comprises a plurality of addresses, wherein each address is associated with at least one of the polynucleotide probes.

81. The system of claim 77, wherein the polynucleotide sequence comprises a single nucleotide polymorphism selected from Table 6.

82. The system of claim 77, wherein the at least one psychosocial questionnaire is selected from the group consisting of Eysenck Personality Questionnaire, Life Experiences Survey, Perceived Stress Scale, State-Trait Anxiety Inventory (STAI) Form Y-2, STAI Form Y-1, Pittsburgh Sleep Quality Index, Kohn Reactivity Scale, Pennebaker Inventory for Limbic Languidness, Short Form 12 Health Survey v2, SF-36, Pain Catastrophizing Scale, In vivo Coping Questionnaire, Coping Strategies Questionnaire-Rev, Lifetime Stressor List & Post-Traumatic Stress Disorder (PTSTD) Checklist for Civilians, Multidimensional Pain Inventory v3, Comprehensive Pain & Symptom Questionnaire, Symptom Checklist-90-R(SCL-90R), Brief Symptom Inventory (BSI), Beck Depression Inventory (BDI), Profile of Mood States Bi-polar, Pain Intensity Measures, and Pain Unpleasantness Measures.

83. The system of claim 77, wherein the neurological testing apparatus is selected from the group consisting of Thermal Pain Delivery and Measurement Devices, Mechanical Pain Delivery and Measurement Devices, Ischemic Pain Delivery and Measurement Devices, Chemical Pain Delivery and Measurement Devices, Electrical Pain Delivery and Measurement Devices, Vibrotactile Delivery and Measurement Devices, Blood Pressure Measuring Devices, Heart Rate Measuring Devices, Heart Rate Variability Measuring Devices, Baroreceptor Monitoring Devices, Cardiac Output Monitoring Devices, Blood Flow Monitoring Devices, and Skin Temperature Measuring Devices.
